(19) United States
(12) Patent Application Publication
(10) Pub. No.: US 2026/0296072 A1
(43) Pub. Date: Oct. 1, 2026

(54) TAPE CASSETTE INCLUDING HOUSING, TAPE ROLL, RIBBON ROLL, AND TAKE-UP SPOOL SPACED APART FROM RIBBON ROLL IN DIRECTION IN WHICH AXIS OF RIBBON ROLL EXTENDS

(71) Applicant: BROTHER KOGYO KABUSHIKI KAISHA, Nagoya (JP)

(72) Inventor: Shinji UKAI, Kiyosu (JP)

(21) Appl. No.: 19/633,768

(22) Filed: Mar. 30, 2026

(30) Foreign Application Priority Data
Mar. 31, 2025 (JP) 2025-059878

(51) Int. Cl. B41J 15/04; B41J 2/325; B41J 3/407; B41J 32/00; B41J 33/00; B41J 33/02; B41J 35/04

(52) U.S. Cl. CPC B41J 15/044; B41J 2/325; B41J 3/4075; B41J 15/046; B41J 32/00; B41J 33/003; B41J 33/02; B41J 35/04

(57) ABSTRACT

A tape cassette includes: a housing; a tape roll; a ribbon roll; and a take-up spool. The tape roll is positioned in the housing. The tape roll is a roll in which a tape is wound. The ribbon roll is positioned in the housing. The ribbon roll is a roll in which an ink ribbon is wound. The ribbon roll is rotatable about an axis extending in a first direction. The take-up spool is positioned in the housing. The take-up spool is configured to take up the ink ribbon. In the tape cassette, the ribbon roll and the take-up spool are spaced apart from each other in the first direction.

### REFERENCE TO RELATED APPLICATIONS

This application claims priority from Japanese Patent Application No. 2025-059878 filed on Mar. 31, 2025. The entire content of the priority application is incorporated herein by reference.

### BACKGROUND ART

A known tape cassette includes a case, a tape, gears, a ribbon roll, and a take-up spool. The case includes a first case, a second case, and a third case which are arranged in order of the first case, the second case, and the third case in an up-down direction. The tape is accommodated in the third case. The gears are accommodated in the second case. The ribbon roll and the take-up spool are accommodated in the first case. In the ribbon roll, an ink ribbon is wound. The take-up spool is configured to take up the ink ribbon.

### SUMMARY

In the tape cassette described above, the ribbon roll and the take-up spool are disposed to overlap each other in position in a direction in which an axis of the ribbon roll extends.

In view of the foregoing, it is an object of the present disclosure to provide a tape cassette in which a ribbon roll and a take-up spool can be positioned to be spaced apart from each other in a direction in which an axis of the ribbon roll extends.

In order to attain the above and other object, the present disclosure provides a tape cassette including: a housing; a tape roll; a ribbon roll; and a take-up spool. The tape roll is positioned in the housing. The tape roll is a roll in which a tape is wound. The ribbon roll is positioned in the housing. The ribbon roll is a roll in which an ink ribbon is wound. The ribbon roll is rotatable about an axis extending in a first direction. The take-up spool is positioned in the housing. The take-up spool is configured to take up the ink ribbon. In the tape cassette, the ribbon roll and the take-up spool are spaced apart from each other in the first direction.

In the tape cassette described above, the ribbon roll and the take-up spool can be positioned spaced apart from each other in the first direction in which the axis of the ribbon roll extends.

### BRIEF DESCRIPTION OF DRAWINGS

FIG. 1 is a perspective view of a printer 1.

FIG. 2 is a perspective view of a tape cassette 100A, and the printer 1 in which a cover 3 has been removed from a housing 2.

FIG. 3 is a perspective view of a printing unit 50.

FIG. 4 is a front view of a drive shaft 63.

FIG. 5 is an exploded perspective view of the tape cassette 100A.

FIG. 6 is a bottom view of the tape cassette 100A, and particularly illustrates a third space S3.

FIG. 7 is a plan view of the tape cassette 100A, and particularly illustrates a second space S2.

FIG. 8 is a bottom view of the tape cassette 100A, and particularly illustrates the arrangement of the components in the tape cassette 100A.

FIG. 9 is a bottom view of the tape cassette 100A.

FIG. 10 is a cross-sectional view taken along line X-X in FIG. 9.

FIG. 11 is a cross-sectional view taken along line XI-XI in FIG. 9.

FIG. 12 is a cross-sectional view taken along line XII-XII in FIG. 9.

FIG. 13 is a perspective view of the tape cassette 100A, and particularly illustrates a fourth space S4 and the operation of gears 30.

FIG. 14 is a perspective view of the tape cassette 100A, and particularly illustrates a first space S1 and a part of the conveying passage for an ink ribbon 45.

FIG. 15 is a cross-sectional view taken along line XV-XV in FIG. 9, and particularly illustrates the first space S1 through the fourth space S4 and a part of the conveying passage for the ink ribbon 45.

FIG. 16 is a perspective view of the tape cassette 100A, and particularly illustrates the second space S2 and a part of the conveying passage for the ink ribbon 45.

FIG. 17 is an exploded perspective view of a tape cassette 100B.

FIG. 18 is a bottom view of the tape cassette 100B, and particularly illustrates a third space S3.

FIG. 19 is a bottom view of the tape cassette 100B, and particularly illustrates a second space S2.

FIG. 20 is a plan view of the tape cassette 100B, and particularly illustrates the arrangement of the components in the tape cassette 100B.

FIG. 21 is a bottom view of the tape cassette 100B.

FIG. 22 is a cross-sectional view taken along line XXII-XXII in FIG. 21.

FIG. 23 is a cross-sectional view taken along line XXIII-XXIII in FIG. 21.

FIG. 24 is a cross-sectional view taken along line XXIV-XXIV in FIG. 21.

FIG. 25 is a perspective view of the tape cassette 100B, and particularly illustrates a fourth space S4 and the operation of gears 30.

FIG. 26 is a perspective view of the tape cassette 100B, and particularly illustrates the third space S3 and a part of the conveying passage for an ink ribbon 45.

FIG. 27 is a cross-sectional view taken along line XXVII-XXVII in FIG. 21, and particularly illustrates a first space S1 through the fourth space S4 and a part of the conveying passage for the ink ribbon 45.

FIG. 28 is a perspective view of the tape cassette 100B, and particularly illustrates the second space S2 and a part of the conveying passage for the ink ribbon 45.

FIG. 29 is an exploded perspective view of a tape cassette 100C.

FIG. 30 is a bottom view of the tape cassette 100C, and particularly illustrates a second space S2.

FIG. 31 is a plan view of the tape cassette 100C, and particularly illustrates a third space S3.

FIG. 32 is a bottom view of the tape cassette 100C, and particularly illustrates the arrangement of the components in the tape cassette 100C.

FIG. 33 is a bottom view of the tape cassette 100C.

FIG. 34 is a cross-sectional view taken along line XXXIV-XXXIV in FIG. 33.

FIG. 35 is a cross-sectional view taken along line XXXV-XXXV in FIG. 33.

FIG. 36 is a cross-sectional view taken along line XXXVI-XXXVI in FIG. 33.

FIG. 37 is a perspective view of the tape cassette 100C, and particularly illustrates a fourth space S4 and the operation of gears 30.

FIG. 38 is a perspective view of the tape cassette 100C, and particularly illustrates the third space S3 and a part of the conveying passage for an ink ribbon 45.

FIG. 39 is a cross-sectional view taken along line XXXIX-XXXIX in FIG. 33, and particularly illustrates a first space S1 through the fourth space S4 and a part of the conveying passage for the ink ribbon 45.

FIG. 40 is a perspective view of the tape cassette 100C, and particularly illustrates the second space S2 and a part of the conveying passage for the ink ribbon 45.

FIG. 41 is a bottom view of a tape cassette 100C, and particularly illustrates a part of the conveying passage for the ink ribbon 45.

FIG. 42 is an exploded perspective view of a tape cassette 100D.

FIG. 43 is a bottom view of the tape cassette 100D, and particularly illustrates a second space S2.

FIG. 44 is a plan view of the tape cassette 100D, and particularly illustrates a third space S3.

FIG. 45 is a bottom view of the tape cassette 100D, and particularly illustrates the arrangement of the components in the tape cassette 100D.

FIG. 46 is a plan view of the tape cassette 100D.

FIG. 47 is a cross-sectional view taken along line XLVII-XLVII in FIG. 46.

FIG. 48 is a bottom view of the tape cassette 100D.

FIG. 49 is a cross-sectional view taken along line XLIX-XLIX in FIG. 48.

FIG. 50 is a perspective view of the tape cassette 100D, and particularly illustrates a fourth space S4 and the operation of gear 30.

FIG. 51 is a perspective view of the tape cassette 100D, and particularly illustrates the third space S3 and a part of the conveying passage for an ink ribbon 45.

FIG. 52 is a cross-sectional view taken along line LII-LII in FIG. 48, and particularly illustrates a first space S1 through the fourth space S4 and a part of the conveying passage for the ink ribbon 45.

FIG. 53 is a perspective view of the tape cassette 100D, and particularly illustrates the second space S2 and a part of the conveying passage for the ink ribbon 45.

FIG. 54 is an exploded perspective view of a tape cassette 100E.

FIG. 55 is a bottom view of the tape cassette 100E, and particularly illustrates a second space S2.

FIG. 56 is a plan view of the tape cassette 100E, and particularly illustrates a third space S3.

FIG. 57 is a bottom view of the tape cassette 100E, and particularly illustrates the arrangement of the components in the tape cassette 100E.

FIG. 58 is a bottom view of the tape cassette 100E.

FIG. 59 is a cross-sectional view taken along line LIX-LIX in FIG. 58.

FIG. 60 is a cross-sectional view taken along line LX-LX in FIG. 58.

FIG. 61 is a cross-sectional view taken along line LXI-LXI in FIG. 58.

FIG. 62 is a perspective view of the tape cassette 100E, and particularly illustrates a fourth space S4 and the operation of gear 30.

FIG. 63 is a perspective view of the tape cassette 100E, and particularly illustrates the third space S3 and a part of the conveying passage for an ink ribbon 45.

FIG. 64 is a cross-sectional view taken along line LXIV-LXIV in FIG. 58, and particularly illustrates a first space S1 through the fourth space S4 and a part of the conveying passage for the ink ribbon 45.

FIG. 65 is a perspective view of the tape cassette 100E, and particularly illustrates the second space S2 and a part of the conveying passage for the ink ribbon 45.

### DESCRIPTION

Hereinafter, a printer 1 and a tape cassette 100A according to an embodiment of the present disclosure will be described while referring to the accompanying drawings. The drawings are used to describe the technical features made possible with the present disclosure. In other words, the configurations and the like illustrated in the drawings are merely illustrative examples and are not intended to limit the present disclosure.

In the present embodiment, a first direction corresponds to an up-down direction. One side of the first direction corresponds to an upward direction, and the other side of the first direction corresponds to a downward direction. A second direction corresponds to a front-rear direction. One side of the second direction corresponds to a frontward direction, and the other side of the second direction corresponds to a rearward direction. A third direction corresponds to a left-right direction. One side of the third direction corresponds to a rightward direction, and the other side of the third direction corresponds to a leftward direction.

Also, an end portion of a component at one side in each direction will be referred to as “one end portion of the component in the corresponding direction”, and an end portion of the component at the other side in each direction will be referred to as “the other end portion of the component in the corresponding direction” as appropriate. Similarly, an end of a component at one side in each direction will be referred to as “one end of the component in the corresponding direction”, and an end of the component at the other side in each direction will be referred to as “the other end of the component in the corresponding direction” as appropriate.

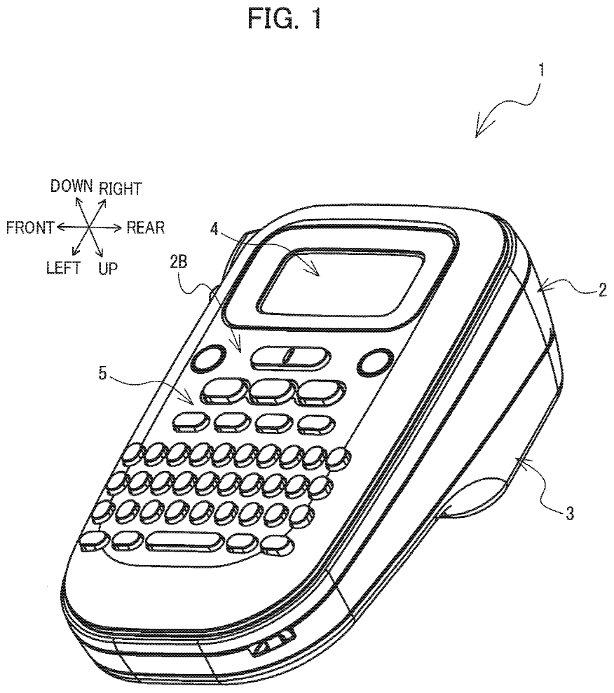

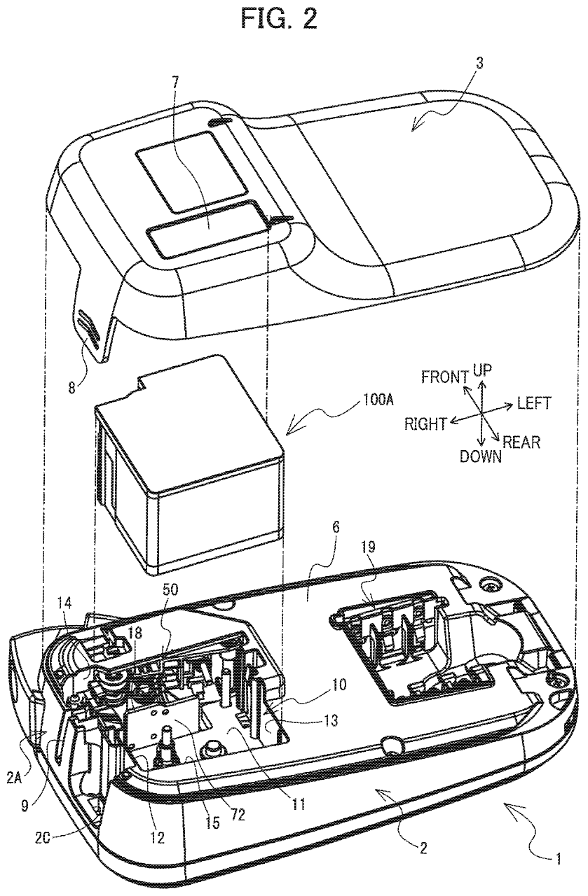

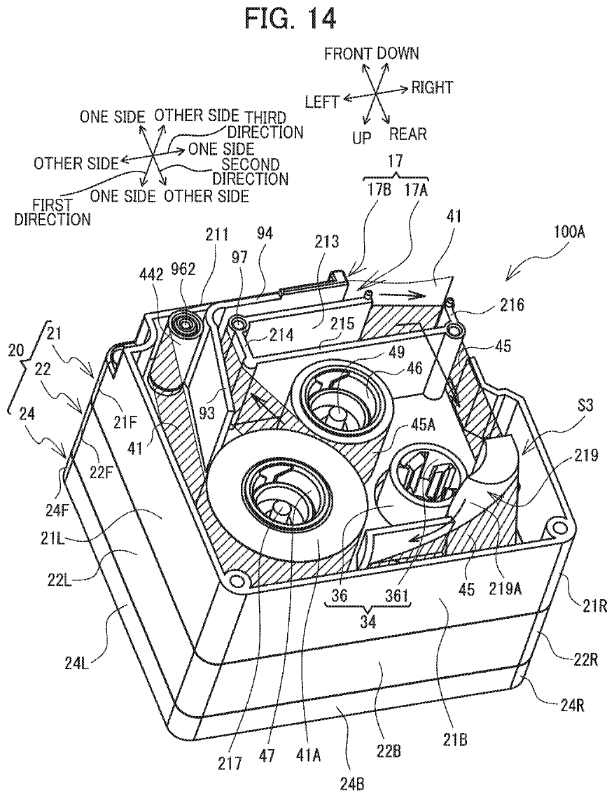

The configuration of the printer 1 will be described below. As illustrated in FIGS. 1 and 2, the printer 1 is a portable label printer. The printer 1 is configured to print images on a tape 41 illustrated in FIG. 14 to create labels. Specifically, the printer 1 is configured to print images, such as characters and figures, on the tape 41.

As illustrated in FIG. 1, and 2, the printer 1 includes a housing 2, a cover 3, a display unit 4, and an input unit 5.

The housing 2 has a box shape and is elongated in the left-right direction. The housing 2 has an upper surface that is formed with an opening. An inner cover 6 is assembled over the opening, thereby protecting an inside of the housing 2. A right wall 2A of the housing 2 has a discharge channel 9, and an anchoring hole 2C. The discharge channel 9 extends through the right wall 2A in the left-right direction. The anchoring hole 2C is configured to engage with an opening/closing unit 8 of the cover 3.

The cover 3 is mounted on the housing 2 so as to be removable from the housing 2. The cover 3 is elongated in the left-right direction. In a state where the cover 3 is mounted on the housing 2, a part of the cover 3 that faces the housing 2 is concaved toward the housing 2. Also, in the state where the cover 3 is mounted on the housing 2, the cover 3 covers the entirety of the upper surface of the housing 2 which includes the opening formed in the upper surface of the housing 2 and the inner cover 6.

The right end portion of the cover 3 includes a window 7. The window 7 is positioned in line with the rear end of a cassette attachment portion 10. Through the window 7, the user can see a label affixed to the upper surface of the tape cassette 100A, for example. The label specifies the type of the tape 41, for example.

The display unit 4 is a liquid crystal display, for example, and is configured to display various information. The display unit 4 is disposed on the right end portion of a lower surface 2B of the housing 2.

The input unit 5 is configured to receive various information inputted through user operations. The input unit 5 is disposed on the lower surface 2B of the housing 2. In other words, the input unit 5 is arranged leftward of the display unit 4. The input unit 5 includes various keys such as character keys, a Print button, and an Esc key.

As illustrated in FIG. 2, inside the housing 2, the printer 1 includes the cassette attachment portion 10, a battery accommodating portion 19, and a printing unit 50.

The tape cassette 100A is attachable to and detachable from the cassette attachment portion 10. The cassette attachment portion 10 is arranged at a position further rightward relative to the left-right center of the inner cover 6. The cassette attachment portion 10 is recessed downward. The cassette attachment portion 10 has a bottom surface 11, and peripheral surfaces 12 to 15. The peripheral surfaces 12 to 15 are connected to edges of the bottom surface 11 to surround the bottom surface 11 in the front-rear direction and the left-right direction.

The battery accommodating portion 19 is configured to accommodate a battery (not illustrated). The battery accommodating portion 19 is arranged on the inner cover 6 at a position further leftward relative to the left-right center of the housing 2 and is recessed downward.

In a state where the cover 3 is removed from the housing 2, the cassette attachment portion 10 and the battery accommodating portion 19 are exposed to an outside of the printer 1. Therefore, the user can replace the tape cassette 100A and the battery by removing the cover 3 from the housing 2.

The printing unit 50 is configured to perform printing on the tape 41. The printing unit 50 is arranged in the lower portion on the front end portion of the cassette attachment portion 10, i.e., in the front portion inside the housing 2.

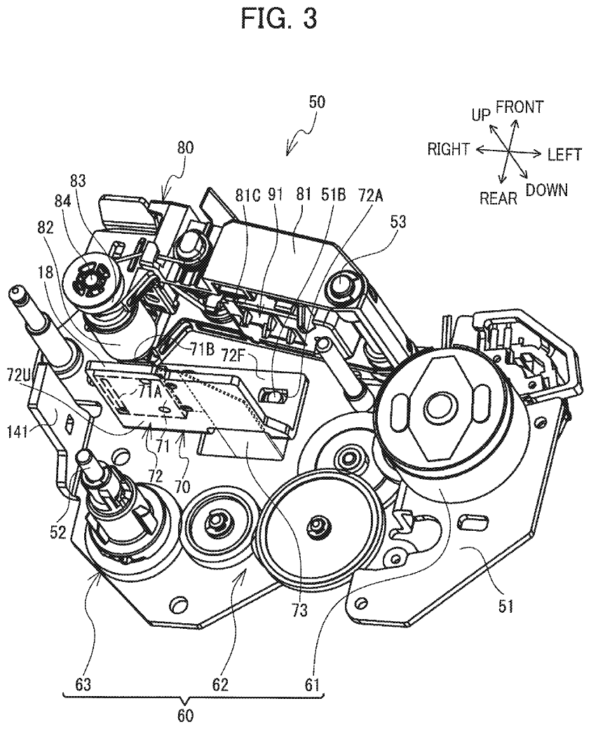

As illustrated in FIG. 3, the printing unit 50 includes a base 51, a head unit 70, a platen unit 80, and a drive mechanism 60.

As illustrated in FIG. 3, the base 51 supports the components in the printing unit 50. The base 51 is a metal plate. The base 51 has plate surfaces that are orthogonal to the up-down direction. The dimension of the base 51 in the left-right direction is greater than the dimension of the base 51 in the front-rear direction. The base 51 includes a mounting portion 141, a pin 51B, and a shaft 52.

The mounting portion 141 is positioned in the right end of the front-rear center of the base 51. The mounting portion 141 extends upward from the base 51. The mounting portion 141 has plate surfaces that face opposite directions in the left-right direction. The mounting portion 141 is a metal plate.

The pin 51B is arranged on the front end portion and on the left-right center of the base 51. The pin 51B extends upward from the base 51. The pin 51B has a columnar shape. Note that another pin (not illustrated) is arranged at a position rightward of the pin 51B. The other pin (not illustrated) has a configuration identical to that of the pin 51B. The shaft 52 is disposed on the right-rear portion of the base 51. The shaft 52 extends upward from the base 51.

As illustrated in FIG. 3, the head unit 70 is assembled to the base 51. The head unit 70 includes a heat sink 72, and a print head 71.

The heat sink 72 holds the print head 71. The heat sink 72 is a metal plate for dissipating heat from the print head 71. The heat sink 72 is disposed on the right end portion of the front-rear center of the base 51. The heat sink 72 includes a first plate 72F, and a second plate 72U.

The first plate 72F has plate surfaces that face opposite directions in the up-down direction. The dimension of the first plate 72F in the left-right direction is greater than the dimension of the first plate 72F in the front-rear direction. A hole 72A is formed in the first plate 72F. The hole 72A extends through the first plate 72F in the up-down direction.

The pin 51B is inserted in the hole 72A. In this state, the first plate 72F is fixed to the base 51 with a screw (not illustrated).

The second plate 72U extends upward from the rear edge of the first plate 72F. The second plate 72U has plate surfaces that face opposite directions in the front-rear direction. The dimension of the second plate 72U in the left-right direction is greater than the dimension of the second plate 72U in the up-down direction. In a state where the tape cassette 100A is attached to the printer 1, the upper surface of the right end portion of the second plate 72U functions as a support part 18 for supporting the tape cassette 100A.

The print head 71 is fixed to the front surface of the second plate 72U of the heat sink 72 with adhesive. The print head 71 is a rectangular circuit board on which a plurality of heating elements 71A and a driver circuit 71B are mounted. The heating elements 71A are aligned in the up-down direction on the right end portion of the circuit board. The driver circuit 71B is arranged on the left-right center portion of the circuit board. The driver circuit 71B is electrically connected to a controller (not illustrated) of the printer 1 via a harness 73.

As illustrated in FIG. 3, the platen unit 80 is disposed on the front portion of the base 51. The left end portion of the platen unit 80 is supported by a rotational shaft 53. The rotational shaft 53 is disposed on the left portion of the front end portion of the base 51. The rotational shaft 53 extends upward from the base 51. The right end portion of the platen unit 80 is pivotally movable in the front-rear direction about the rotational shaft 53.

The pivotal movement of the platen unit 80 causes a platen roller 82 to be moved between an adjacent position (not illustrated) and a separated position (a position illustrated in FIG. 3). The adjacent position is a position in which the platen roller 82 is positioned close to the print head 71, and the separated position is a position in which the platen roller 82 is separated away from the print head 71.

For convenience, in the following description related to the components of the platen unit 80, the directions for the components of the platen unit 80 will be based on a state where the platen roller 82 is in the adjacent position. Also, the directions for the components of the platen unit 80 will be based on the directions for the components of the printer 1 described above.

The platen unit 80 includes a platen holder 81, a platen shaft 84, the platen roller 82, a platen gear 83, and a detection unit 91.

The left end portion of the platen holder 81 is open rearward. The left end portion of the platen holder 81 includes an upper wall and a lower wall. Support holes (not illustrated) are formed on the respective upper wall and the lower wall of the platen holder 81 to extend through the respective upper wall and the lower wall in the up-down direction. Specifically, the upper support hole extends through the upper wall of the platen holder 81 in the up-down direction, and the lower support hole extends through the lower wall of the platen holder 81 in the up-down direction. The rotational shaft 53 of the base 51 is inserted through the support holes. The platen roller 82 is supported so as to be rotatable between the upper wall and the lower wall on the right end portion of the platen holder 81.

The platen shaft 84 is a shaft that extends in the up-down direction. The platen roller 82 has a hollow cylindrical shape and extends in the up-down direction. The platen shaft 84 is inserted through the platen roller 82. The platen roller 82 is rotatable together with the platen shaft 84.

The platen gear 83 is fixed to the upper end of the platen shaft 84. The platen shaft 84 protrudes further upward relative to the upper wall of the platen holder 81. The platen gear 83 is a helical gear. The platen gear 83 has gear teeth that are helical (i.e., skewed) at a prescribed angle relative to the up-down direction. The platen shaft 84 is rotatable together with the platen gear 83.

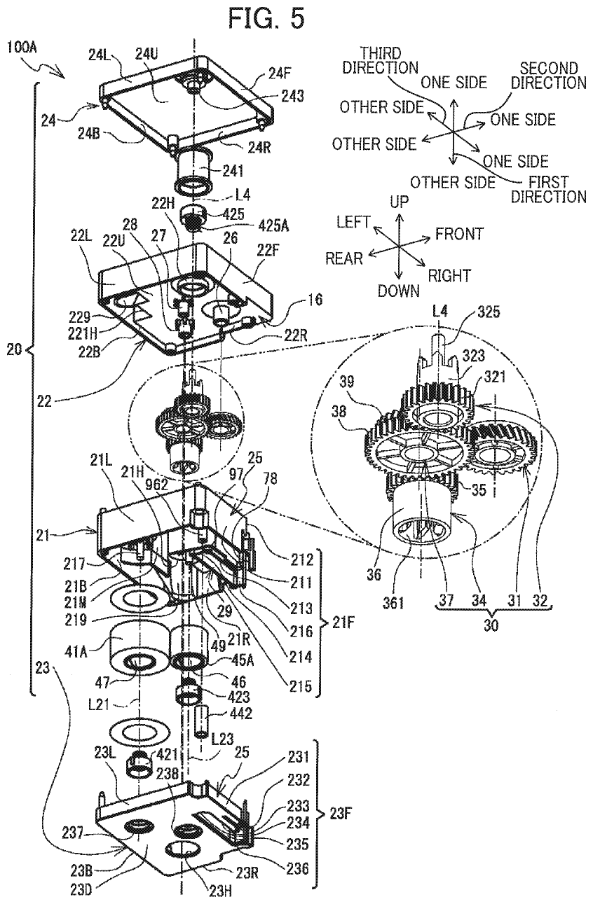

In a state where the platen roller 82 is in the adjacent position, the tape 41 and an ink ribbon 45 are to be nipped between the platen roller 82 and the print head 71. The platen gear 83 is configured to engage with a gear 31 (see FIG. 5) in the tape cassette 100A.

A drive force from a drive shaft 63 (described later) is inputted into the platen roller 82 via the tape cassette 100A and the platen gear 83. The axial rotation of the platen roller 82 causes the tape 41 nipped between the platen roller 82 and the print head 71 to be conveyed toward the discharge channel 9.

As illustrated in FIG. 3, the platen holder 81 includes a holding portion 81C. The holding portion 81C is arranged on the right portion in the platen holder 81. The holding portion 81C has a recessed shape that is recessed frontward. The holding portion 81C holds the detection unit 91.

The detection unit 91 includes mechanical switches. The mechanical switches of the detection unit 91 are turned on and off by detection parts (not illustrated) on the tape cassette 100A. The detection unit 91 is configured to detect cassette identification information assigned to the tape cassette 100A on the basis of the combination of on/off signals from the mechanical switches.

As illustrated in FIG. 3, the drive mechanism 60 is assembled with the base 51. The drive mechanism 60 includes a motor 61, a gear train 62, and the drive shaft 63. The motor 61, the gear train 62, and the base 51 are disposed inside the housing 2 at a position downward of the inner cover 6.

The motor 61 is a drive source of gears 30 (described later). The motor 61 is disposed on the left end portion of the base 51. The gear train 62 includes a plurality of gears coupled together for transmitting a drive force of the motor 61 to the drive shaft 63.

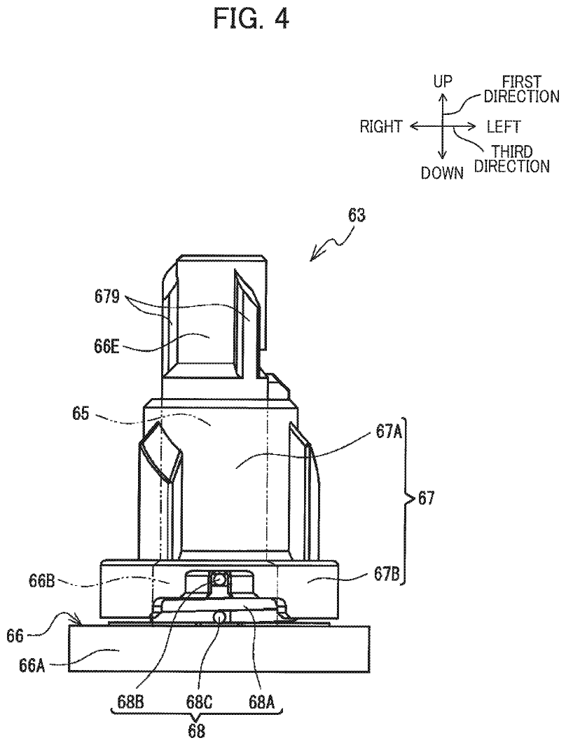

The drive shaft 63 will be described with reference to FIGS. 3 and 4. The drive shaft 63 is disposed on the right-rear corner of the base 51. The drive shaft 63 is fitted over the shaft 52 disposed on the base 51. The drive shaft 63 is exposed inside the cassette attachment portion 10.

The drive shaft 63 is configured to be inserted into a gear 34 (described later). A drive force transmitted from the motor 61 is inputted into the drive shaft 63 via the gear train 62. The drive shaft 63 is configured to rotate the gear 34 with the drive force from the motor 61.

The drive shaft 63 includes a drive gear 66, a clutch spring 68, and a drive cam 67.

The drive force from the motor 61 is to be transmitted to the drive gear 66 via the gear train 62. The drive gear 66 is made of resin material, for example.

The drive gear 66 includes a gear 66A, and a shaft 65.

The gear 66A is in engagement with the most downstream gear in the gear train 62 illustrated in FIG. 3. The gear 66A is rotatable by the drive force transmitted from the motor 61 illustrated in FIG. 3 via the gear train 62. The shaft 65 extends upward from the gear 66A.

The shaft 65 has a hollow cylindrical shape. The diameter of the shaft 65 is smaller than the diameter of the gear 66A. The shaft 65 is fitted over the shaft 52 illustrated in FIG. 3. The shaft 65 is rotatable together with the gear 66A about the shaft 52.

The upper end portion of the shaft 65 serves as a shaft 66E. The shaft 66E has a hollow cylindrical shape. A transmission gear 679 that extends in the up-down direction is disposed on the shaft 66E. The shaft 66E is configured to be inserted into the gear 34 (described later). The shaft 66E is configured to transmit the drive force from the motor 61 to the gear 34 through the transmission gear 679.

The clutch spring 68 is a coil spring. The clutch spring 68 includes a body 68A, a first arm 68B, and a second arm 68C.

The body 68A is placed over the outer circumferential surface of a first shaft 66B of the drive gear 66. The body 68A has a helical shape extending in the up-down direction. The first arm 68B extends outward in the radial direction of the shaft 65 from the upper end of the body 68A. The second arm 68C extends outward in the radial direction from the lower end of the body 68A.

The drive cam 67 is mounted on the shaft 65. The drive cam 67 has a hollow cylindrical shape. The drive cam 67 is made of resin material different from the drive gear 66, for example. Specifically, the drive cam 67 is made a different type or grade of resin material from the drive gear 66.

The drive cam 67 includes a cam portion 67A, and a spring accommodating portion 67B.

The cam portion 67A has a hollow cylindrical shape that extends in the up-down direction. The spring accommodating portion 67B is disposed on the lower end portion of the cam portion 67A. The diameter of the spring accommodating portion 67B is diameter that is greater than the diameter of the cam portion 67A. The spring accommodating portion 67B accommodates the clutch spring 68.

The shaft 65 is inserted through the drive cam 67. The shaft 66E is a portion of the shaft 65 that protrudes further upward relative to the drive cam 67.

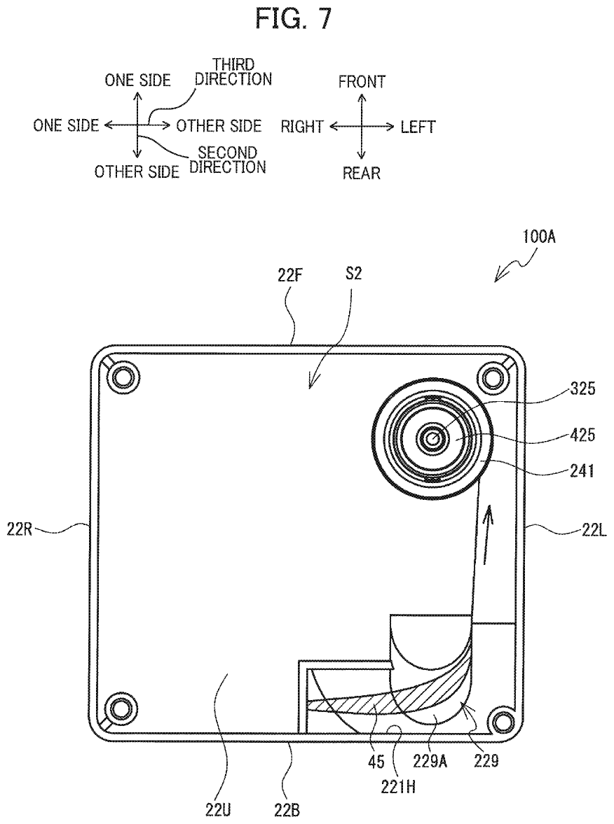

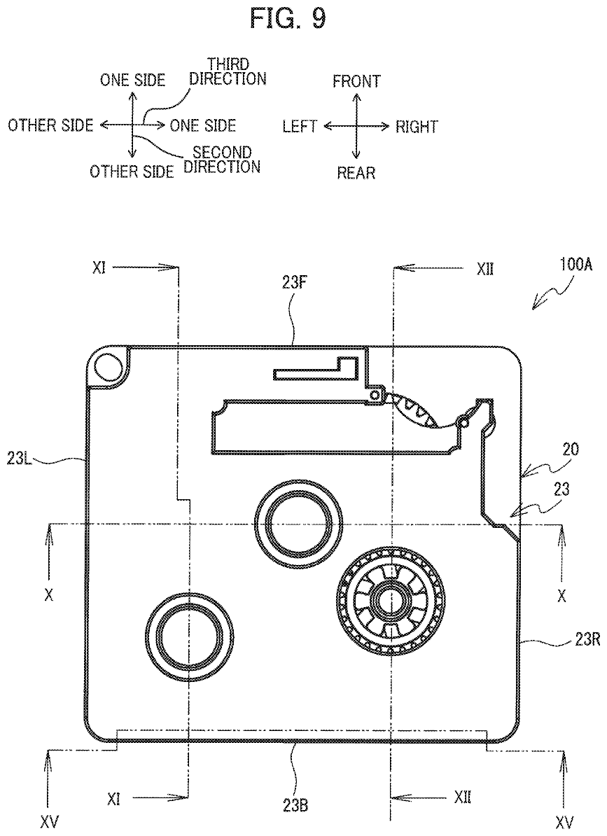

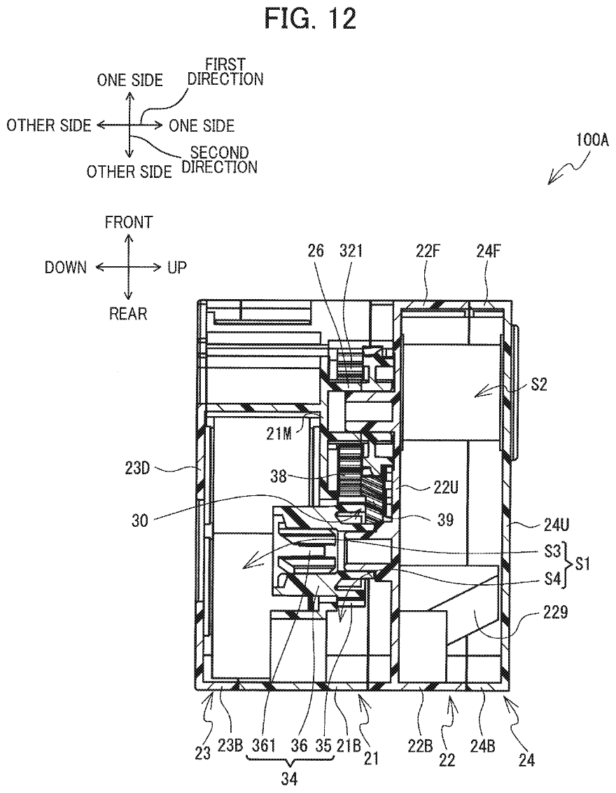

Next, the tape cassette 100A will be described with reference to FIGS. 5 through 16. The tape cassette 100A is attachable to the cassette attachment portion 10 illustrated in FIG. 2. Replenishment of the tape and change of the type (for example, the size, the color, and the material) of the tape can be performed by replacing the tape cassette 100A attached to the cassette attachment portion 10 of the printer 1.

The tape cassette 100A includes a housing 20, a tape roll 41A, a ribbon roll 45A, a take-up spool 241, and the gears 30. As illustrated in FIG. 5, the tape cassette 100A has a rectangular parallelepiped outer shape. That is, the housing 20 has a rectangular parallelepiped shape. The housing 20 accommodates the tape roll 41A, the ribbon roll 45A, the take-up spool 241, and the gears 30.

Inside the housing 20, the tape roll 41A is positioned on the other side in the second direction and on the other side in the third direction. Inside the housing 20, a tape spool 47 is positioned on the other side in the second direction and on the other side in the third direction.

The tape roll 41A is a roll in which the tape 41 is wound about the tape spool 47. The tape spool 47 is rotatable about a rotation axis L21 extending in the first direction. The rotation axis L21 will be described later.

The tape spool 47 has a hollow cylindrical shape elongated in the first direction. The tape 41 has a strip shape. The tape 41 includes a printing tape having adhesive coated on one surface and a releasing paper bonded to the one surface of the printing tape to cover the same, for example. The tape 41 is to be overlaid on the ink ribbon 45 (described later) to be subjected to printing by the print head 71.

As indicated above, the tape 41 is wound about the tape spool 47. The tape spool 47 is rotatable about the rotation axis L21 extending in the first direction with the tape 41 wound about the tape spool 47. That is, the tape roll 41A is rotatable about the rotation axis L21 extending in the first direction. The rotation axis L21 is an imaginary axis. The rotation axis L21 passes through the center of the tape roll 41A.

Inside the housing 20, the ribbon roll 45A is positioned in the vicinity of the center in the second direction and in the vicinity of the center in the third direction. Inside the housing 20, a ribbon spool 46 is positioned in the vicinity of the center in the second direction and in the vicinity of the center in the third direction.

The ribbon roll 45A is a roll in which the ink ribbon 45 is wound about the ribbon spool 46. The ribbon spool 46 is rotatable about a rotation axis L23 extending in the first direction. The rotation axis L23 will be described later.

The ribbon spool 46 has a hollow cylindrical shape that is elongated in the first direction. The ink ribbon 45 has a strip shape. For example, the ink ribbon 45 is a strip-like film containing ink. The ink ribbon 45 is to be used to perform printing on the tape 41. Specifically, the ink ribbon 45 is to be overlaid on the tape 41 in a head opening 29 (described later) to be used for printing by the print head 71.

The ink ribbon 45 is wound about the ribbon spool 46. Specifically, the ribbon spool 46 is rotatable about the rotation axis L23 extending in the first direction with the ink ribbon 45 wound about the ribbon spool 46. Accordingly, the ribbon roll 45A is rotatable about the rotation axis L23 extending in the first direction. The take-up spool 241 (described later) is configured to take up the ink ribbon 45. The rotation axis L23 is an imaginary axis. The rotation axis L23 passes through the center of the ribbon roll 45A.

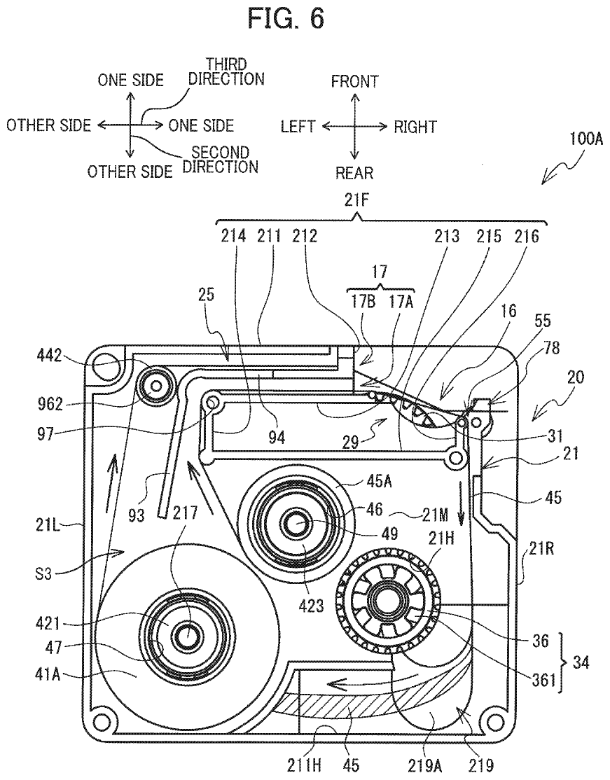

As illustrated in FIGS. 5 and 6, the housing 20 of the tape cassette 100A includes an arm 25. The arm 25 is positioned at the one end portion of the housing 20 in the second direction. In the second direction, the arm 25 is positioned closer to the one end portion of the housing 20 in the second direction than to the other end portion of the housing 20 in the second direction.

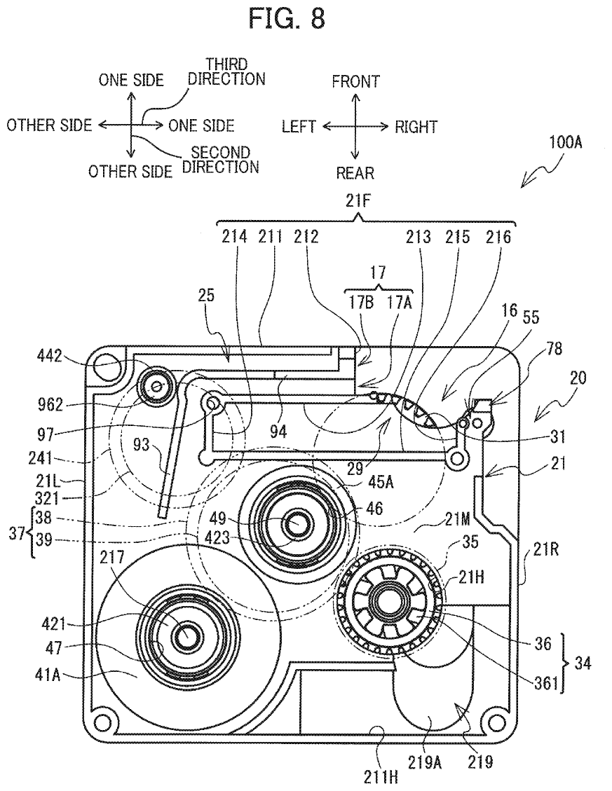

As illustrated in FIGS. 6 and 8, the arm 25 has a discharge port 17. The discharge port 17 allows the tape 41 and the ink ribbon 45 to be discharged to an outside of the housing 20 through the discharge port 17. The arm 25 and the discharge port 17 will be described later in detail.

As illustrated in FIG. 5, the housing 20 includes a case 21, a case 22, a case 23, and a case 24.

The case 23 constitutes the other end of the housing 20 in the first direction. The case 21 is disposed on the one side of the case 23 in the first direction. The case 21 is coupled to the one end of the case 23 in the first direction.

The case 22 is disposed on the one side of the case 21 in the first direction. The case 22 is coupled to the one end of the case 21 in the first direction.

The case 24 constitutes the one end of the housing 20 in the first direction. The case 24 is disposed on the one side of the case 22 in the first direction. The case 24 is coupled to the one end of the case 22 in the first direction.

As illustrated in FIG. 5, the case 23 includes plates 23D, 23R, 23B, 23L, and 23F. Each of the plates 23D, 23B, 23R, and 23L has a rectangular shape.

The plate 23D has plate surfaces that are orthogonal to the first direction. The plate 23D has an opening 23H. Shafts 237 and 238 are disposed on the plate 23D. In the plate 23D, the opening 23H is located on the other side in the second direction and on the one side in the third direction. The opening 23H extends through the plate 23D in the first direction. The shafts 237 and 238 protrude toward the one side in the first direction from the plate 23D.

The plate 23R is positioned at the one end of the plate 23D in the third direction. The plate 23B is positioned at the other end of the plate 23D in the second direction. The plate 23L is positioned at the other end of the plate 23D in the third direction. The plates 23R, 23B, and 23L extend toward the one side in the first direction from the plate 23D.

The plate 23F is positioned at the one end of the plate 23D in the second direction. The plate 23F includes plates 231 through 236. Each of the plates 231 through 236 has a rectangular shape. Each of the plates 231, 233, and 235 has plate surfaces that are orthogonal to the second direction. Each of the plates 232, 234, and 236 has plate surfaces that are orthogonal to the third direction.

The plate 231 is positioned at the one end of the plate 23D in the first direction. The one end of the plate 232 (i.e., the one end of the plate 232 in the second direction) is connected to the one end of the plate 231 (i.e., the one end of the plate 231 in the third direction). The other end of the plate 232 (i.e., the other end of the plate 232 in the second direction) is connected to the one end of the plate 233 (i.e., the one end of the plate 233 in the third direction). The other end of the plate 233 (i.e., the other end of the plate 233 in the third direction) is connected to the one end of the plate 234 (i.e., the one end of the plate 234 in the second direction). The other end of the plate 234 (i.e., the other end of the plate 234 in the second direction) is connected to the other end of the plate 235 (i.e., the other end of the plate 235 in the third direction). The one end of the plate 235 (i.e., the other end of the plate 235 in the third direction) is connected to the other end of the plate 236 (i.e., the other end of the plate 236 in the second direction).

As illustrated in FIG. 5, the case 21 includes a partition plate 21M and plates 21R, 21B, 21L, and 21F. Each of the partition plate 21M and the plates 21R, 21B, and 21L has a rectangular shape.

As illustrated in FIGS. 5, 6, and 8, the partition plate 21M has plate surfaces that are orthogonal to the first direction. The partition plate 21M has openings 21H and 211H. A ribbon guide 219, plates 93 and 94, and shafts 49, 217, and 962 are disposed on the partition plate 21M.

In the partition plate 21M, the opening 21H is located on the other side in the second direction and on the one side in the third direction. The position of the opening 21H is the same as the position of the opening 23H. Specifically, the position of the opening 21H in the second direction and in the third direction is the same as the position of the opening 23H in the second direction and in the third direction. The opening 21H extends through the partition plate 21M in the up-down direction (i.e., in the first direction).

In the partition plate 21M, the opening 211H is located on the other side in the second direction and on the one side in the third direction. The opening 211H extends through the partition plate 21M in the first direction. The other end of the partition plate 21M in the second direction and the one end of the partition plate 21M in the third direction are notched by the opening 211H.

The ribbon guide 219, the plates 93 and 94, and the shafts 49, 217, and 962 extend toward the other side in the first direction from the partition plate 21M.

The ribbon guide 219 is disposed on the corner of the housing 20 on the other side in the second direction and on the one side in the third direction. Specifically, the ribbon guide 219 is disposed on the corner of the housing 20, i.e., at a position further toward the other side in the second direction and further toward the one side in the third direction than the opening 21H. The one end of the ribbon guide 219 in the first direction is connected to the opening 211H.

The ribbon guide 219 has a sloped surface 219A, which is curved. The sloped surface 219A is sloped to extend toward the one side in the second direction as the sloped surface 219A extends toward the other side in the first direction. The ribbon guide 219 is configured to guide the conveyance of the ink ribbon 45. More specifically, the ink ribbon 45 is to be conveyed while contacting the sloped surface 219A of the ribbon guide 219.

The plate 93 extends in the second direction. The plate 93 is positioned closer to the plate 21L than to the plate 21R in the third direction. The one end of the plate 93 in the second direction is connected to the other end of the plate 94 in the third direction.

The plate 94 extends in the third direction. The plate 94 extends toward the one side in the third direction from the one end of the plate 93 in the second direction. The plate 94 is positioned within the arm 25 (described later).

On the partition plate 21M, the shaft 49 is disposed in the vicinity of the center in the second direction and in the vicinity of the center in the third direction. The center of the shaft 49 has the rotation axis L23. A holder 423 is fitted over the shaft 49. The holder 423 has a hollow cylindrical shape. The holder 423 is rotatable about the shaft 49.

The shaft 217 is disposed on the corner of the partition plate 21M on the other side in the second direction and on the other side in the third direction. The center of the shaft 217 has the rotation axis L21. A holder 421 is fitted over the shaft 217. The holder 421 has a hollow cylindrical shape. The holder 421 is rotatable about the shaft 217.

The shaft 962 is disposed on the corner of the partition plate 21M on the one side in the second direction and on the other side in the third direction. A tape guide 442 is fitted over the shaft 962. The tape guide 442 has a hollow cylindrical shape. The tape guide 442 is rotatable about the shaft 962.

The plate 21R is positioned at the one end of the housing 20 in the third direction. The plate 21R has plate surfaces which are orthogonal to the third direction. In the first direction, the partition plate 21M is positioned between the one end of the plate 21R in the first direction and the other end of the plate 21R in the first direction.

The plate 21B is positioned at the other end of the housing 20 in the second direction. The plate 21B has plate surfaces which are orthogonal to the second direction. In the first direction, the partition plate 21M is positioned between the one end of the plate 21B in the first direction and the other end of the plate 21B in the first direction.

The plate 21L is positioned at the other end of the housing 20 in the third direction. The plate 21L has plate surfaces which are orthogonal to the third direction. In the first direction, the partition plate 21M is positioned between the one end of the plate 21L in the first direction and the other end of the plate 21L in the first direction.

The plate 21F is positioned at the one end of the housing 20 in the second direction. The plate 21F includes plates 211 through 216. Each of the plates 211 through 216 has a rectangular shape. Each of the plates 211, 213, and 215 has plate surfaces which are orthogonal to the second direction. Each of the plates 214 and 216 has plate surfaces which are orthogonal to the third direction.

The plate 211 is positioned at the one end of the partition plate 21M in the second direction. The plate 213 is positioned further toward the other side in the second direction than the plate 94. The plate 94 is positioned between the plate 211 and the plate 213 in the second direction. In other words, a gap is formed between the plate 94 and the plate 211. A gap is also formed between the plate 94 and the plate 213.

The one end of the plate 212 in the second direction is connected to the one end of the plate 211 in the third direction. The other end of the plate 212 in the second direction is connected to the one end of the plate 213 in the third direction. The plate 212 has the discharge port 17 (described later).

The other end of the plate 213 in the third direction is connected to a guide 97. The guide 97 is connected to the one end of the plate 214 in the second direction. The other end of the plate 214 in the second direction is connected to the other end of the plate 215 in the third direction. The plate 214 is positioned further toward the one side in the third direction than the plate 93 to be spaced apart from the plate 93. That is, a gap is formed between the plate 93 and the plate 214.

The one end of the plate 215 in the third direction is connected to the other end of the plate 216 in the second direction.

The plates 211 through 216 are disposed at positions the same as the plates 231 through 236 in the second direction and in the third direction, respectively.

The cases 21 and 23 constitute the arm 25 of the tape cassette 100A. Specifically, the arm 25 is constituted by the plates 21F and 23F. More specifically, the arm 25 is constituted by the plate 23D and the plate 231 through 234 of the case 23, and the partition plate 21M and the plates 211, 213, and 214 of the case 21.

The arm 25 has the discharge port 17 on the one end of the arm 25 (i.e., the one end of the arm 25 in the third direction). The discharge port 17 includes a discharge port 17A and a discharge port 17B.

As illustrated in FIG. 14, each of the discharge ports 17A and 17B has a slit shape extending in the first direction. The discharge port 17A is constituted by the plate 213 and the one end of the plate 94 (i.e., the one end of the plate 94 in the third direction).

In the second direction, the discharge port 17B is positioned closer to the one end of the housing 20 in the second direction than the discharge port 17A is to the one end of the housing 20 in the second direction. The discharge port 17B is constituted by the one end of the plate 94 (i.e., the one end of the plate 94 in the third direction) and the one end of the plate 211 (i.e., the one end of the plate 211 in the third direction).

The housing 20 further includes a guide 78. Specifically, the guide 78 is disposed on the one end of the plate 21R (i.e., the one end of the plate 21R in the second direction). The guide 78 has a slit extending in the first direction. The tape 41 that has been discharged out of the arm 25 through the discharge port 17 is to be conveyed toward the slit in the guide 78. The guide 78 is configured to guide the tape 41 passing through the slit of the guide 78 toward the discharge channel 9 of the printer 1.

The housing 20 has an inlet port 55. Specifically, the inlet port 55 is positioned between the one end of the plate 21R (i.e., the one end of the plate 21R in the second direction) and the guide 78. The inlet port 55 has a slit allowing the used ink ribbon 45 to enter the housing 20 again through the inlet port 55.

In the following description, a space located further toward the one side in the third direction than the arm 25 will also be referred to as the head opening 29. That is, the head opening 29 is a space between the arm 25 and the guide 78, and is also a space between the arm 25 and the inlet port 55.

As illustrated in FIG. 5, the case 22 includes a partition plate 22U and plates 22B, 22R, 22L, and 22F. Each of the partition plate 22U and the plates 22B, 22R, 22L, and 22F has a rectangular shape.

The partition plate 22U has plate surfaces which are orthogonal to the first direction. The partition plate 22U has openings 22H and 221H. A ribbon guide 229 and shafts 26 through 28 are disposed on the partition plate 22U.

The opening 22H is located on the corner of the partition plate 22U on the one side in the second direction and on the other side in the third direction. The opening 22H extends through the partition plate 22U in the first direction.

The opening 221H is located in the corner of the partition plate 22U on the other side in the second direction and on the other side in the third direction. The opening 221H extends through the partition plate 22U in the first direction. In a state where the case 23 is coupled to the case 22, the opening 221H is in communication with the opening 211H illustrated in FIG. 6.

The ribbon guide 229 and the shafts 26 through 28 extend in the first direction from the partition plate 22U.

The ribbon guide 229 is disposed on the corner of the partition plate 22U on the other side in the second direction and on the other side in the third direction. The other end of the ribbon guide 229 in the first direction is connected to the opening 221H. The ribbon guide 229 has a sloped surface 229A, which is curved. The sloped surface 229A is sloped to extend toward the one side in the second direction as the sloped surface 229A extends toward the one side in the first direction. The ribbon guide 229 is configured to guide the conveyance of the ink ribbon 45. Specifically, the ink ribbon 45 is to be conveyed while contacting the sloped surface 229A of the ribbon guide 229.

The shaft 26 is disposed on the corner of the partition plate 22U on the one side in the second direction and on the one side in the third direction. The shaft 27 is disposed on a portion of the partition plate 22U in the vicinity of the center in the second direction and in the vicinity of the center in the third direction. The shaft 28 is disposed on the other side of the shaft 27 in the second direction and on the one side of the shaft 27 in the third direction. The position of the shaft 28 corresponds to the position of the opening 23H.

The plate 22R is positioned at the one end of the partition plate 22U in the third direction. The plate 22R has plate surfaces which are orthogonal to the third direction. In the first direction, the partition plate 22U is positioned between the one end of the plate 22R in the first direction and the other end of the plate 22R in the first direction.

The plate 22B is positioned at the other end of the partition plate 22U in the second direction. The plate 22B has plate surfaces which are orthogonal to the second direction. In the first direction, the partition plate 22U is positioned between the one end of the plate 22B in the first direction and the other end of the plate 22B in the first direction.

The plate 22L is positioned at the other end of the partition plate 22U in the third direction. The plate 22L has plate surfaces which are orthogonal to the third direction. In the first direction, the partition plate 22U is positioned between the one end of the plate 22L in the first direction and the other end of the plate 22L in the first direction.

The plate 22F is positioned at the one end of the partition plate 22U in the second direction. The plate 22F has plate surfaces which are orthogonal to the second direction. In the first direction, the partition plate 22U is positioned between the one end of the plate 22F in the first direction and the other end of the plate 22F in the first direction.

The housing 20 also has an opening 16. More specifically, the opening 16 is positioned on the corner of the case 21 and the case 22 on the one side in the second direction and on the one side in the third direction.

As illustrated in FIG. 5, the case 24 includes plates 24U, 24R, 24B, 24L, and 24F. Each of the plates 24U, 24B, 24R, 24L, and 24F has a rectangular shape.

The plate 24U has plate surfaces which are orthogonal to the first direction. A shaft 243 is disposed on the plate 24U. Specifically, the shaft 243 is disposed on the corner of the plate 24U on the one side in the second direction and on the other side in the third direction. The shaft 243 extends toward the other side in the first direction from the plate 24U.

The plate 24R is positioned at the one end of the plate 24U in the third direction. The plate 24B is positioned at the other end of the plate 24U in the second direction. The plate 24L is positioned at the other end of the plate 24U in the third direction. The plate 24F is positioned at the one end of the plate 24U in the second direction.

The plates 24R, 24B, 24L, and 24F also extend toward the other side in the first direction from the plate 24U.

The partition plate 22U partitions the internal space of the housing 20 into a first space S1 and a second space S2 in the first direction.

The first space S1 is a space enclosed by the plates 23D, 23F, 23B, 23L, and 23R of the case 23, the plates 21F, 21B, 21L, and 21R of the case 21, and the partition plate 22U and the plates 22F, 22B, 22L, and 22R of the case 22.

The second space S2 is a space enclosed by the partition plate 22U and the plates 22F, 22B, 22L, and 22R of the case 22, and the plates 24U, 24F, 24B, 24L, and 24R of the case 24.

The first space S1 and the second space S2 are arranged in the first direction. The first space S1 is located on the other side of the second space S2 in the first direction. The arm 25 defines the one end of the first space S1 in the second direction. The opening 23H is in communication with the first space S1.

The partition plate 21M partitions the first space S1 into a third space S3 and a fourth space S4 in the first direction. The third space S3 and the fourth space S4 are arranged in the first direction. The third space S3 is positioned on the other side of the fourth space S4 in the first direction.

The third space S3 is a space enclosed by the plates 23D, 23F, 23B, 23L, and 23R of the case 23, and the partition plate 21M and the plates 21F, 21B, 21L, and 21R of the case 21.

The fourth space S4 is a space enclosed by the partition plate 21M and the plates 21F, 21B, 21L, and 21R of the case 21, and the partition plate 22U and the plates 22F, 22B, 22L, and 22R of the case 22.

As illustrated in FIGS. 5 and 9 through 13, the tape roll 41A, the ribbon roll 45A, the gears 30, the discharge ports 17A and 17B, and the inlet port 55 are positioned in the first space S1 of the tape cassette 100A.

Specifically, the tape roll 41A, the ribbon roll 45A, the discharge ports 17A and 17B, and the inlet port 55 are positioned in the third space S3.

In the third space S3, the tape roll 41A is disposed on the corner of the partition plate 21M on the other end in the second direction and on the other end in the third direction, as illustrated in FIGS. 6, 8, and 11. The holder 421 is fitted inside the tape spool 47. The shaft 237 is fitted inside the holder 421.

The shaft 217 is inserted in the holder 421. The shaft 217 has the rotation axis L21 extending in the first direction. Accordingly, the tape spool 47 is rotatable about the rotation axis L21.

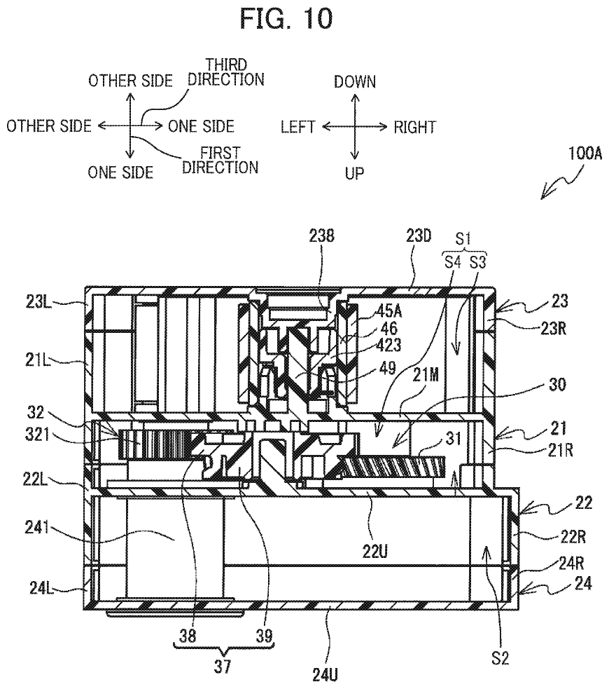

As illustrated in FIGS. 6 and 10, in the third space S3, the ribbon roll 45A is disposed in the vicinity of the center of the partition plate 21M in the third direction. Specifically, in the third space S3, the ribbon roll 45A is positioned between the plate 215 and the center in the second direction of the partition plate 21M.

The holder 423 is fitted inside the ribbon spool 46. The shaft 238 is fitted inside the holder 423. The shaft 49 is inserted in the holder 423. The shaft 49 has the rotation axis L23 extending in the first direction. With this configuration, the ribbon spool 46 is rotatable about the rotation axis L23.

In the third space S3, the discharge port 17A is positioned at the one end of the arm 25 (i.e., the one end of the arm 25 in the third direction). The discharge port 17A allows the ink ribbon 45 to be discharged from the third space S3 through the discharge port 17A.

In the third space S3, the discharge port 17B is also positioned at the one end of the arm 25 (i.e., the one end of the arm 25 in the third direction). The discharge port 17B allows the tape 41 to be discharged from the third space S3 through the discharge port 17B.

The discharge port 17A is positioned between the discharge port 17B and the ribbon roll 45A in the second direction.

In the third space S3, the inlet port 55 is positioned on the corner on the one side in the second direction and on the one side in the third direction. The inlet port 55 allows the ink ribbon 45 to enter the third space S3 again through the inlet port 55.

As illustrated in FIGS. 10 through 13, the gears 30 are positioned in the fourth space S4. The gears 30 are configured to transmit a drive force transmitted through the transmission gear 679 on the shaft 66E of the drive shaft 63 to the platen roller 82.

The gears 30 include the gears 34 and 31, and gears 37 and 32. The gear 34 is fitted over the shaft 28. The gear 31 is fitted over the shaft 26. The gear 37 is fitted over the shaft 27. The gear 32 is inserted through the opening 22H.

The gear 34 is rotatable about the shaft 28. The position of the gear 34 in the second direction and in the third direction is the same as the positions of the openings 23H and 21H in the second direction and in the third direction.

The gear 34 is coupled to the gear 31 through the gear 37. The gear 34 is configured to transmit a drive force to the gear 31. The gear 34 includes a gear 35 and a cam 36. The gear 35 is an external gear that is in meshing engagement with a gear 38 of the gear 37. The gear 35 is coupled to the cam 36.

The cam 36 is fixed to the gear 35 in the first direction. The cam 36 extends toward the other side in the first direction from the gear 35. The cam 36 is an internal gear having a hollow cylindrical shape. Specifically, the cam 36 has splines 361 on the inner circumferential surface of the cam 36. The shaft 66E of the drive shaft 63 is configured to be inserted into the cam 36 from the other side in the first direction.

A part of the cam 36 is inserted in the third space S3 from the fourth space S4. The cam 36 is exposed to the outside of the housing 20 through the opening 23H. Note that the phrase “the cam 36 is exposed” denotes a state in which the cam 36 is visible by the user.

The gear 31 is an external gear. The gear 31 is rotatable about the shaft 26 extending in the first direction. The gear 31 is positioned further toward the one side in the second direction than the gear 34 to be spaced apart from the gear 34.

The gear 31 is configured to transmit, to the platen gear 83, a drive force for conveying the tape 41. The gear 31 is so-called a helical gear. The gear teeth on the gear 31 are helical (i.e., skewed) relative to the first direction at a predetermined angle. The gear teeth on the gear 31 are of the opposite hand to the gear teeth on the platen gear 83.

In a state where the tape cassette 100A is attached to the cassette attachment portion 10, the gear 31 meshes with the platen gear 83 in the space in communication with the head opening 29.

A part of the gear 31 is exposed to the outside of the housing 20 through the opening 16. That is, a part of the gear 31 is exposed to the space in communication with the head opening 29. Note that the phrase “the gear 31 is exposed” denotes a state in which the gear 31 is visible by the user.

The gear 37 is in meshing engagement with both the gear 31 and the gear 34. The gear 37 is configured to transmit a drive force inputted into the gear 34 to the gear 31.

Specifically, the gear 37 is configured to transmit a drive force inputted into the gear 34 to the gear 31 while reducing a rotational speed of the drive force. That is, the gears 30 include a reduction mechanism.

The gear 37 is a double gear including the gear 38 and a gear 39. The gears 38 and 39 are arranged side by side and coaxial with each other. The diameter of the gear 39 is smaller than the diameter of the gear 38. In the first direction, the gear 38 is positioned closer to the tape roll 41A than the gear 39 is to the tape roll 41A.

The gear 38 is in meshing engagement with the gear 34. The gear 38 is an external spur gear.

The gear 39 is in meshing engagement with the gear 31. The gear 39 is an external helical gear. The gear 39 has gear teeth which are of the opposite hand to the gear teeth on the gear 31.

The gear 32 includes a gear 321, a cam 323, and a shaft 325. The gear 321 is in meshing engagement with the gear 38. The cam 323 extends toward the one side in the first direction from the gear 321. The one end portion of the cam 323 in the first direction has a plurality of recessed portions. The shaft 325 extends in the first direction from the center of the gear 321.

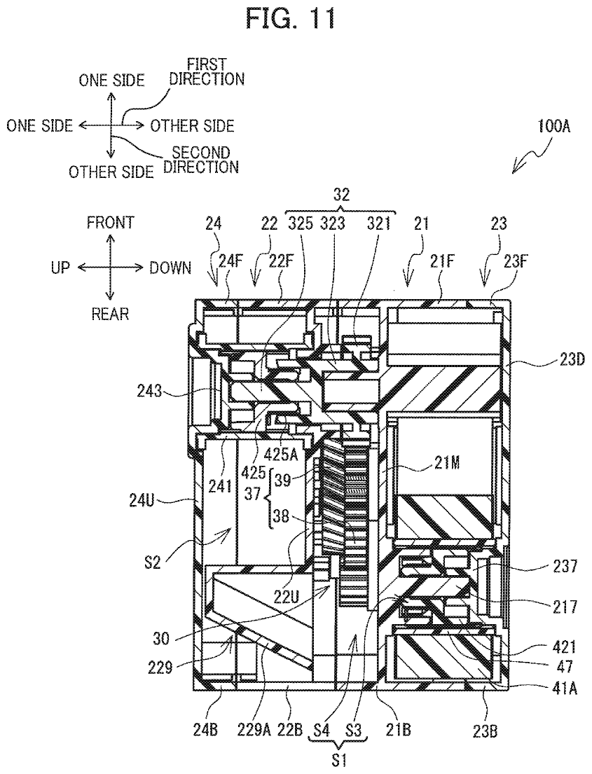

As illustrated in FIG. 11, a part of the gear 32 (i.e., the cam 323 and the shaft 325) is inserted in the second space S2 from the fourth space S4.

As illustrated in FIG. 11, the take-up spool 241 is positioned in the second space S2 in the tape cassette 100A. The take-up spool 241 is positioned on the corner in the second space S2 on the one side in the second direction and on the other side in the third direction.

As illustrated in FIG. 11, a holder 425 is fitted inside the take-up spool 241. The shaft 243 is fitted inside the holder 425. That is, the shaft 243 is inserted in the holder 425.

Further, the shaft 325 is inserted in the holder 425. The shafts 243 and 325 have a rotation axis L4 extending in the first direction. That is, the take-up spool 241 is rotatable about the rotation axis L4 extending in the first direction.

A clutch spring 425A is mounted on the other end portion of the holder 425 in the first direction. Each of the two arms of the clutch spring 425A is fitted in one of the recessed portions of the cam 323. A drive force due to the rotation of the gear 321 is to be transmitted to the take-up spool 241 through the clutch spring 425A.

Next, the positional relationship among the components in the tape cassette 100A will be described with reference to FIG. 8. In the following description, the phrase “a component overlaps another component” denotes that at least a part of the component overlaps at least a part of the other component when viewed from the one side or the other side in the corresponding direction. Further, the phrase “a component does not overlap another component” denotes that the component does not overlap the other component when viewed from the one side or the other side in the corresponding direction. These phrases do not denote that the component and the other component are physically in contact with each other.

The ribbon roll 45A does not overlap either the tape roll 41A or the take-up spool 241 in the first direction. The ribbon roll 45A does not overlap the take-up spool 241 in the second direction. The ribbon roll 45A does not overlap the take-up spool 241 in the third direction. The ribbon roll 45A overlaps the tape roll 41A in the second direction. The ribbon roll 45A overlaps the tape roll 41A in the third direction.

The take-up spool 241 does not overlap either the tape roll 41A or the ribbon roll 45A in the first direction. In the first direction, the other end of the take-up spool 241 in the first direction are spaced apart from both the one end of the tape roll 41A in the first direction and the one end of the ribbon roll 45A in the first direction. The take-up spool 241 does not overlap either the ribbon roll 45A or the tape roll 41A in the second direction. The take-up spool 241 does not overlap either the ribbon roll 45A or the tape roll 41A in the third direction.

The gear 34 does not overlap any of the tape roll 41A, the ribbon roll 45A, or the take-up spool 241 in the first direction. A part of the gear 34 (i.e., the gear 35) does not overlap any of the tape roll 41A, the ribbon roll 45A, or the take-up spool 241 in the second direction. Further, a part of the gear 34 (i.e., the gear 35) does not overlap any of the tape roll 41A, the ribbon roll 45A, or the take-up spool 241 in the third direction. A part of the gear 34 (i.e., the cam 36) overlaps both the tape roll 41A and the ribbon roll 45A in the second direction. Further, a part of the gear 34 (i.e., the cam 36) overlaps both the tape roll 41A and the ribbon roll 45A in the third direction.

The gear 37 overlaps the ribbon roll 45A in the first direction. A part of the gear 37 overlaps a part of the tape roll 41A in the first direction. A part of the gear 37 overlaps a part of the take-up spool 241 in the first direction. The gear 37 does not overlap any of the ribbon roll 45A, the tape roll 41A, or the take-up spool 241 in the second direction. The gear 37 does not overlap any of the ribbon roll 45A, the tape roll 41A, or the take-up spool 241 in the third direction.

A part of the gear 31 overlaps a part of the ribbon roll 45A in the first direction. The gear 31 does not overlap either the tape roll 41A or the take-up spool 241 in the first direction. The gear 31 does not overlap any of the tape roll 41A, the ribbon roll 45A, or the take-up spool 241 in the second direction. The gear 31 does not overlap any of the tape roll 41A, the ribbon roll 45A, or the take-up spool 241 in the third direction.

The gear 32 overlaps the take-up spool 241 in the first direction. A part of the gear 32 (i.e., the gear 321) does not overlap any of the tape roll 41A, the ribbon roll 45A, or the take-up spool 241 in the second direction. Also, a part of the gear 32 (i.e., the gear 321) does not overlap any of the tape roll 41A, the ribbon roll 45A, or the take-up spool 241 in the third direction. A part of the gear 32 (i.e., the cam 323) overlaps the take-up spool 241 in the second direction. Also, a part of the gear 32 (i.e., the cam 323) overlaps the take-up spool 241 in the third direction.

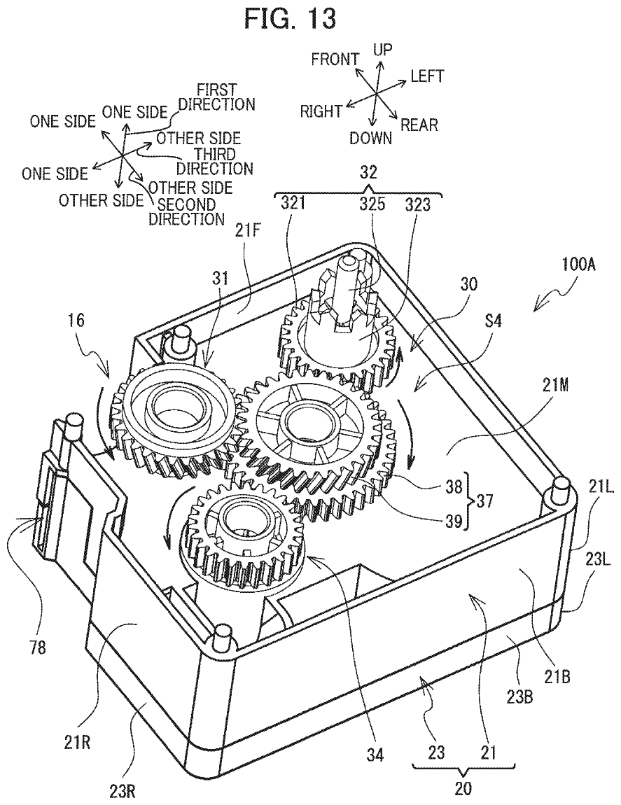

Next, the printing operations performed with the printer 1 and the tape cassette 100A will be described with reference to FIGS. 13 through 16. The user attaches the tape cassette 100A to the cassette attachment portion 10, thereby positioning the print head 71 in the head opening 29 at a position in which the print head 71 overlaps both the tape 41 and the ink ribbon 45 in the second direction.

The shaft 66E of the drive shaft 63 is inserted in the cam 36 of the gear 34 positioned in the fourth space S4. The platen roller 82 is moved to the adjacent position. As a result, the platen gear 83 is brought into meshing engagement with the gear 31.

As illustrated in FIG. 13, in a state where the tape cassette 100A is attached to the cassette attachment portion 10, the gear 34 is rotated together with the cam 36 due to the rotation of the shaft 66E of the drive shaft 63. The gear 37 is also rotated in accordance with the rotation of the gear 34. The gear 31 is also rotated in accordance with the rotation of the gear 37. The platen gear 83 is also rotated in accordance with the rotation of the gear 31, thereby rotating the platen roller 82.

As illustrated in FIG. 14, the tape 41 is drawn off the tape roll 41A in the third space S3 due to the rotation of the platen roller 82. At the same time, the ink ribbon 45 is drawn off the ribbon roll 45A in the third space S3 due to the rotation of the take-up spool 241.

In the third space S3, the tape 41 that has been drawn off the tape roll 41A is guided by the tape guide 442. Specifically, the tape 41 is conveyed in the second direction between the plate 21L and the plate 93.

The tape 41 is guided by the tape guide 442 toward the discharge port 17B. At this time, the tape 41 is conveyed toward the one side in the third direction through the gap between the plate 211 and the plate 94. Then, the tape 41 is discharged through the discharge port 17B to the outside of the housing 20, i.e., an outside of the third space S3.

In the meantime, in the third space S3, the ink ribbon 45 is conveyed toward the one side in the second direction toward the guide 97 in the arm 25. Specifically, the ink ribbon 45 is conveyed toward the one side in the second direction through the gap between the plate 93 and the plate 214.

After reaching the guide 97, the ink ribbon 45 is conveyed toward the discharge port 17A. That is, the ink ribbon 45 is conveyed toward the one side in the third direction through the gap between the plate 94 and the plate 213. Then, the ink ribbon 45 is discharged to the outside of the housing 20 through the discharge port 17A.

The tape 41 and the ink ribbon 45 which have been discharged through the discharge port 17 are conveyed toward the head opening 29. In the head opening 29, the platen roller 82 presses the tape 41 against the print head 71 through the ink ribbon 45. At this time, selected one or more heating elements 71A are heated in the print head 71, whereby some of the ink contained in the surface of the ink ribbon 45 is transferred to the tape 41. As a result, characters or symbols are printed on the tape 41.

The tape 41 on which printing has been performed is guided toward the discharge channel 9 in the printer 1 by the guide 78. That is, the tape 41 that has been discharged through the discharge port 17B does not return to an inside of the housing 20.

In the meantime, in the second space S2, the cam 323 is rotated together with the rotation of the gear 32. Since the clutch spring 425A is disposed between the cam 323 and the holder 425, the holder 425 is also rotated, thereby rotating the take-up spool 241 together with the holder 425.

In accordance with the rotation of the take-up spool 241, the used ink ribbon 45 is conveyed toward the inlet port 55. As the inlet port 55 guides the ink ribbon 45, the ink ribbon 45 is conveyed toward the third space S3 again.

In the third space S3, the ink ribbon 45 is conveyed toward the ribbon guide 219. At this time, the ink ribbon 45 is conveyed toward the other side in the second direction between the plate 21R and the plate 216.

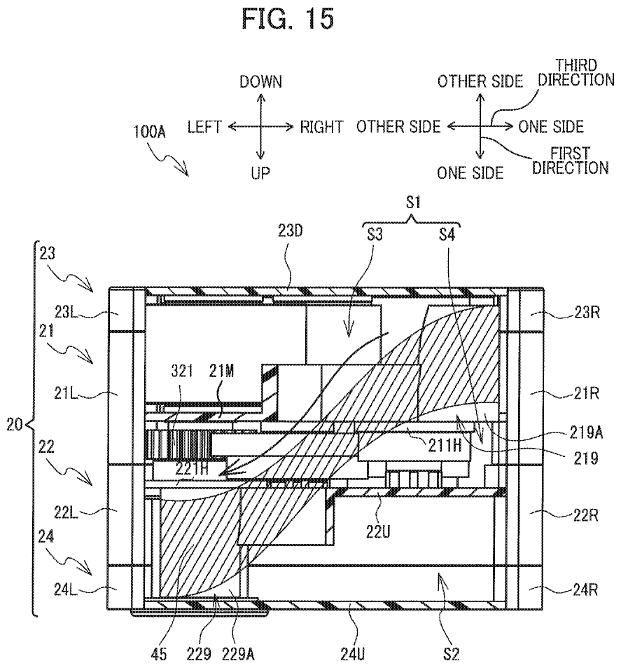

As illustrated in FIG. 15, the conveying direction in which the ink ribbon 45 is conveyed is changed by the sloped surface 219A of the ribbon guide 219. Specifically, the ink ribbon 45 is conveyed toward the one side in the first direction and the other side in the third direction toward the ribbon guide 229 in the second space S2.

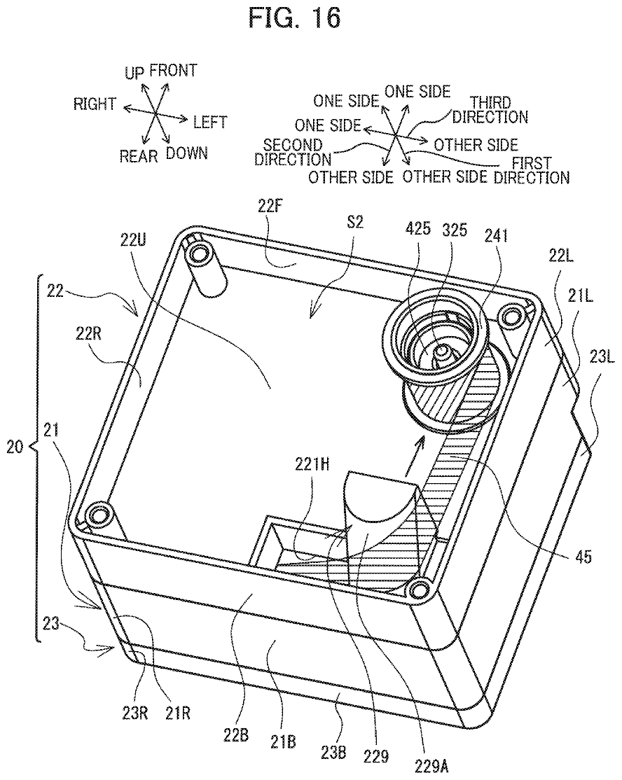

As illustrated in FIG. 16, the conveying direction of the ink ribbon 45 is further changed by the sloped surface 229A of the ribbon guide 229. The ink ribbon 45 is conveyed toward the one side in the second direction toward the take-up spool 241. The ink ribbon 45 is finally taken up by the take-up spool 241.

Once the printing operation has been completed, the user cuts off the printed tape 41 from the printer 1.

As described above, the tape spool 47 is positioned in the housing 20. The tape roll 41A is mounted on the tape spool 47. The ribbon spool 46 is positioned in the housing 20. The ribbon roll 45A is mounted on the ribbon spool 46. The discharge port 17A is positioned in the first space S1 (more specifically, in the plate 21F that defines the first space S1). The discharge port 17A allows the ink ribbon 45 to be discharged to the outside of the housing 20. The inlet port 55 is also positioned in the first space S1 (more specifically, in the plate 21F that defines the first space S1). The inlet port 55 allows the ink ribbon 45 to enter the housing 20.

The ribbon guides 219 and 229 are positioned for guiding the ink ribbon 45 during the conveyance of the ink ribbon 45 from the first space S1 toward the second space S2. The ribbon guide 219 is positioned in the first space S1, while the ribbon guide 229 is positioned in the second space S2. The ribbon spool 46 and the take-up spool 241 are spaced apart from each other in the first direction. The ribbon spool 46, the tape roll 41A, and the tape spool 47 are positioned in the first space S1. The ink ribbon 45 drawn off the ribbon roll 45A is conveyed through the discharge port 17A and the inlet port 55 and conveyed along the ribbon guides 219 and 229, in order, and is taken up by the take-up spool 241. That is, in the conveying direction in which the ink ribbon 45 drawn off the ribbon roll 45A is conveyed from the ribbon roll 45A to the take-up spool 241, the ribbon roll 45A, the discharge port 17A, the inlet port 55, the ribbon guides 219 and 229, and the take-up spool 241 are arranged in order from upstream to downstream. The components can be appropriately positioned in the tape cassette 100A.

The discharge port 17B is positioned in the first space S1 (more specifically, in the plate 21F that defines the first space S1). The discharge port 17B allows the tape 41 to be discharged to the outside of the housing 20. The tape guide 442 is positioned in the first space S1. The tape guide 442 is positioned for guiding the tape 41 during the conveyance of the tape 41. The tape 41 drawn off the tape roll 41A is conveyed to the discharge port 17B after conveyed along the tape guide 442. That is, in the conveying direction in which the tape 41 drawn off the tape roll 41A is conveyed from the tape roll 41A to the discharge port 17B, the tape roll 41A, the tape guide 442, and the discharge port 17B are arranged in order from upstream to downstream. In the tape cassette 100A, the tape 41 drawn off the tape roll 41A can be conveyed to the discharge port 17B via the tape guide 442.

The take-up spool 241 does not overlap the ribbon roll 45A in the first direction. The take-up spool 241 does not overlap the ribbon roll 45A in the second direction orthogonal to the first direction. The take-up spool 241 and the ribbon roll 45A can be arranged to be offset from each other in the tape cassette 100A.

The take-up spool 241 does not overlap the tape roll 41A in the first direction. The take-up spool 241 does not overlap the ribbon roll 45A in the second direction orthogonal to the first direction. The take-up spool 241, the tape roll 41A, and the ribbon roll 45A can be arranged offset from one another in the tape cassette 100A.

The partition plate 21M partitions the first space S1 into the third space S3 and the fourth space S4 in the first direction. The ribbon roll 45A is positioned in the third space S3. The gears 30 are positioned in the fourth space S4. In the tape cassette 100A, the ribbon roll 45A can be arranged in the third space S3, and the gears 30 can be arranged in the fourth space S4.

The gears 30 include the gear 31. A part of the gear 31 is exposed to the outside of the housing 20. The tape cassette 100A can expose the gear 31 to the outside of the housing 20.

The gear 31 overlaps the ribbon roll 45A in the first direction. The tape cassette 100A enables the gear 31 and the ribbon roll 45A to be arranged to overlap each other.

The gears 30 include the gear 32 coupled to the take-up spool 241. The tape cassette 100A can drive the take-up spool 241 using the gear 32.

The gear 32 overlaps the take-up spool 241 in the first direction. The tape cassette 100A enables the gear 32 and the take-up spool 241 to be arranged to overlap each other in the first direction.

The gears 30 include the gear 37 in engagement with the gear 31. The tape cassette 100A can accommodate not only the gears 31 and 32 but also the gear 37.

The gear 37 overlaps the ribbon roll 45A in the first direction. The tape cassette 100A enables the gear 37 and the ribbon roll 45A to be arranged to overlap each other in the first direction.

The gear 37 overlaps the tape roll 41A in the first direction. The gear 37 and the tape roll 41A can be arranged to overlap each other in the first direction in the tape cassette 100A.

The gears 30 include the gear 34 for receiving a drive force. The tape cassette 100A can accommodate the gear 34.

The rotation axis L23 is an example of the “axis”. The partition plate 22U is an example of the “first partition plate”. The surfaces of the plate 23D are an example of the “first surface”. The surfaces of the plate 24U are an example of the “second surface”. The case 23 is an example of the “first case”. The case 24 is an example of the “second case”. The discharge port 17A is an example of the “discharge port”.

The present disclosure is not limited to the embodiment described above, and various modifications may be made to the above embodiment. Note that the configurations in the modifications described below may be appropriately combined as long as they are not contradictory.

In the above embodiment, the housing 20 employs the configuration illustrated in FIG. 5 but is not limited to this configuration. The shapes of the cases 21 through 24 may be modified as appropriate, for example. The internal space of the housing 20 is a region enclosed by the outer shell of the housing 20, i.e., by the cases 21 through 24. Each of the cases 21 through 24 may have a part having one or more holes and/or openings other than those described in the above embodiment.

Although the second space S2 and the third space S3 are spaced apart from each other in the first direction in the above embodiment, the present disclosure need not be limited to this configuration. For example, the second space S2 and the third space S3 may be adjacent to each other in the first direction. For example, the second space S2, the third space S3, and the fourth space S4 may be arranged in order of the second space S2, the third space S3, and the fourth space S4 in the first direction. That is, the order of the first space S1 through the fourth space S4 may be changed appropriately.

In the above embodiment, the first space S1 through the fourth space S4 are defined in the housing 20 using the partition plates 21M and 22U. However, other configurations may be employed. The components other than the partition plates 21M and 22U, such as shafts or ribs, may be used to define the spaces in the housing 20. In this case, the partition plates 21M and 22U may be omitted. Any configuration can be employed as long as the ribbon roll 45A and the take-up spool 241 are arranged to be offset from each other in the first direction.

In the above embodiment, the internal space of the housing 20 is partitioned into the first space S1 and the second space S2 using the partition plate 22U, but different configurations may be employed. The position of the partition plate 22U may be changed appropriately. That is, the sizes of the first space S1 and the second space S2 can be adjusted as appropriate depending on the dimensions of the tape 41, the ink ribbon 45, and the take-up spool 241, for example.

The partition plate 22U may not be a flat plate extending both in the second direction and the third direction. For example, a part of or the entirety of the partition plate 22U may be curved. The partition plate 22U may be constituted by plates having lattice shapes. The partition plate 22U may have any shape as long as the partition plate 22U can partition the internal space of the housing 20 into the first space S1 and the second space S2. Note that “partitioning the internal space into the first space S1 and the second space S2” denotes that a component exists between the first space S1 and the second space S2 as a boundary. For example, more than half of the partition plate 22U may be occupied by a hole.

In the above embodiment, the partition plate 21M partitions the first space S1 into the third space S3 and the fourth space S4. However, other configurations may be employed. The position of the partition plate 21M may be changed appropriately. In other words, the sizes of the third space S3 and the fourth space S4 can be adjusted as appropriate depending on the dimensions of the tape 41 and the gears 30, for example.

The partition plate 21M may not be a flat plate that is orthogonal to the first direction. A part of or the entirety of the partition plate 21M may be curved, for example. The partition plate 21M may have any shape provided that the partition plate 21M can partition the first space S1 into the third space S3 and the fourth space S4. Note that “partitioning the first space S1 into the third space S3 and the fourth space S4” denotes that a component exists between the third space S3 and the fourth space S4 as a boundary. For example, more than half of the partition plate 21M may be occupied by a hole.

In the above embodiment, the gears 30 include the gears 31, 32, 37, and 34. However, the present disclosure is not limited to the above configuration. The configuration of the gears 30 and the number of gears in the gears 30 may be changed appropriately. For example, the gear 37 may be dispensed with. In this case, the gear 35 of the gear 34 is in direct engagement with the gear 32. The dimensions of the gears 34, 31, and 37 may be changed as appropriate.

In the above embodiment, the gear 37 is a double gear. However, other configurations may be employed. The gear 37 may be a single gear, for example.

Although the gears 30 include the gears 34, 37, and 38, the present disclosure is not limited to this configuration. For example, the gears 30 may be configured to transmit a drive force using spur gears, helical gears, external gears, internal gears, worm gears and worm wheels.

The gears 30 may instead be configured to transmit a drive force using components other than gears rotatable about their axes, such as toothed belts and toothed pulleys, bevel gears and drive shafts, and rack and pinion mechanisms, for example.

In the above embodiment, the shaft 962 and the tape guide 442 are arranged on the partition plate 21M of the case 21. However, the shaft 962 and the tape guide 442 may be arranged on portions other than the partition plate 21M. For example, the shaft 962 may be arranged on the plate 23D of the case 23. The shaft 962 can be arranged on any suitable portion as long as the tape guide 442 can be arranged on a position in which the tape guide 442 can guide the tape 41 in the third space S3.

Although the tape roll 41A is a roll in which the tape 41 is wound about the tape spool 47 in the above embodiment, different configurations may be employed. The tape roll 41A may be a roll in which the tape 41 alone (i.e., the tape 41 itself) is wound, for example. That is, the tape 41 may not be wound about the tape spool 47 to form the tape roll 41A.

In the above embodiment, the ribbon roll 45A is a roll in which the ribbon roll 45A is wound about the ribbon spool 46. However, the present disclosure is not limited to this configuration. For example, the ribbon roll 45A may be a roll in which the ink ribbon 45 alone (i.e., the ink ribbon 45 itself) is wound. That is, the ink ribbon 45 may not be wound about the ribbon spool 46 to form the ribbon roll 45A.

The cam 36 may be omitted from the gear 34. The opening 21H may be omitted from the housing 20. The opening 23H may also be omitted from the housing 20. The cam 36 may not be exposed to the outside of the housing 20 through the openings 21H and 23H.

The positions of the ribbon guides 219 and 229 in the housing 20 according to the above embodiment can be changed as appropriate. The positions of the openings 211H and 221H can be changed as appropriate in accordance with the positions of the respective ribbon guides 219 and 229. The shapes of the ribbon guides 219 and 229 can also be changed as appropriate. That is, the ribbon guides 219 and 229 may have any shapes as long as the ribbon guides 219 and 229 can guide the conveyance of the ink ribbon 45.

The positions of the ribbon roll 45A, the tape roll 41A, the take-up spool 241, and the gears 30 in the first direction, in the second direction, and in the third direction can be changed appropriately. That is, the ribbon roll 45A, the tape roll 41A, the take-up spool 241, and the gears 30 may overlap one another or may not overlap one another in each direction.

Note that the modifications described above may be applied not only to the tape cassette 100A but also to tape cassettes 100B through 100E which will be described later, as long as they are not contradictory.

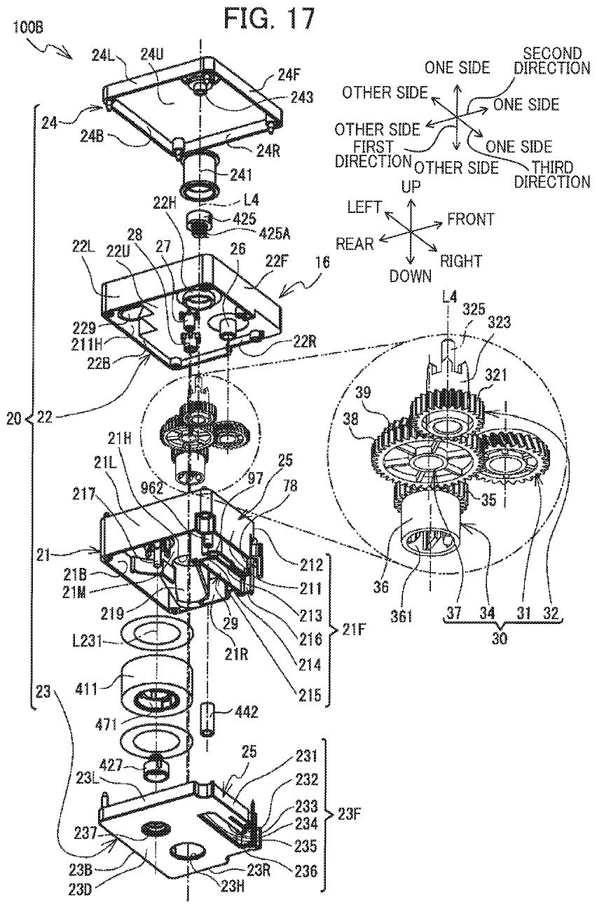

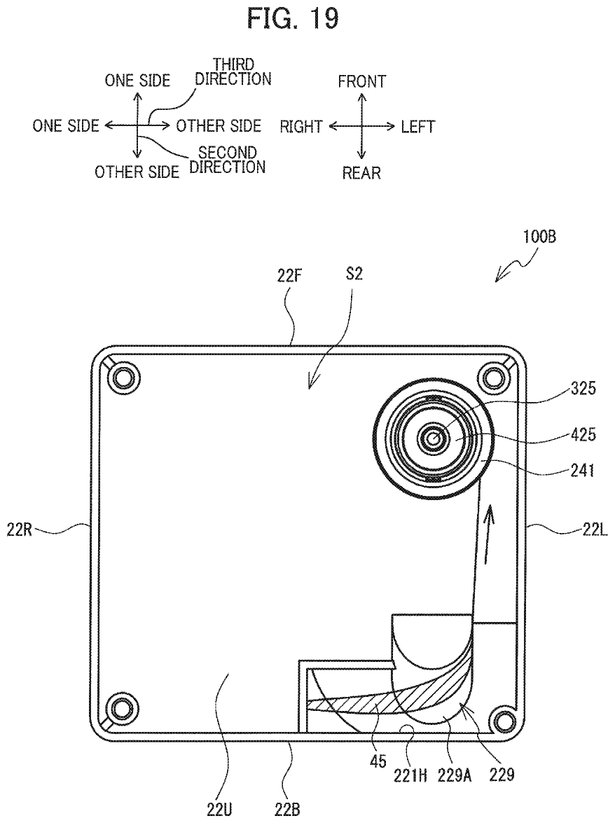

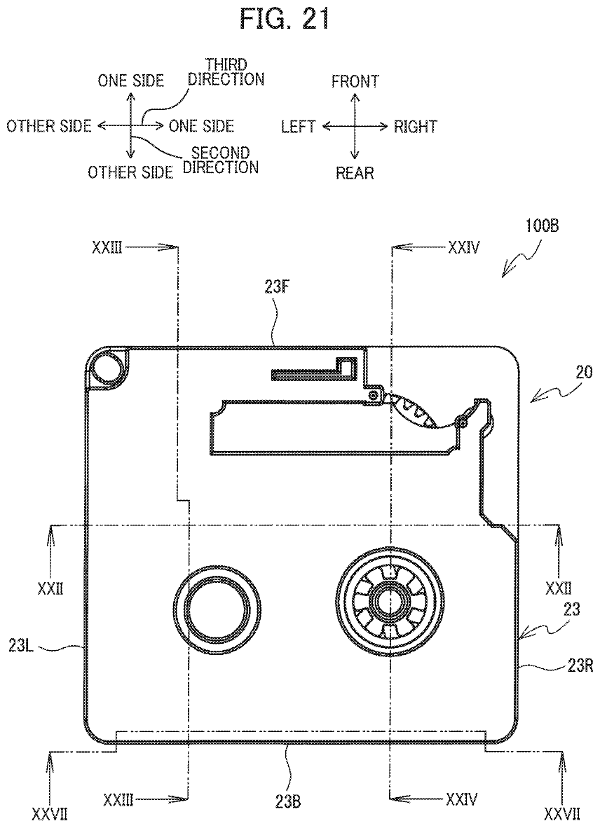

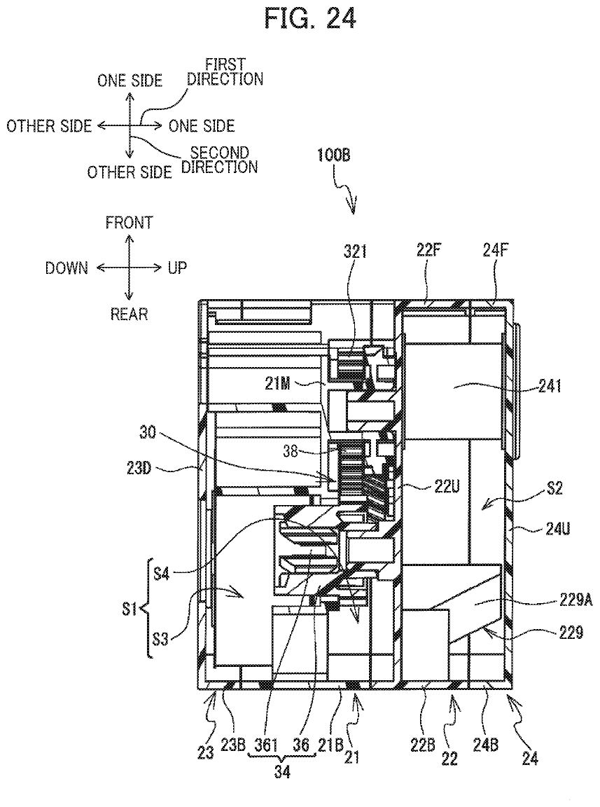

Next, the tape cassette 100B according to a modification of the present disclosure will be described with reference to FIGS. 17 through 28. The tape cassette 100B is attachable to the cassette attachment portion 10 illustrated in FIG. 2. Replenishment of the tape and change of the type (for example, the size, the color, and the material) of the tape can be performed by replacing the tape cassette 100B attached to the cassette attachment portion 10 of the printer 1.

The tape cassette 100B includes a housing 20, a roll 411, a take-up spool 241, and gears 30. As illustrated in FIG. 17, the outer shape of the tape cassette 100B is a rectangular parallelepiped shape. That is, the housing 20 has a rectangular parallelepiped shape. The housing 20 accommodates the roll 411, the take-up spool 241, and the gears 30.

In the housing 20, the roll 411 is positioned on the other side in the second direction and on the other side in the third direction. In the housing 20, a spool 471 is also positioned on the other side in the second direction and on the other side in the third direction.

The roll 411 is a roll in which a tape 41 and an ink ribbon 45 are wound together in an overlaid state. That is, the roll 411 serves not only as a tape roll but also as a ribbon roll.

The spool 471 has a hollow cylindrical shape elongated in the first direction. Each of the tape 41 and the ink ribbon 45 has a strip shape. The tape 41 includes a printing tape having adhesive coated on one surface and a releasing paper bonded to the one surface of the printing tape to cover the same, for example. The tape 41 is to be overlaid on the ink ribbon 45 to be subjected to printing by the print head 71.

The tape 41 and the ink ribbon 45 are wound about the spool 471. The spool 471 is rotatable about a rotation axis L231 extending in the first direction with the tape 41 and the ink ribbon 45 wound about the spool 471. The roll 411 is also rotatable about the rotation axis L231 extending in the first direction. The rotation axis L231 is an imaginary axis. The rotation axis L231 passes through the center of the roll 411.

As illustrated in FIG. 17, the housing 20 of the tape cassette 100B includes an arm 25. The arm 25 is positioned at the one end portion of the housing 20 in the second direction. In the second direction, the arm 25 is positioned closer to the one end portion of the housing 20 in the second direction than to the other end portion of the housing 20 in the second direction.

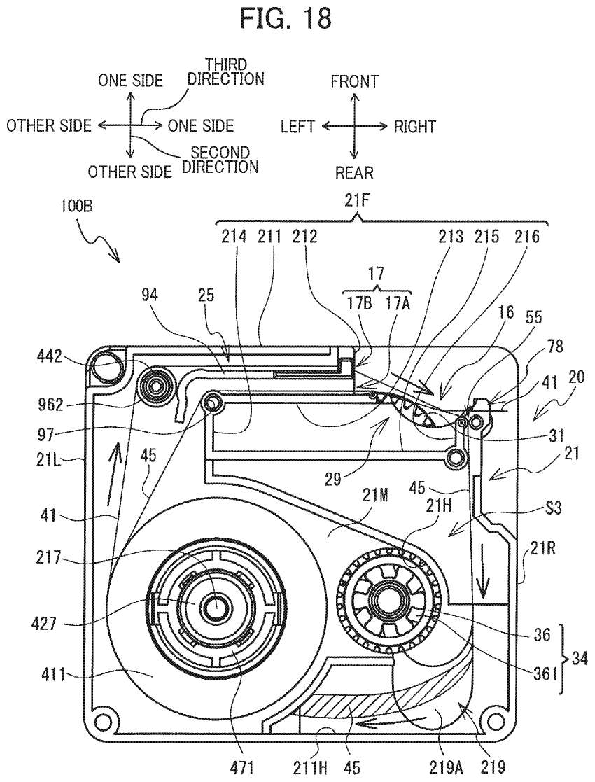

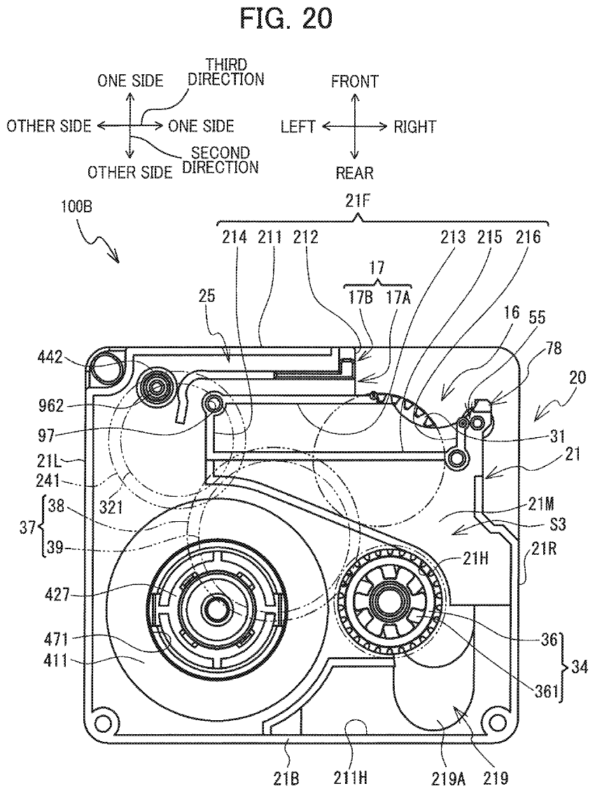

As illustrated in FIGS. 18 and 20, the arm 25 has a discharge port 17. The discharge port 17 allows the tape 41 and the ink ribbon 45 to be discharged to an outside of the housing 20 through the discharge port 17. The arm 25 and the discharge port 17 will be described later in detail.

As illustrated in FIG. 17, the housing 20 includes a case 21, a case 22, a case 23, and a case 24.

The case 23 constitutes the other end of the housing 20 in the first direction. The case 21 is disposed on the one side of the case 23 in the first direction. The case 21 is coupled to the one end of the case 23 in the first direction.

The case 22 is disposed on the one side of the case 21 in the first direction. The case 22 is coupled to the one end of the case 21 in the first direction.

The case 24 constitutes the one end of the housing 20 in the first direction. The case 24 is disposed on the one side of the case 22 in the first direction. The case 24 is coupled to the one end of the case 22 in the first direction.

As illustrated in FIG. 17, the case 23 includes plates 23D, 23R, 23B, 23L, and 23F. Each of the plates 23D, 23B, 23R, and 23L has a rectangular shape.

The plate 23D has plate surfaces that are orthogonal to the first direction. The plate 23D has an opening 23H. A shaft 237 is disposed on the plate 23D. In the plate 23D, the opening 23H is located on the other side in the second direction and on the one side in the third direction. The opening 23H extends through the plate 23D in the first direction. The shaft 237 is disposed on the other end portion of the plate 23D in the third direction. The shaft 237 protrudes toward the one side in the first direction.

The plate 23R is positioned at the one end of the plate 23D in the third direction. The plate 23B is positioned at the other end of the plate 23D in the second direction. The plate 23L is positioned at the other end of the plate 23D in the third direction. The plates 23R, 23B, and 23L extend toward the one side in the first direction from the plate 23D.

The plate 23F is positioned at the one end of the plate 23D in the second direction. The plate 23F includes plates 231 through 236. Each of the plates 231 through 236 has a rectangular shape. Each of the plates 231, 233, and 235 has plate surfaces that are orthogonal to the second direction. Each of the plates 232, 234, and 236 has plate surfaces that are orthogonal to the third direction.

The plate 231 is positioned at the one end of the plate 23D in the first direction. The one end of the plate 232 (i.e., the one end of the plate 232 in the second direction) is connected to the one end of the plate 231 (i.e., the one end of the plate 231 in the third direction). The other end of the plate 232 (i.e., the other end of the plate 232 in the second direction) is connected to the one end of the plate 233 (i.e., the one end of the plate 233 in the third direction). The other end of the plate 233 (i.e., the other end of the plate 233 in the third direction) is connected to the one end of the plate 234 (i.e., the one end of the plate 234 in the second direction). The other end of the plate 234 (i.e., the other end of the plate 234 in the second direction) is connected to the other end of the plate 235 (i.e., the other end of the plate 235 in the third direction). The one end of the plate 235 (i.e., the other end of the plate 235 in the third direction) is connected to the other end of the plate 236 (i.e., the other end of the plate 236 in the second direction).

As illustrated in FIG. 17, the case 21 includes a partition plate 21M, and plates 21R, 21B, 21L, and 21F. Each of the partition plate 21M and the plates 21R, 21B, and 21L has a rectangular shape.

As illustrated in FIGS. 17 through 20, the partition plate 21M has plate surfaces that are orthogonal to the first direction. The partition plate 21M has openings 21H and 211H. A ribbon guide 219, a plate 94, and shafts 217 and 962 are disposed on the partition plate 21M.

In the partition plate 21M, the opening 21H is located on the other side in the second direction and on the one side in the third direction. The position of the opening 21H is the same as the position of the opening 23H. Specifically, the position of the opening 21H in the second direction and in the third direction is the same as the position of the opening 23H in the second direction and in the third direction. The opening 21H extends through the partition plate 21M in the up-down direction (i.e., in the first direction).

The opening 211H is located in the corner of the partition plate 21M on the other side in the second direction and on the one side in the third direction. The opening 211H extends through the partition plate 21M in the first direction. The other end of the partition plate 21M in the second direction and the one end of the partition plate 21M in the third direction are notched by the opening 211H.

The ribbon guide 219, the plate 94, and the shafts 217 and 962 extend toward the other side in the first direction from the partition plate 21M.

The ribbon guide 219 is disposed on the corner of the housing 20 on the other side in the second direction and on the one side in the third direction. Specifically, the ribbon guide 219 is disposed on the corner of the housing 20, i.e., at a position further toward the other side in the second direction and toward the one side in the third direction than the opening 21H. The one end of the ribbon guide 219 in the first direction is connected to the opening 211H.

The ribbon guide 219 has a sloped surface 219A, which is curved. The sloped surface 219A is sloped to extend toward the one side in the second direction as the sloped surface 219A extends toward the other side in the first direction. The ribbon guide 219 is configured to guide the conveyance of the ink ribbon 45. More specifically, the ink ribbon 45 is to be conveyed while contacting the sloped surface 219A of the ribbon guide 219.

The plate 94 is positioned between a plate 211 and a plate 213 of the plate 21F in the second direction. The plate 94 extends in the third direction. The plate 94 is positioned within the arm 25 (described later).

The shaft 217 is disposed on the corner of the partition plate 21M on the other side in the second direction and on the other side in the third direction. The center of the shaft 217 has the rotation axis L231. A holder 427 is fitted over the shaft 217. The holder 427 is rotatable about the rotation axis L231.

The shaft 962 is disposed on the corner of the partition plate 21M on the one side in the second direction and on the other side in the third direction. A tape guide 442 is fitted over the shaft 962. The tape guide 442 has a hollow cylindrical shape. The tape guide 442 is rotatable about the shaft 962.

The plate 21R is positioned at the one end of the housing 20 in the third direction. The plate 21R has plate surfaces which are orthogonal to the third direction. In the first direction, the partition plate 21M is positioned between the one end of the plate 21R in the first direction and the other end of the plate 21R in the first direction.

The plate 21B is positioned at the other end of the housing 20 in the second direction. The plate 21B has plate surfaces which are orthogonal to the second direction. In the first direction, the partition plate 21M is positioned between the one end of the plate 21B in the first direction and the other end of the plate 21B in the first direction.

The plate 21L is positioned at the other end of the housing 20 in the third direction. The plate 21L has plate surfaces which are orthogonal to the third direction. In the first direction, the partition plate 21M is positioned between the one end of the plate 21L in the first direction and the other end of the plate 21L in the first direction.

The plate 21F is positioned at the one end of the housing 20 in the second direction. The plate 21F includes plates 212 and 214 through 216 in addition to the plates 211 and 213. Each of the plates 211 through 216 has a rectangular shape. Each of the plates 211, 213, and 215 has plate surfaces which are orthogonal to the second direction. Each of the plates 212, 214, and 216 has plate surfaces which are orthogonal to the third direction.

The plate 211 is positioned at the one end of the partition plate 21M in the second direction. The plate 213 is positioned further toward the other side in the second direction than the plate 94. The plate 94 is positioned between the plate 211 and the plate 213 in the second direction. In other words, a gap is formed between the plate 94 and the plate 211, and a gap is formed between the plate 94 and the plate 213.

The one end of the plate 212 in the second direction is connected to the one end of the plate 211 in the third direction. The other end of the plate 212 in the second direction is connected to the one end of the plate 213 in the third direction. The plate 212 constitutes the discharge port 17 (described later).

The other end of the plate 213 in the third direction is connected to a guide 97. The guide 97 is connected to the one end of the plate 214 in the second direction. The other end of the plate 214 in the second direction is connected to the other end of the plate 215 in the third direction.

The one end of the plate 215 in the third direction is connected to the other end of the plate 216 in the second direction.

The plates 211 through 216 are disposed at positions the same as the plates 231 through 236 in the second direction and in the third direction, respectively.

The cases 21 and 23 constitute the arm 25 of the tape cassette 100B. Specifically, the arm 25 is constituted by the plates 21F and 23F. More specifically, the arm 25 is constituted by the plate 23D and the plates 231 through 234 of the case 23, and the partition plate 21M and the plates 211, 213, and 214 of the case 21.

The arm 25 has the discharge port 17 on the one end of the arm 25 in the third direction (i.e., the one end of the arm 25 in the third direction). The discharge port 17 includes a discharge port 17A and a discharge port 17B.

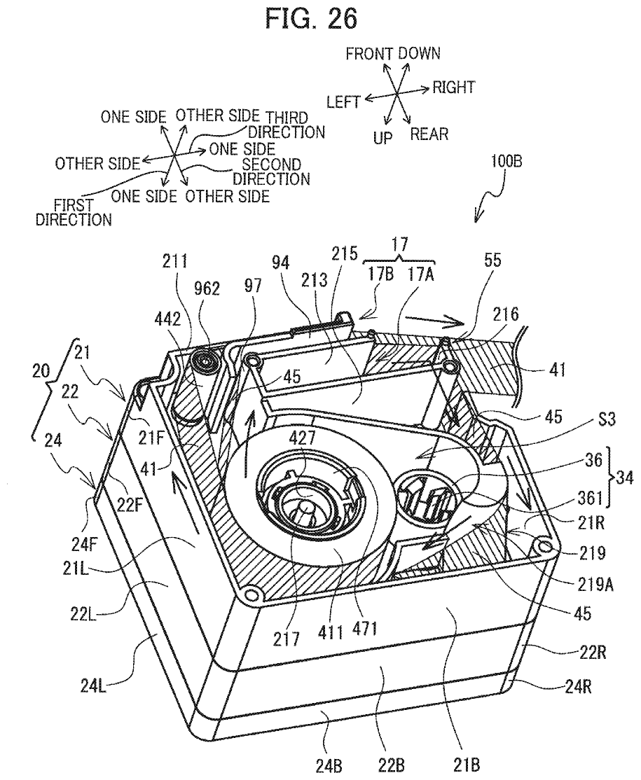

As illustrated in FIG. 26, each of the discharge ports 17A and 17B has a slit shape extending in the first direction. The discharge port 17A is defined by the plate 213 and the one end of the plate 94 (i.e., the one end of the plate 94 in the third direction).

In the second direction, the discharge port 17B is positioned closer to the one end of the housing 20 in the second direction than the discharge port 17A is to the one end of the housing 20 in the second direction. The discharge port 17B is constituted by the one end of the plate 94 (i.e., the one end of the plate 94 in the third direction) and the one end of the plate 211 (i.e., the one end of the plate 211 in the third direction).

The housing 20 also includes a guide 78. Specifically, the guide 78 is disposed on the one end of the plate 21R (i.e., the one end of the plate 21R in the second direction). The guide 78 has a slit extending in the first direction. The tape 41 that has been discharged out of the arm 25 through the discharge port 17 is to be conveyed toward the slit in the guide 78. The guide 78 is configured to guide the tape 41 passing through the slit of the guide 78 toward the discharge channel 9 of the printer 1.

The housing 20 has an inlet port 55. Specifically, the inlet port 55 is positioned between the one end of the plate 21R (i.e., the one end of the plate 21R in the second direction) and the guide 78. The inlet port 55 has a slit through which the used ink ribbon 45 enters the housing 20 again.

In the following description, a space located further toward the one side in the third direction than the arm 25 will also be referred to as a head opening 29. That is, the head opening 29 is a space between the arm 25 and the guide 78. The head opening 29 is also a space between the arm 25 and the inlet port 55.

As illustrated in FIG. 17, the case 22 includes a partition plate 22U and plates 22B, 22R, 22L, and 22F. Each of the partition plate 22U and the plates 22B, 22R, 22L, and 22F has a rectangular shape.

The partition plate 22U has plate surfaces which are orthogonal to the first direction. The partition plate 22U has openings 22H and 221H. A ribbon guide 229 and shafts 26 through 28 are disposed on the partition plate 22U.

In the partition plate 22U, the opening 22H is located on the one side in the second direction and on the other side in the third direction. The opening 22H extends through the partition plate 22U in the first direction.

The opening 221H is located in the corner of the partition plate 22U on the other side in the second direction and on the other side in the third direction. The opening 221H extends through the partition plate 22U in the first direction. In a state where the case 23 is coupled to the case 22, the opening 221H is in communication with the opening 211H illustrated in FIG. 18.

The ribbon guide 229 and the shafts 26 through 28 extend in the first direction from the partition plate 22U.

The ribbon guide 229 is disposed on the corner of the partition plate 22U on the other side in the second direction and on the other side in the third direction. The other end of the ribbon guide 229 in the first direction is connected to the opening 221H. The ribbon guide 229 has a sloped surface 229A, which is curved. The sloped surface 229A is sloped to extend toward the one side in the second direction as the sloped surface 229A extends toward the one side in the first direction. The ribbon guide 229 is configured to guide the conveyance of the ink ribbon 45. Specifically, the ink ribbon 45 is to be conveyed while contacting the sloped surface 229A of the ribbon guide 229.

The shaft 26 is disposed on the corner of the partition plate 22U on the one side in the second direction and on the one side in the third direction. The shaft 27 is disposed on a portion of the partition plate 22U in the vicinity of the center in the second direction and in the vicinity of the center in the third direction. The shaft 28 is disposed on the other side of the shaft 27 in the second direction and on the one side of the shaft 27 in the third direction. The position of the shaft 28 corresponds to the position of the opening 23H.

The plate 22R is positioned at the one end of the partition plate 22U in the third direction. The plate 22R has plate surfaces which are orthogonal to the third direction. In the first direction, the partition plate 22U is positioned between the one end of the plate 22R in the first direction and the other end of the plate 22R in the first direction.

The plate 22B is positioned at the other end of the partition plate 22U in the second direction. The plate 22B has plate surfaces which are orthogonal to the second direction. In the first direction, the partition plate 22U is positioned between the one end of the plate 22B in the first direction and the other end of the plate 22B in the first direction.

The plate 22L is positioned at the other end of the partition plate 22U in the third direction. The plate 22L has plate surfaces which are orthogonal to the third direction. In the first direction, the partition plate 22U is positioned between the one end of the plate 22L in the first direction and the other end of the plate 22L in the first direction.

The plate 22F is positioned at the one end of the partition plate 22U in the second direction. The plate 22F has plate surfaces which are orthogonal to the second direction. In the first direction, the partition plate 22U is positioned between the one end of the plate 22F in the first direction and the other end of the plate 22F in the first direction.

The housing 20 also has an opening 16. More specifically, the opening 16 is positioned on the corner of the case 21 and the case 22 on the one side in the second direction and on the one side in the third direction.

As illustrated in FIG. 17, the case 24 includes plates 24U, 24R, 24B, 24L, and 24F. Each of the plates 24U, 24B, 24R, 24L, and 24F has a rectangular shape.

The plate 24U has plate surfaces which are orthogonal to the first direction. A shaft 243 is disposed on the plate 24U. Specifically, the shaft 243 is disposed on the corner of the plate 24U on the one side in the second direction and on the other side in the third direction. The shaft 243 extends toward the other side in the first direction from the plate 24U.

The plate 24R is positioned at the one end of the plate 24U in the third direction. The plate 24B is positioned at the other end of the plate 24U in the second direction. The plate 24L is positioned at the other end of the plate 24U in the third direction. The plate 24F is positioned at the one end of the plate 24U in the second direction.

The plates 24R, 24B, 24L, and 24F extend toward the other side in the first direction from the plate 24U.

The partition plate 22U partitions the internal space of the housing 20 into a first space S1 and a second space S2 in the first direction.

The first space S1 is a space enclosed by the plates 23D, 23F, 23B, 23L, and 23R of the case 23, the plates 21F, 21B, 21L, and 21R of the case 21, and the partition plate 22U and the plates 22F, 22B, 22L, and 22R of the case 22.

The second space S2 is a space enclosed by the partition plate 22U and the plates 22F, 22B, 22L, and 22R of the case 22 and the plates 24U, 24F, 24B, 24L, and 24R of the case 24.

The first space S1 and the second space S2 are arranged in the first direction. The first space S1 is located on the other side of the second space S2 in the first direction. The arm 25 defines the one end of the first space S1 in the second direction. The opening 23H is in communication with the first space S1.

The partition plate 21M partitions the first space S1 into a third space S3 and a fourth space S4 in the first direction. The third space S3 and the fourth space S4 are arranged in the first direction. The third space S3 is positioned on the other side of the fourth space S4 in the first direction.

The third space S3 is a space enclosed by the plates 23D, 23F, 23B, 23L, and 23R of the case 23 and the partition plate 21M and the plates 21F, 21B, 21L, and 21R of the case 21.

The fourth space S4 is a space enclosed by the partition plate 21M and the plates 21F, 21B, 21L, and 21R of the case 21 and the partition plate 22U and the plates 22F, 22B, 22L, and 22R of the case 22.

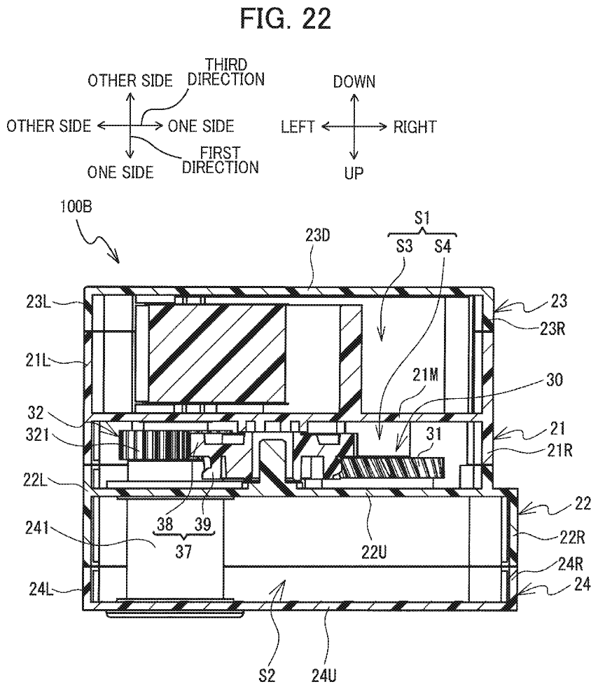

As illustrated in FIGS. 22 through 25, the roll 411, the gears 30, the discharge ports 17A and 17B, and the inlet port 55 are positioned in the first space S1 of the tape cassette 100B.

Specifically, the roll 411, the discharge ports 17A and 17B, and the inlet port 55 are positioned in the third space S3. The gears 30 are positioned in the fourth space S4.

In the third space S3, the roll 411 is positioned on the corner of the partition plate 21M on the other side in the second direction and on the other side in the third direction. The holder 427 is fitted inside the spool 471. The shafts 217 and 237 are inserted through the holder 427. The shafts 217 and 237 have the rotation axis L231 extending in the first direction. Accordingly, the spool 471 is rotatable about the rotation axis L231.

In the third space S3, the discharge port 17A is positioned at the one end of the arm 25 (i.e., the one end of the arm 25 in the third direction). The discharge port 17A allows the ink ribbon 45 to be discharged from the third space S3 through the discharge port 17A.

In the third space S3, the discharge port 17B is also positioned at the one end of the arm 25 (i.e., the one end of the arm 25 in the third direction). The discharge port 17B allows the tape 41 to be discharged from the third space S3 through the discharge port 17B.

Here, the discharge port 17A is positioned between the discharge port 17B and the roll 411 in the second direction.

In the third space S3, the inlet port 55 is located in the corner on the one side in the second direction and on the one side in the third direction. The inlet port 55 allows the ink ribbon 45 to enter the third space S3 again through the inlet port 55.

As illustrated in FIGS. 22 through 25, the gears 30 are positioned in the fourth space S4. The gears 30 are configured to transmit a drive force transmitted through the transmission gear 679 on the shaft 66E of the drive shaft 63 to the platen roller 82.

The gears 30 include gears 34, 31, 37, and 32. The gear 34 is fitted over the shaft 28. The gear 31 is fitted over the shaft 26. The gear 37 is fitted over the shaft 27. The gear 32 is inserted through the opening 22H.

The gear 34 is rotatable about the shaft 28. The position of the gear 34 in the second direction and in the third direction is the same as the positions of the openings 23H and 21H in the second direction and in the third direction.

The gear 34 is coupled to the gear 31 through the gear 37. The gear 34 is configured to transmit a drive force to the gear 31. The gear 34 includes a gear 35 and a cam 36. The gear 35 is an external gear that is in meshing engagement with a gear 38 of the gear 37. The gear 35 is coupled to the cam 36.

The cam 36 is fixed to the gear 35 in the first direction. The cam 36 extends toward the other side in the first direction from the gear 35. The cam 36 is an internal gear having a hollow cylindrical shape. Specifically, the cam 36 has splines 361 on the inner circumferential surface of the cam 36. The shaft 66E of the drive shaft 63 is configured to be inserted into the cam 36 from the other side in the first direction.

A part of the cam 36 is inserted in the third space S3 from the fourth space S4. The cam 36 is exposed to the outside of the housing 20 through the opening 23H. Note that “the cam 36 is exposed” denotes a state in which the cam 36 is visible by the user.

The gear 31 is an external gear. The gear 31 is rotatable about the shaft 26 extending in the first direction. The gear 31 is positioned further toward the one side in the second direction than the gear 34 to be spaced apart from the gear 34.

The gear 31 is configured to transmit, to the platen gear 83, a drive force for conveying the tape 41. The gear 31 is so-called a helical gear. The gear teeth of the gear 31 are helical (i.e., skewed) relative to the first direction at a predetermined angle. The gear teeth on the gear 31 are of the opposite hand to the gear teeth on the platen gear 83.

In a state where the tape cassette 100B is attached to the cassette attachment portion 10, the gear 31 meshes with the platen gear 83 in the space in communication with the head opening 29.

A part of the gear 31 is exposed to the outside of the housing 20 through the opening 16. That is, a part of the gear 31 is exposed to the space in communication with the head opening 29. Note that the phrase “the gear 31 is exposed” denotes a state in which the gear 31 is visible by the user.

The gear 37 is in meshing engagement with both the gear 31 and the gear 34. The gear 37 is configured to transmit a drive force inputted into the gear 34 to the gear 31.

Specifically, the gear 37 is configured to transmit a drive force inputted into the gear 34 to the gear 31 while reducing a rotational speed of the drive force. That is, the gears 30 include a reduction mechanism.

The gear 37 is a double gear including the gear 38 and a gear 39. The gears 38 and 39 are arranged side by side and coaxial with each other. The diameter of the gear 39 is smaller than the diameter of the gear 38. In the first direction, the gear 38 is positioned closer to the roll 411 than the gear 39 is to the roll 411.

The gear 38 is in meshing engagement with the gear 34. The gear 38 is an external spur gear.

The gear 39 is in meshing engagement with the gear 31. The gear 39 is an external helical gear. The gear 39 has gear teeth which are of the opposite hand to the gear teeth on the gear 31.

The gear 32 includes a gear 321, a cam 323, and a shaft 325. The gear 321 is in meshing engagement with the gear 38. The cam 323 extends toward the one side in the first direction from the gear 321. The one end portion of the cam 323 in the first direction has a plurality of recessed portions. The shaft 325 extends in the first direction from the center of the gear 321.

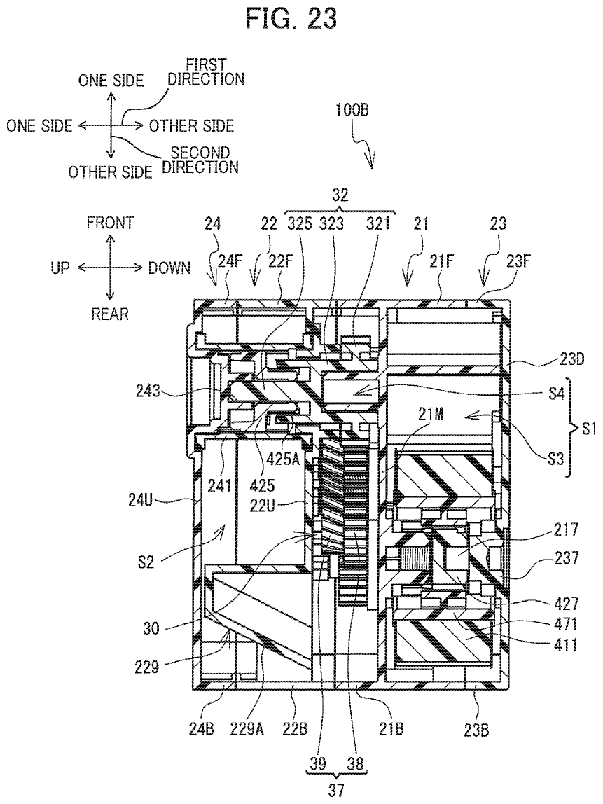

As illustrated in FIG. 23, a part of the gear 32 (i.e., the cam 323 and the shaft 325) is inserted in the second space S2 from the fourth space S4.

The take-up spool 241 is positioned in the second space S2 in the tape cassette 100B. The take-up spool 241 is positioned on the corner in the second space S2 on the one side in the second direction and on the other side in the third direction.

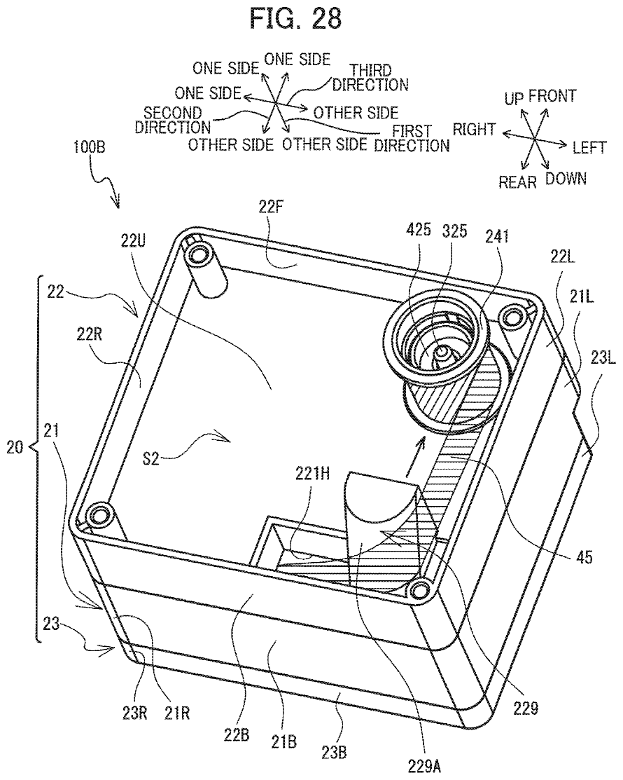

As illustrated in FIGS. 23 and 28, a holder 425 is fitted inside the take-up spool 241. The shaft 243 is fitted inside the holder 425. That is, the shaft 243 is inserted in the holder 425.

The shaft 325 is also inserted in the holder 425. The shafts 243 and 325 have a rotation axis L4 extending in the first direction. That is, the take-up spool 241 is rotatable about the rotation axis L4 extending in the first direction.

A clutch spring 425A is mounted on the other end portion of the holder 425 in the first direction. Each of the two arms of the clutch spring 425A is fitted in one of the recessed portions of the cam 323. A drive force due to the rotation of the gear 321 is to be transmitted to the take-up spool 241 through the clutch spring 425A.

Next, the positional relationship among the components in the tape cassette 100B will be described with reference to FIG. 20. In the following description, the phrase “a component overlaps another component” denotes that at least a part of the component overlaps at least a part of the other component when viewed from the one side or the other side in the corresponding direction. Further, the phrase “a component does not overlap another component” denotes that the component does not overlap the other component when viewed from the one side or the other side in the corresponding direction. These phrases do not denote that the component and the other component are physically in contact with each other.

The roll 411 overlaps the take-up spool 241 in the first direction. In the first direction, the other end of the take-up spool 241 in the first direction is spaced apart from the one end of the roll 411 in the first direction. The roll 411 does not overlap the take-up spool 241 in the second direction. The roll 411 does not overlap the take-up spool 241 in the third direction.

A part of the take-up spool 241 overlaps a part of the roll 411 in the first direction. The take-up spool 241 does not overlap the roll 411 in the second direction. The take-up spool 241 does not overlap the roll 411 in the third direction.

The gear 34 does not overlap either the roll 411 or the take-up spool 241 in the first direction. A part of the gear 34 (i.e., the gear 35) does not overlap either the roll 411 or the take-up spool 241 in the second direction. Also, a part of the gear 34 (i.e., the gear 35) does not overlap either the roll 411 or the take-up spool 241 in the third direction. A part of the gear 34 (i.e., the cam 36) overlaps the roll 411 in the second direction. Further, a part of the gear 34 (i.e., the cam 36) overlaps the roll 411 in the third direction.

A part of the gear 37 overlaps a part of the roll 411 in the first direction. A part of the gear 37 overlaps a part of the take-up spool 241 in the first direction.

The gear 31 does not overlap the roll 411 in the first direction. The gear 31 does not overlap the take-up spool 241 in the first direction. The gear 31 does not overlap either the roll 411 or the take-up spool 241 in the second direction. The gear 31 does not overlap either the roll 411 or the take-up spool 241 in the third direction.

The gear 32 overlaps the take-up spool 241 in the first direction. A part of the gear 32 (i.e., the gear 321) does not overlap either the roll 411 or the take-up spool 241 in the second direction. Also, a part of the gear 32 (i.e., the gear 321) does not overlap either the roll 411 or the take-up spool 241 in the third direction. A part of the gear 32 (i.e., the cam 323) overlaps the take-up spool 241 in the second direction. Also, a part of the gear 32 (i.e., the cam 323) overlaps the take-up spool 241 in the third direction.

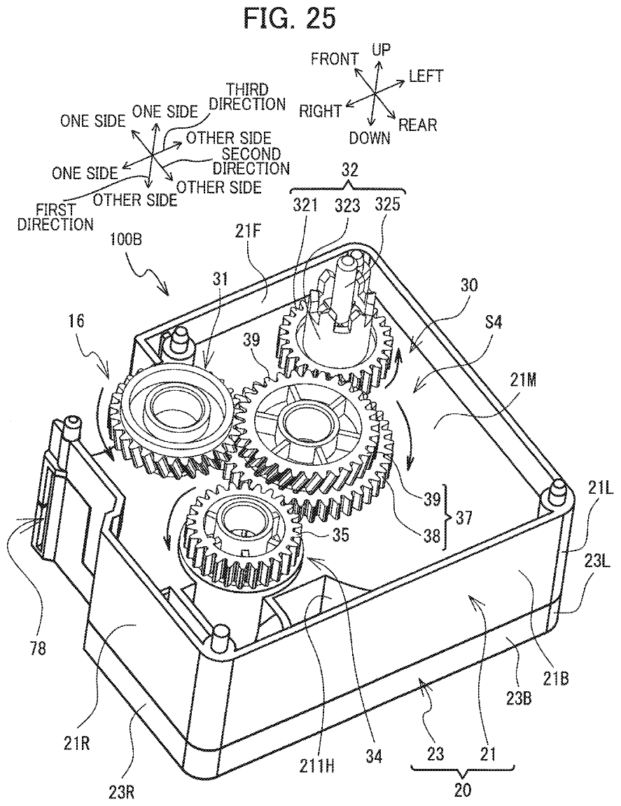

Next, the printing operations performed with the printer 1 and the tape cassette 100B will be described with reference to FIGS. 25 through 28. The user attaches the tape cassette 100B to the cassette attachment portion 10, thereby positioning the print head 71 in the head opening 29 at a position in which the print head 71 overlaps both the tape 41 and the ink ribbon 45 in the second direction.

The shaft 66E of the drive shaft 63 is inserted in the cam 36 of the gear 34 accommodated in the fourth space S4. The platen roller 82 is moved to the adjacent position. As a result, the platen gear 83 is brought into meshing engagement with the gear 31.

As illustrated in FIG. 25, in a state where the tape cassette 100B is attached to the cassette attachment portion 10, the gear 34 is rotated together with the cam 36 due to the shaft 66E of the drive shaft 63. The gear 37 is also rotated in accordance with the rotation of the gear 34. The gear 31 is also rotated in accordance with the rotation of the gear 37. The platen gear 83 is also rotated in accordance with the rotation of the gear 31, thereby rotating the platen roller 82.

As illustrated in FIG. 26, in the third space S3, the tape 41 and the ink ribbon 45 are drawn off the roll 411 due to the rotation of the platen roller 82. The tape 41 is conveyed toward the one side in the second direction, i.e., toward the tape guide 442.

In the third space S3, the tape 41 is guided by the tape guide 442 toward the discharge port 17B. At this time, the tape 41 is conveyed toward the one side in the third direction through the gap between the plate 211 and the plate 94. Then, the tape 41 is discharged through the discharge port 17B to the outside of the housing 20, i.e., an outside of the third space S3.

In the third space S3, the ink ribbon 45 is conveyed toward the guide 97 due to the rotation of the platen roller 82. At this time, the ink ribbon 45 separates from the tape 41. After reaching the guide 97, the ink ribbon 45 is guided toward the discharge port 17A. Specifically, the ink ribbon 45 is conveyed toward the one side in the third direction through the gap between the plate 94 and the plate 213. Then, the ink ribbon 45 is discharged to the outside of the housing 20, i.e., the outside of the third space S3, through the discharge port 17A.

The tape 41 and the ink ribbon 45 which have been discharged through the discharge port 17 are conveyed toward the head opening 29. The platen roller 82 presses the tape 41 against the print head 71 through the ink ribbon 45 in the head opening 29. At this time, selected one or more heating elements 71A are heated in the print head 71, whereby some of the ink contained in the surface of the ink ribbon 45 is transferred to the tape 41. As a result, characters or symbols are printed on the tape 41.

The tape 41 on which printing has been performed is guided toward the discharge channel 9 in the printer 1 by the guide 78. That is, the tape 41 that has been discharged through the discharge port 17B does not return to an inside of the housing 20.

In the meantime, in the second space S2, the cam 323 is rotated together with the rotation of the gear 32. Since the clutch spring 425A is disposed between the cam 323 and the holder 425, the holder 425 is also rotated, thereby rotating the take-up spool 241 together with the holder 425.

In accordance with the rotation of the take-up spool 241, the used ink ribbon 45 is conveyed toward the inlet port 55. While guided by the inlet port 55, the ink ribbon 45 is conveyed toward the third space S3 again.

In the third space S3, the ink ribbon 45 is conveyed toward the ribbon guide 219. At this time, the ink ribbon 45 is conveyed toward the other side in the second direction between the plate 21R and the plate 216.

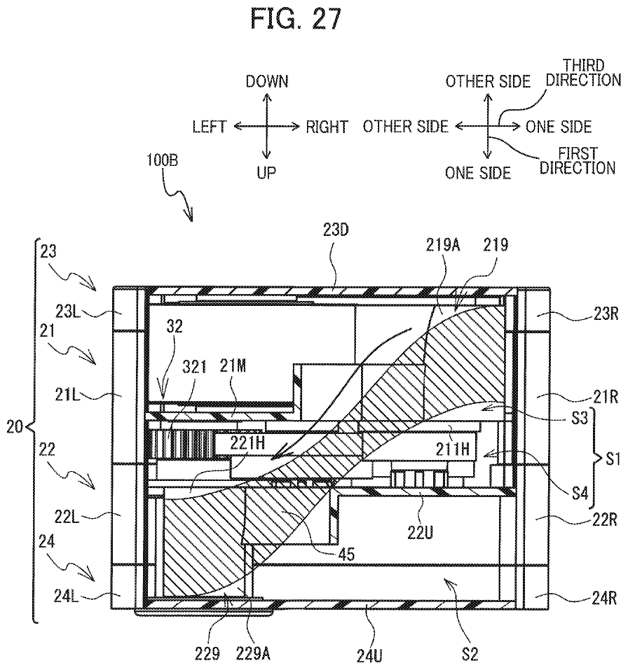

As illustrated in FIG. 27, the conveying direction of the ink ribbon 45 is changed by the sloped surface 219A of the ribbon guide 219. Specifically, the ink ribbon 45 is conveyed toward the one side in the first direction and the other side in the third direction toward the ribbon guide 229 in the second space S2.

As illustrated in FIG. 28, the conveying direction of the ink ribbon 45 is further changed by the sloped surface 229A of the ribbon guide 229. Specifically, the ink ribbon 45 is conveyed toward the one side in the second direction to the take-up spool 241. Then, the ink ribbon 45 is taken up by the take-up spool 241.

Once the printing operation has been completed, the user cuts off the printed tape 41 from the printer 1.

As described above, the discharge port 17A is positioned in the first space S1 (more specifically, in the plate 21F that defines the first space S1). The discharge port 17A allows the ink ribbon 45 to be discharged to the outside of the housing 20. The inlet port 55 is also positioned in the first space S1 (more specifically, in the plate 21F that defines the first space S1). The inlet port 55 allows the ink ribbon 45 to enter the housing 20.

The ribbon guides 219 and 229 are positioned for guiding the ink ribbon 45 during the conveyance of the ink ribbon 45 from the first space S1 toward the second space S2. The ribbon guide 219 is positioned in the first space S1, while the ribbon guide 229 is positioned in the second space S2. The tape 41 and the ink ribbon 45 are wound into a roll in an overlaid state to constitute the single roll 411. The roll 411 is positioned in the first space S1 and is rotatable about the rotation axis L231. The ink ribbon 45 drawn off the roll 411 is conveyed through the discharge port 17A and the inlet port 55 and conveyed along the ribbon guides 219 and 229, in order, and is taken up by the take-up spool 241. That is, in the conveying direction in which the ink ribbon 45 drawn off the roll 411 is conveyed from the roll 411 to the take-up spool 241, the roll 411, the discharge port 17A, the inlet port 55, the ribbon guides 219 and 229, and the take-up spool 241 are arranged in order from upstream to downstream. The tape cassette 100B enables the components to be properly arranged in the tape cassette 100B.

The discharge port 17B is positioned in the first space S1 (more specifically, in the plate 21F that defines the first space S1). The discharge port 17B allows the tape 41 to be discharged to the outside of the housing 20. The tape guide 442 is positioned in the first space S1. The tape guide 442 is configured to guide the tape 41 during the conveyance of the tape 41. The tape 41 drawn off the roll 411 is conveyed to the discharge port 17B after conveyed along the tape guide 442. That is, in the conveying direction in which the tape 41 drawn off the roll 411 is conveyed from the roll 411 to the discharge port 17B, the roll 411, the tape guide 442, and the discharge port 17B are arranged in order from upstream to downstream. In the tape cassette 100B, the roll 411, the tape guide 442, and the discharge port 17B can be arranged in order in the conveying direction of the tape 41.

The take-up spool 241 does not overlap the roll 411 in the first direction. The take-up spool 241 does not overlap the roll 411 in the second direction orthogonal to the first direction. The take-up spool 241 and the roll 411 can be arranged to be offset from each other in the tape cassette 100B.

The partition plate 21M partitions the first space S1 into the third space S3 and the fourth space S4 in the first direction. The roll 411 is positioned in the third space S3. The gears 30 are positioned in the fourth space S4. In the tape cassette 100B, the roll 411 can be arranged in the third space S3, and the gears 30 can be arranged in the fourth space S4.

The gears 30 include the gear 31. A part of the gear 31 is exposed to the outside of the housing 20. The tape cassette 100B can expose the gear 31 to the outside of the housing 20.

The gear 31 does not overlap the roll 411 in the first direction. The gear 31 and the roll 411 can be arranged to be offset from each other in the first direction in the tape cassette 100B.

The gears 30 include the gear 32 coupled to the take-up spool 241. The tape cassette 100B can drive the take-up spool 241 using the gear 32.

The gear 32 overlaps the take-up spool 241 in the first direction. The tape cassette 100B enables the gear 32 and the take-up spool 241 to be arranged to overlap each other in the first direction.

The gears 30 include the gear 37 in engagement with the gear 31. The tape cassette 100B can accommodate not only the gears 31 and 32 but also the gear 37.

The gear 37 overlaps the roll 411 in the first direction. The gear 37 and the roll 411 can be arranged in the tape cassette 100B to overlap each other in the first direction.

The gears 30 include the gear 34 for receiving a drive force. The tape cassette 100B can accommodate the gear 34.

In this modification, the roll 411 is an example of the “tape roll”. The roll 411 is also an example of the “ribbon roll”. The roll 411 is also an example of the “single roll”. The rotation axis L231 is an example of the “axis”. The partition plate 22U is an example of the “first partition plate”. The partition plate 21M is an example of the “second partition plate”. The surfaces of the plate 23D are an example of the “first surface”. The surfaces of the plate 24U are an example of the “second surface”. The case 23 is an example of the “first case”. The case 24 is an example of the “second case”. The plate 21F is an example of the “wall defining the first space”. The ribbon guide 219 is an example of the “first ribbon guide”. The ribbon guide 229 is an example of the “second ribbon guide”. The discharge port 17A is an example of the “first discharge port”. The discharge port 17A is also an example of the “discharge port”. The discharge port 17B is an example of the “second discharge port”. The inlet port 55 is an example of the “inlet port”. The gears 30, 31, 32, 37, and 34 are each an example of the “gear”.

Note that the conveying passage for the ink ribbon 45 in the tape cassette 100B may be modified. For example, the ink ribbon 45 may be conveyed along the tape guide 442 and through the discharge port 17B together with the tape 41.

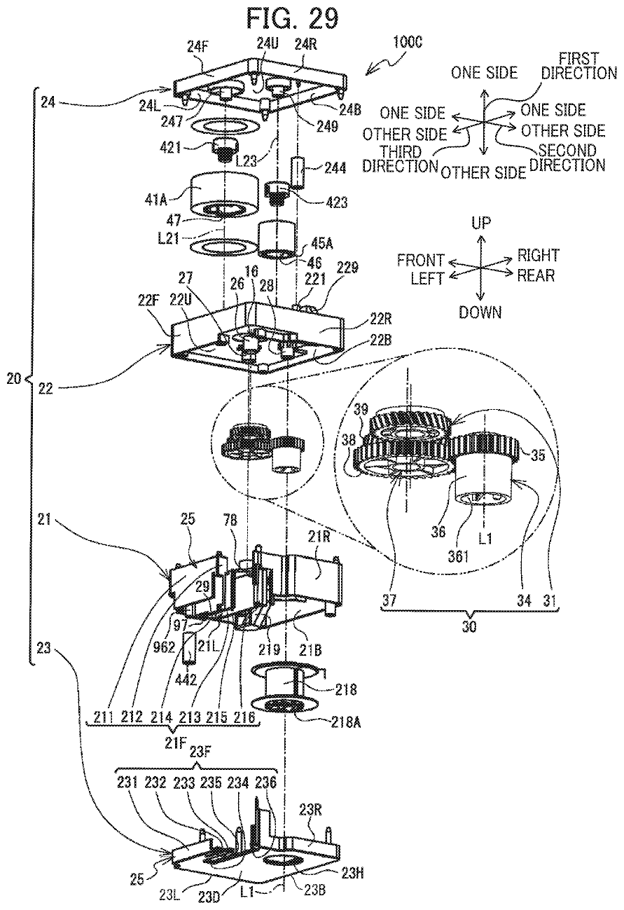

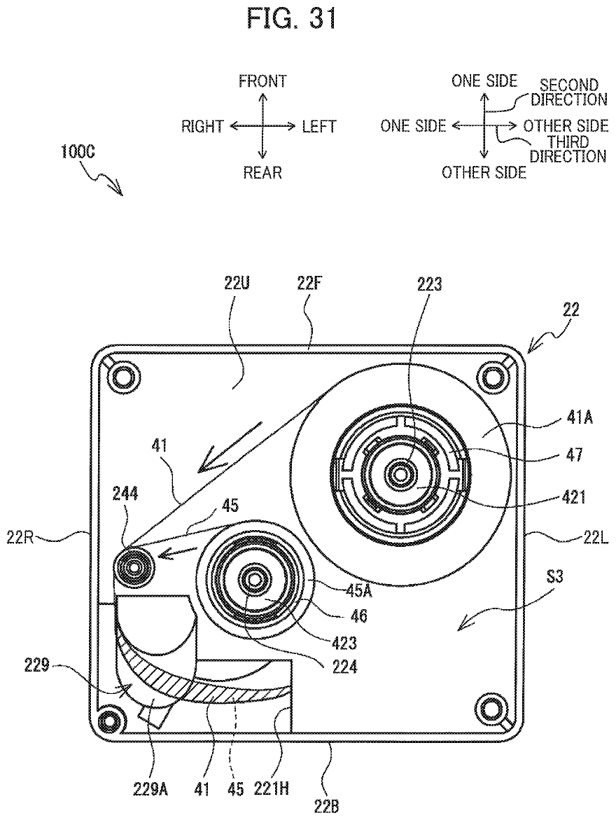

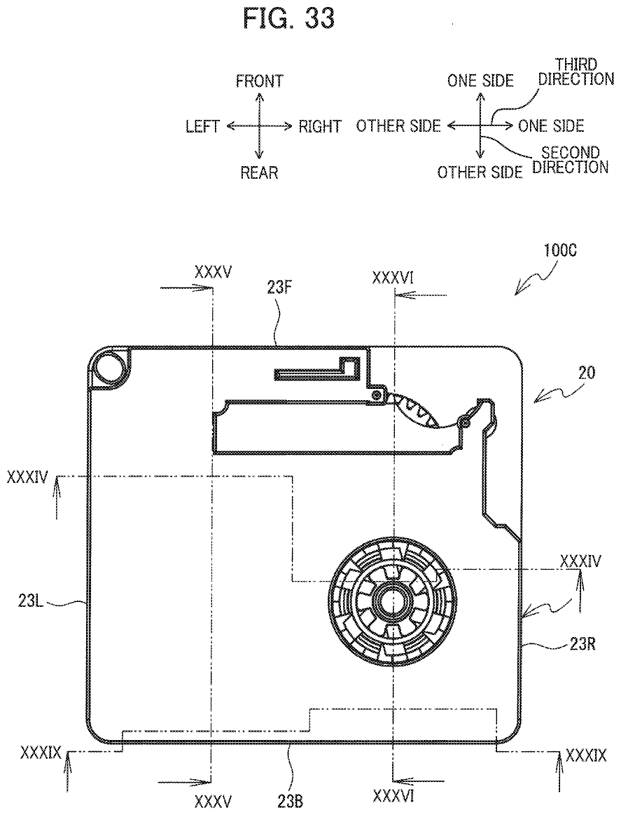

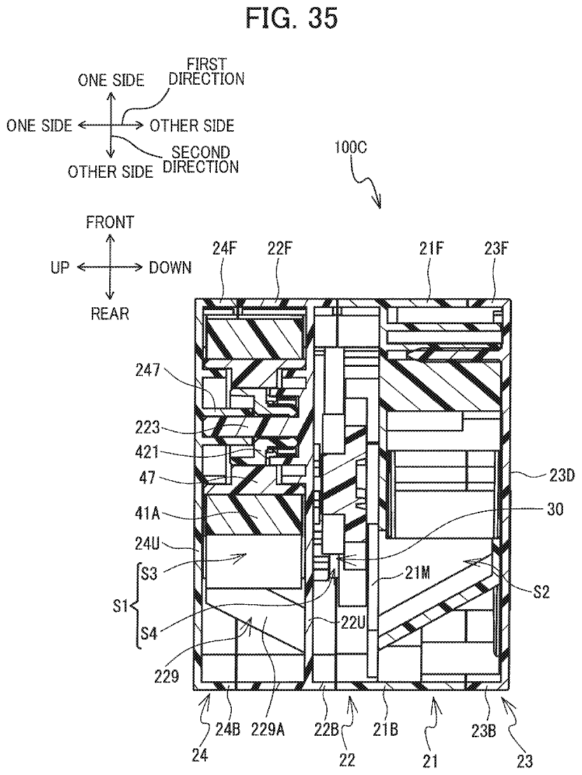

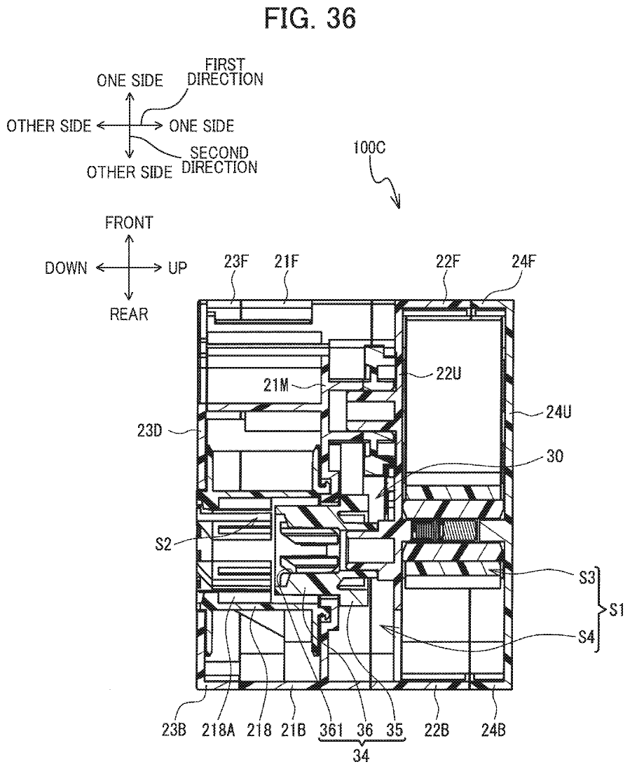

Next, the tape cassette 100C according to a modification of the present disclosure will be described with reference to FIGS. 29 through 41. The tape cassette 100C is attachable to the cassette attachment portion 10 illustrated in FIG. 2. Replenishment of the tape and change of the type (for example, the size, the color, and the material) of the tape can be performed by replacing the tape cassette 100C attached to the cassette attachment portion 10 of the printer 1.

The tape cassette 100C includes a housing 20, a tape roll 41A, a ribbon roll 45A, a take-up spool 218, and gears 30. As illustrated in FIG. 29, the tape cassette 100C has a rectangular parallelepiped outer shape. That is, the housing 20 has a rectangular parallelepiped shape. The housing 20 accommodates the tape roll 41A, the ribbon roll 45A, the take-up spool 218, and the gears 30.

Inside the housing 20, the tape roll 41A is positioned on the one side in the second direction and on the other side in the third direction. Inside the housing 20, a tape spool 47 is positioned on the one side in the second direction and on the other side in the third direction.

The tape roll 41A is a roll in which a tape 41 is wound about the tape spool 47. The tape spool 47 is rotatable about a rotation axis L21 extending in the first direction. The rotation axis L21 will be described later.

The tape spool 47 has a hollow cylindrical shape elongated in the first direction. The tape 41 has a strip shape. The tape 41 includes a printing tape having adhesive coated on one surface and a releasing paper bonded to the one surface of the printing tape to cover the same, for example. The tape 41 is to be overlaid on an ink ribbon 45 (described later) to be subjected to printing by the print head 71.

The tape 41 is wound about the tape spool 47. The tape spool 47 is rotatable about the rotation axis L21 extending in the first direction with the tape 41 wound about the tape spool 47. The tape roll 41A is rotatable about the rotation axis L21 extending in the first direction. The rotation axis L21 is an imaginary axis. The rotation axis L21 passes through the center of the tape roll 41A.

Inside the housing 20, the ribbon roll 45A is positioned in the vicinity of the center in the second direction and in the vicinity of the center in the third direction. Inside the housing 20, a ribbon spool 46 is positioned in the vicinity of the center in the second direction and in the vicinity of the center in the third direction.

The ribbon roll 45A is a roll in which the ink ribbon 45 is wound about the ribbon spool 46. The ribbon spool 46 is rotatable about a rotation axis L23 extending in the first direction. The rotation axis L23 will be described later.

The ribbon spool 46 has a hollow cylindrical shape that is elongated in the first direction. The ink ribbon 45 has a strip shape. For example, the ink ribbon 45 is a strip-like film containing ink. The ink ribbon 45 is to be used for performing printing on the tape 41. Specifically, the ink ribbon 45 is to be overlaid on the tape 41 in a head opening 29 (described later) to be used for printing by the print head 71.

The ink ribbon 45 is wound about the ribbon spool 46. Specifically, the ribbon spool 46 is rotatable about the rotation axis L23 extending in the first direction with the ink ribbon 45 wound about the ribbon spool 46. The ribbon roll 45A is also rotatable about the rotation axis L23 extending in the first direction. The ink ribbon 45 is to be taken up by the take-up spool 218 (described later). The rotation axis L23 is an imaginary axis. The rotation axis L23 passes through the center of the ribbon roll 45A.

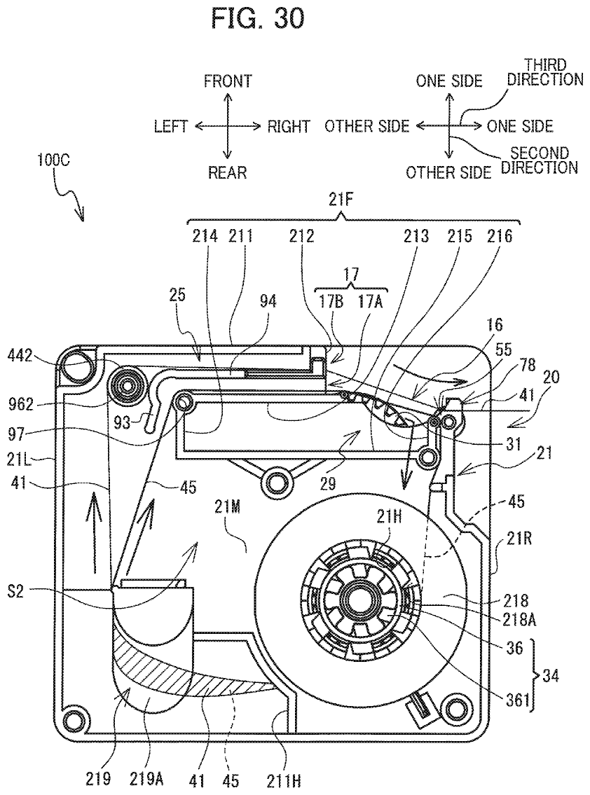

As illustrated in FIGS. 29 and 30, the housing 20 of the tape cassette 100C includes an arm 25. The arm 25 is positioned at the one end portion of the housing 20 in the second direction. In the second direction, the arm 25 is positioned closer to the one end portion of the housing 20 in the second direction than to the other end portion of the housing 20 in the second direction.

As illustrated in FIG. 30, the arm 25 has a discharge port 17. The discharge port 17 allows the tape 41 and the ink ribbon 45 to be discharged to an outside of the housing 20 through the discharge port 17. The arm 25 and the discharge port 17 will be described later in detail.

As illustrated in FIG. 29, the housing 20 includes a case 21, a case 22, a case 23, and a case 24.

The case 23 constitutes the other end of the housing 20 in the first direction. The case 21 is disposed on the one side of the case 23 in the first direction. The case 21 is coupled to the one end of the case 23 in the first direction.

The case 22 is disposed on the one side of the case 21 in the first direction. The case 22 is coupled to the one end of the case 21 in the first direction.

The case 24 constitutes the one end of the housing 20 in the first direction. The case 24 is disposed on the one side of the case 22 in the first direction. The case 24 is coupled to the one end of the case 22 in the first direction.

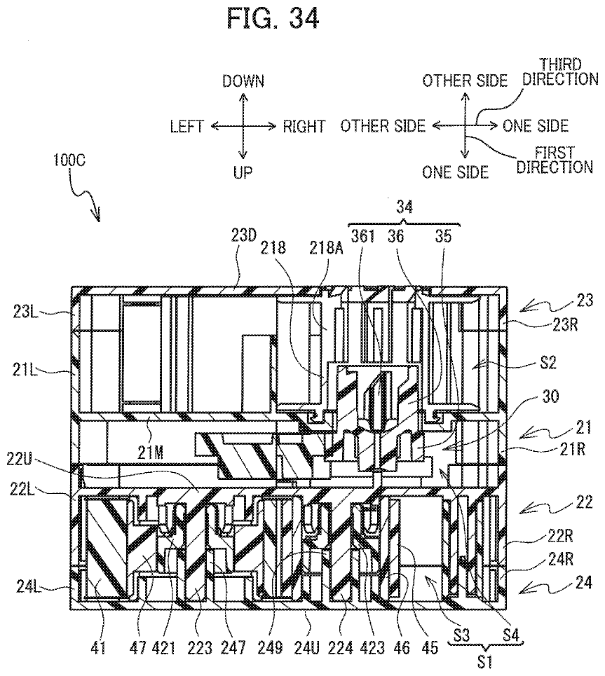

As illustrated in FIGS. 29 and 34, the case 23 includes plates 23D, 23R, 23B, 23L, and 23F. Each of the plates 23D, 23B, 23R, and 23L has a rectangular shape.

The plate 23D has plate surfaces that are orthogonal to the first direction. The plate 23D has an opening 23H. In the plate 23D, the opening 23H is located on the other side in the second direction and on the one side in the third direction. The opening 23H extends through the plate 23D in the first direction.

The plate 23R is positioned at the one end of the plate 23D in the third direction. The plate 23B is positioned at the other end of the plate 23D in the second direction. The plate 23L is positioned at the other end of the plate 23D in the third direction. The plates 23R, 23B, and 23L extend toward the one side in the first direction from the plate 23D.

The plate 23F is positioned at the one end of the plate 23D in the second direction. The plate 23F includes plates 231 through 236. Each of the plates 231 through 236 has a rectangular shape. Each of the plates 231, 233, and 235 has plate surfaces that are orthogonal to the second direction. Each of the plates 232, 234, and 236 has plate surfaces that are orthogonal to the third direction.

The plate 231 is positioned at the one end of the plate 23D in the first direction. The one end of the plate 232 (i.e., the one end of the plate 232 in the second direction) is connected to the one end of the plate 231 (i.e., the one end of the plate 231 in the third direction). The other end of the plate 232 (i.e., the other end of the plate 232 in the second direction) is connected to the one end of the plate 233 (i.e., the one end of the plate 233 in the third direction). The other end of the plate 233 (i.e., the other end of the plate 233 in the third direction) is connected to the one end of the plate 234 (i.e., the one end of the plate 234 in the second direction). The other end of the plate 234 (i.e., the other end of the plate 234 in the second direction) is connected to the other end of the plate 235 (i.e., the other end of the plate 235 in the third direction). The one end of the plate 235 (i.e., the other end of the plate 235 in the third direction) is connected to the other end of the plate 236 (i.e., the other end of the plate 236 in the second direction).

As illustrated in FIGS. 29, 30, 32, and 33, the case 21 includes a partition plate 21M and plates 21R, 21B, 21L, and 21F. Each of the partition plate 21M and the plates 21R, 21B, and 21L has a rectangular shape.

As illustrated in FIGS. 29, 30, and 32, the partition plate 21M has plate surfaces that are orthogonal to the first direction. The partition plate 21M has openings 21H and 211H. A ribbon guide 219, plates 93 and 94, and a shaft 962 are disposed on the partition plate 21M.

In the partition plate 21M, the opening 21H is located on the other side in the second direction and on the one side in the third direction. The position of the opening 21H is the same as the position of the opening 23H. Specifically, the position of the opening 21H in the second direction and in the third direction is the same as the position of the opening 23H in the second direction and in the third direction. The opening 21H extends through the partition plate 21M in the up-down direction (i.e., in the first direction).

In the partition plate 21M, the opening 211H is located on the other side in the second direction and on the other side in the third direction. The opening 211H extends through the partition plate 21M in the first direction. The other end of the partition plate 21M in the second direction and the other end of the partition plate 21M in the third direction are notched by the opening 211H.

The ribbon guide 219, the plates 93 and 94, and the shaft 962 extend toward the other side in the first direction from the partition plate 21M.

The ribbon guide 219 is disposed on the corner of the housing 20 on the other side in the second direction and on the other side in the third direction. The ribbon guide 219 is disposed at a position further toward the other side in the third direction than the opening 21H. The one end of the ribbon guide 219 in the first direction is connected to the opening 211H.

The ribbon guide 219 has a sloped surface 219A, which is curved. The sloped surface 219A is sloped to extend toward the one side in the second direction as the sloped surface 219A extends toward the other side in the first direction. The ribbon guide 219 is configured to guide the conveyance of the ink ribbon 45. More specifically, the ink ribbon 45 is to be conveyed while contacting the sloped surface 219A of the ribbon guide 219.

The plate 93 extends in the second direction. In the third direction, the plate 93 is positioned closer to the plate 21L than to the plate 21R. The one end of the plate 93 in the second direction is connected to the other end of the plate 94 in the third direction.

The plate 94 extends in the third direction. The plate 94 is positioned between a plate 211 and a plate 213 of the plate 21F in the second direction. The plate 94 is positioned within the arm 25 (described later).

The shaft 962 is disposed on the corner of the partition plate 21M on the one side in the second direction and on the other side in the third direction. A tape guide 442 is fitted over the shaft 962. The tape guide 442 has a hollow cylindrical shape. The tape guide 442 is rotatable about the shaft 962.

The plate 21R is positioned at the one end of the housing 20 in the third direction. The plate 21R has plate surfaces which are orthogonal to the third direction. In the first direction, the partition plate 21M is positioned between the one end of the plate 21R in the first direction and the other end of the plate 21R in the first direction.

The plate 21B is positioned at the other end of the housing 20 in the second direction. The plate 21B has plate surfaces which are orthogonal to the second direction. In the first direction, the partition plate 21M is positioned between the one end of the plate 21B in the first direction and the other end of the plate 21B in the first direction.

The plate 21L is positioned at the other end of the housing 20 in the third direction. The plate 21L has plate surfaces which are orthogonal to the third direction. In the first direction, the partition plate 21M is positioned between the one end of the plate 21L in the first direction and the other end of the plate 21L in the first direction.

The plate 21F is positioned at the one end of the housing 20 in the second direction. The plate 21F includes the plates 211 and 213 and plates 212 and 214 through 216. Each of the plates 211 through 216 has a rectangular shape. Each of the plates 211, 213, and 215 has plate surfaces which are orthogonal to the second direction. Each of the plates 212, 214, and 216 has plate surfaces which are orthogonal to the third direction.

The plate 211 is positioned at the one end of the partition plate 21M in the second direction. The plate 213 is positioned further toward the other side in the second direction than the plate 94. The plate 94 is positioned between the plate 211 and the plate 213 in the second direction. In other words, a gap is formed between the plate 94 and the plate 211, and a gap is formed between the plate 94 and the plate 213.

The one end of the plate 212 in the second direction is connected to the one end of the plate 211 in the third direction. The other end of the plate 212 in the second direction is connected to the one end of the plate 213 in the third direction. The plate 212 constitutes the discharge port 17 (described later).

The other end of the plate 213 in the third direction is connected to a guide 97. The guide 97 is also connected to the one end of the plate 214 in the second direction. The other end of the plate 214 in the second direction is connected to the other end of the plate 215 in the third direction. The plate 214 is positioned further toward the one side in the third direction than the plate 93 to be spaced apart from the plate 93.

The one end of the plate 215 in the third direction is connected to the other end of the plate 216 in the second direction.

The plates 211 through 216 are disposed at positions the same as the plates 231 through 236 both in the second direction and the third direction, respectively.

The cases 21 and 23 constitute the arm 25 of the tape cassette 100C. The arm 25 is constituted by the plates 21F and 23F. More specifically, the arm 25 is constituted by the plate 23D and the plate 231 through 234 of the case 23 and the partition plate 21M and the plates 211, 213, and 214 of the case 21.

The arm 25 has the discharge port 17 on the one end of the arm 25 (i.e., the one end of the arm 25 in the third direction). The discharge port 17 includes a discharge port 17A and a discharge port 17B.

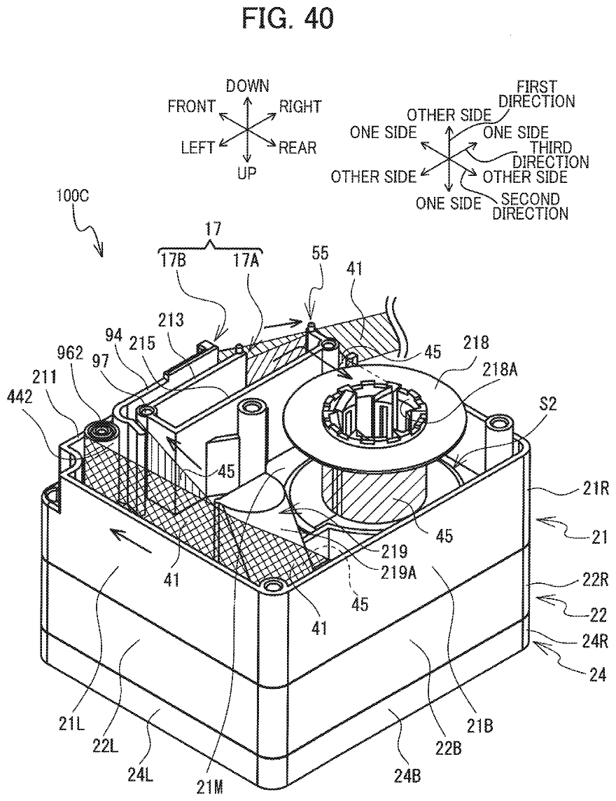

As illustrated in FIG. 40, each of the discharge ports 17A and 17B has a slit shape extending in the first direction. The discharge port 17A is constituted by the plate 213 and the one end of the plate 94 (i.e., the one end of the plate 94 in the third direction).

In the second direction, the discharge port 17B is positioned closer to the one end of the housing 20 in the second direction than the discharge port 17A is to the one end of the housing 20 in the second direction. The discharge port 17B is constituted by the one end of the plate 94 (i.e., the one end of the plate 94 in the third direction) and the one end of the plate 211 (i.e., the one end of the plate 211 in the third direction).

The housing 20 further includes a guide 78. Specifically, the guide 78 is disposed on the one end of the plate 21R (i.e., the one end of the plate 21R in the second direction). The guide 78 has a slit extending in the first direction. The tape 41 that has been discharged out of the arm 25 through the discharge port 17 is to be conveyed toward the slit in the guide 78. The guide 78 is configured to guide the tape 41 passing through the slit of the guide 78 toward the discharge channel 9 of the printer 1.

The housing 20 has an inlet port 55. Specifically, the inlet port 55 is positioned between the one end of the plate 21R (i.e., the one end of the plate 21R in the second direction) and the guide 78. The inlet port 55 has a slit through which the used ink ribbon 45 enters the housing 20 again.

In the following description, a space located further toward the one side in the third direction than the arm 25 will also be referred to as the head opening 29. That is, the head opening 29 is a space between the arm 25 and the guide 78, and is also a space between the arm 25 and the inlet port 55.

As illustrated in FIGS. 29, 31, and 32, the case 22 includes a partition plate 22U and plates 22B, 22R, 22L, and 22F. Each of the partition plate 22U and the plates 22B, 22R, 22L, and 22F has a rectangular shape.

The partition plate 22U has plate surfaces which are orthogonal to the first direction. The partition plate 22U has an opening 221H. A ribbon guide 229 and shafts 26 through 28, 223, and 224 are disposed on the partition plate 22U.

The opening 221H is located in the corner of the partition plate 22U on the other side in the second direction and on the one side in the third direction. The opening 221H extends through the partition plate 22U in the first direction. In a state where the case 23 is coupled to the case 22, the opening 221H is in communication with the opening 211H illustrated in FIG. 30.

The ribbon guide 229 and the shafts 26 through 28 extend toward the other side in the first direction from the partition plate 22U. The shafts 223 and 224 extend toward the one side in the first direction from the partition plate 22U.

The ribbon guide 229 is disposed on the corner of the partition plate 22U on the other side in the second direction and on the one side in the third direction. The other end of the ribbon guide 229 in the first direction is connected to the opening 221H. The ribbon guide 229 has a sloped surface 229A, which is curved. The sloped surface 229A is sloped to extend toward the one side in the second direction as the sloped surface 229A extends toward the one side in the first direction. The ribbon guide 229 is configured to guide the conveyance of the ink ribbon 45. Specifically, the ink ribbon 45 is to be conveyed while contacting the sloped surface 229A of the ribbon guide 229.

The shaft 26 is disposed on the corner of the partition plate 22U on the one side in the second direction and on the one side in the third direction. The shaft 27 is disposed on a portion of the partition plate 22U in the vicinity of the center in the second direction and in the vicinity of the center in the third direction. The shaft 28 is disposed on the other side of the shaft 27 in the second direction and on the one side of the shaft 27 in the third direction. The position of the shaft 28 corresponds to the position of the opening 23H.

On the partition plate 22U, the shaft 223 is positioned on the one side in the second direction and on the other side in the third direction. On the partition plate 22U, the shaft 224 is positioned on the other side in the second direction and on the one side in the third direction.

The plate 22R is positioned at the one end of the partition plate 22U in the third direction. The plate 22R has plate surfaces which are orthogonal to the third direction. In the first direction, the partition plate 22U is positioned between the one end of the plate 22R in the first direction and the other end of the plate 22R in the first direction.

The plate 22B is positioned at the other end of the partition plate 22U in the second direction. The plate 22B has plate surfaces which are orthogonal to the second direction. In the first direction, the partition plate 22U is positioned between the one end of the plate 22B in the first direction and the other end of the plate 22B in the first direction.

The plate 22L is positioned at the other end of the partition plate 22U in the third direction. The plate 22L has plate surfaces which are orthogonal to the third direction. In the first direction, the partition plate 22U is positioned between the one end of the plate 22L in the first direction and the other end of the plate 22L in the first direction.

The plate 22F is positioned at the one end of the partition plate 22U in the second direction. The plate 22F has plate surfaces which are orthogonal to the second direction. In the first direction, the partition plate 22U is positioned between the one end of the plate 22F in the first direction and the other end of the plate 22F in the first direction.

The housing 20 also has an opening 16. More specifically, the opening 16 is positioned on the corner of the case 21 and the case 22 on the one side in the second direction and on the one side in the third direction.

As illustrated in FIG. 29, the case 24 includes plates 24U, 24R, 24B, 24L, and 24F. Each of the plates 24U, 24B, 24R, 24L, and 24F has a rectangular shape.

The plate 24U has plate surfaces which are orthogonal to the first direction. Shafts 247 and 249 are disposed on the plate 24U. Specifically, the shafts 247 and 249 extend toward the other side in the first direction from the plate 24U. The shaft 247 is disposed on the corner of the plate 24U on the one side in the second direction and on the other side in the third direction. The shaft 249 is disposed at a position away from the center of the plate 24U, more specifically, at a position further toward the other side in the second direction and toward the one side in the third direction than the center of the plate 24U.

The plate 24R is positioned at the one end of the plate 24U in the third direction. The plate 24B is positioned at the other end of the plate 24U in the second direction. The plate 24L is positioned at the other end of the plate 24U in the third direction. The plate 24F is positioned at the one end of the plate 24U in the second direction.

The plates 24R, 24B, 24L, and 24F extend toward the other side in the first direction from the plate 24U.

The partition plate 21M partitions the internal space of the housing 20 into a first space S1 and a second space S2 in the first direction.

The first space S1 is a space enclosed by the partition plate 21M and the plates 21F, 21B, 21L, and 21R of the case 21, the plates 22F, 22B, 22L, and 22R of the case 22, and the plates 24U, 24F, 24B, 24L, and 24R of the case 24.

The second space S2 is a space enclosed by the plates 23D, 23F, 23B, 23L, and 23R of the case 23 and the partition plate 21M and the plates 21F, 21B, 21L, and 21R of the case 21.

The first space S1 and the second space S2 are arranged in the first direction. The first space S1 is located on the one side of the second space S2 in the first direction. The arm 25 defines the one end of the second space S2 in the second direction. The opening 23H is in communication with the second space S2.

Further, the partition plate 22U partitions the first space S1 into a third space S3 and a fourth space S4 in the first direction. The third space S3 and the fourth space S4 are arranged in the first direction. The third space S3 is positioned on the one side of the fourth space S4 in the first direction.

The third space S3 is a space enclosed by the plates 24U, 24F, 24B, 24L, and 24R of the case 24 and the partition plate 22U and the plates 22F, 22B, 22L, and 22R of the case 22.

The fourth space S4 is a space enclosed by the partition plate 21M and the plates 21F, 21B, 21L, and 21R of the case 21 and the partition plate 22U and the plates 22F, 22B, 22L, and 22R of the case 22.

As illustrated in FIGS. 29, 31, and 34 through 37, the tape roll 41A, the ribbon roll 45A, and the gears 30 are positioned in the first space S1 of the tape cassette 100C.

Specifically, the tape roll 41A and the ribbon roll 45A are positioned in the third space S3.

In the third space S3, the tape roll 41A is disposed on the corner of the partition plate 22U on the one side in the second direction and on the other side in the third direction, as illustrated in FIGS. 29, 31, and 34 through 36. A holder 421 is fitted inside the tape spool 47.

The shafts 247 and 223 are fitted inside the holder 421. The shafts 247 and 223 have the rotation axis L21 extending in the first direction. That is, the tape spool 47 is rotatable about the rotation axis L21.

As illustrated in FIGS. 29, 31, and 34 through 36, in the third space S3, the ribbon roll 45A is disposed at a position away from center of the partition plate 22U, more specifically, at a position further toward the other side in the second direction and further toward the one side in the third direction than the center of the partition plate 22U.

A holder 423 is fitted inside the ribbon spool 46. The shafts 249 and 224 are fitted inside the holder 423. The shafts 249 and 224 have the rotation axis L23 extending in the first direction. Accordingly, the ribbon spool 46 is rotatable about the rotation axis L23.

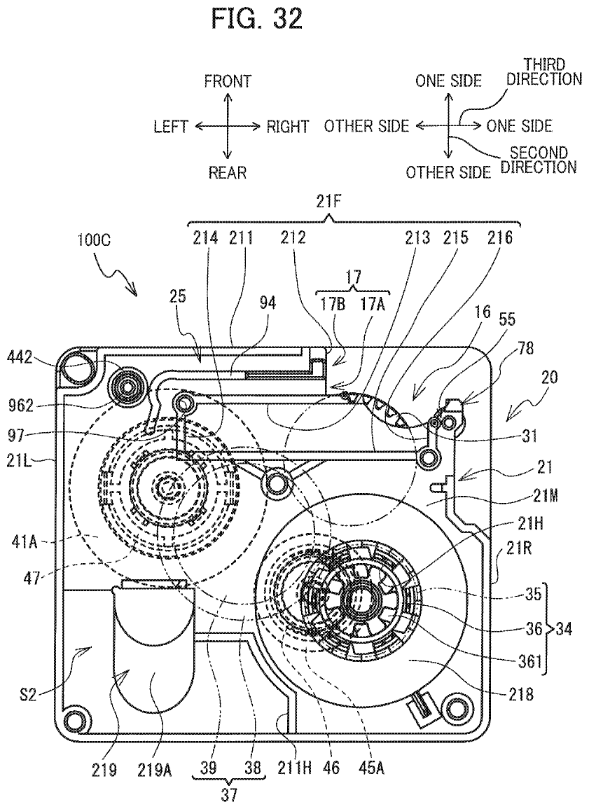

As illustrated in FIGS. 32 and 34 through 37, the gears 30 are positioned in the fourth space S4. The gears 30 are configured to transmit a drive force transmitted through the transmission gear 679 on the shaft 66E of the drive shaft 63 to the platen roller 82.

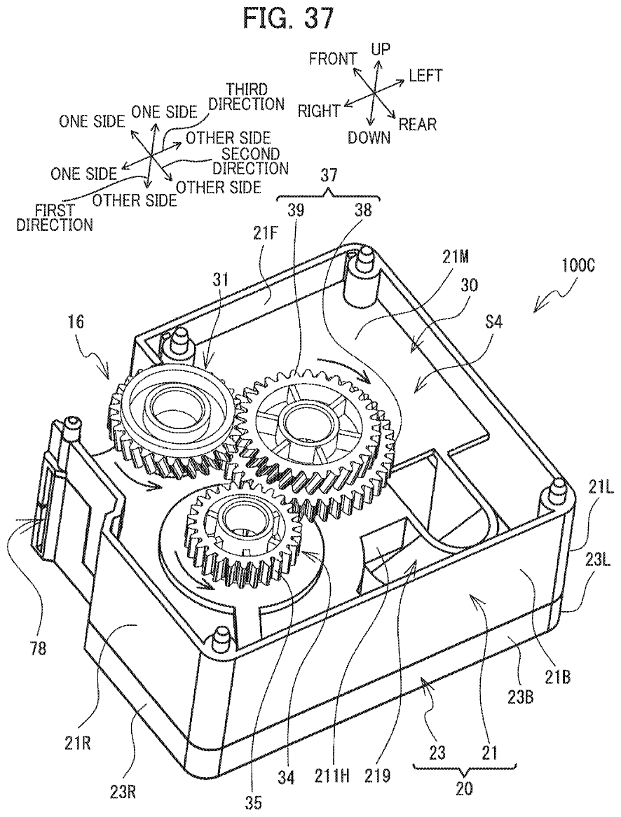

As illustrated in FIGS. 29 and 37, the gears 30 include gears 34, 31, and 37. The gear 34 is fitted over the shaft 28. The gear 31 is fitted over the shaft 26. The gear 37 is fitted over the shaft 27.

The gear 34 is rotatable about the shaft 28. The position of the gear 34 in the second direction and in the third direction is the same as the positions of the openings 23H and 21H in the second direction and in the third direction.

The gear 34 is coupled to the gear 31 through the gear 37. The gear 34 is configured to transmit a drive force to the gear 31. The gear 34 includes a gear 35 and a cam 36. The gear 35 is an external gear that is in meshing engagement with a gear 38 of the gear 37. The gear 35 is coupled to the cam 36.

The cam 36 is fixed to the gear 35 in the first direction. The cam 36 extends toward the other side in the first direction from the gear 35. The cam 36 is an internal gear having a hollow cylindrical shape. Specifically, the cam 36 has splines 361 on the inner circumferential surface of the cam 36. The shaft 66E of the drive shaft 63 is configured to be inserted into the cam 36 from the other side in the first direction.

A part of the cam 36 is inserted in the second space S2 from the fourth space S4. The cam 36 is exposed to the outside of the housing 20 through the opening 23H. Note that “the cam 36 is exposed” denotes a state in which the cam 36 is visible by the user.

The gear 31 is an external gear. The gear 31 is rotatable about the shaft 26 extending in the first direction. The gear 31 is positioned further toward the one side in the second direction than the gear 34 to be spaced apart from the gear 34.

The gear 31 is configured to transmit, to the platen gear 83, a drive force for conveying the tape 41. The gear 31 is so-called a helical gear. The gear teeth of the gear 31 are helical (i.e., skewed) relative to the first direction at a predetermined angle. The gear teeth on the gear 31 are of the opposite hand to the gear teeth on the platen gear 83.

In a state where the tape cassette 100C is attached to the cassette attachment portion 10, the gear 31 meshes with the platen gear 83 in the space in communication with the head opening 29.

A part of the gear 31 is exposed to the outside of the housing 20 through the opening 16. That is, a part of the gear 31 is exposed to the space in communication with the head opening 29. Note that the phrase “the gear 31 is exposed” denotes a state in which the gear 31 is visible by the user.

The gear 37 is in meshing engagement with both the gear 31 and the gear 34. The gear 37 is configured to transmit a drive force inputted into the gear 34 to the gear 31.

Specifically, the gear 37 is configured to transmit a drive force inputted into the gear 34 to the gear 31 while reducing a rotational speed of the drive force. That is, the gears 30 include a reduction mechanism.

The gear 37 is a double gear including the gear 38 and a gear 39. The gears 38 and 39 are arranged side by side and coaxial with each other. The diameter of the gear 39 is smaller than the diameter of the gear 38. The gear 38 is positioned farther from the tape roll 41A than the gear 39 is from the tape roll 41A in the first direction.

The gear 38 is in meshing engagement with the gear 34. The gear 38 is an external spur gear.

The gear 39 is in meshing engagement with the gear 31. The gear 39 is an external helical gear. The gear 39 has gear teeth which are of the opposite hand to the gear teeth on the gear 31.

As illustrated in FIGS. 30 and 34 through 36, the take-up spool 218, the discharge ports 17A and 17B, and the inlet port 55 are located in the second space S2.

The take-up spool 218 is positioned at the corner in the second space S2 on the other side in the second direction and on the one side in the third direction. The take-up spool 218 has a hollow cylindrical shape extending in the first direction.

A cam 218A is arranged inside the take-up spool 218. The cam portion 67A of the drive cam 67 in the printer 1 is configured to be fitted in the cam 218A. The cam portion 67A is rotatable about a rotation axis L1. That is, the cam 218A is rotatable about the rotation axis L1.

In the second space S2, the discharge port 17A is located in the one end of the arm 25 (i.e., the one end of the arm 25 in the third direction). The discharge port 17A allows the ink ribbon 45 to be discharged from the second space S2 through the discharge port 17A.

In the second space S2, the discharge port 17B is also located in the one end of the arm 25. The discharge port 17B allows the tape 41 to be discharged from the second space S2 through the discharge port 17B.

The discharge port 17A is positioned between the discharge port 17B and the ribbon roll 45A in the second direction.

In the second space S2, the inlet port 55 is located in the corner on the one side in the second direction and on the one side in the third direction. The inlet port 55 allows the ink ribbon 45 to be inserted in the second space S2 again through the inlet port 55.

Next, the positional relationship among the components in the tape cassette 100C will be described with reference to FIG. 32. In the following description, the phrase “a component overlaps another component” denotes that at least a part of the component overlaps at least a part of the other component when viewed from the one side or the other side in the corresponding direction. Further, the phrase “a component does not overlap another component” denotes that the component does not overlap the other component when viewed from the one side or the other side in the corresponding direction. These phrases do not denote that the component and the other component are physically in contact with each other.

The ribbon roll 45A does not overlap the tape roll 41A in the first direction. The ribbon roll 45A overlaps the take-up spool 218 in the first direction. Both the ribbon roll 45A and the tape roll 41A do not overlap the take-up spool 218 in the second direction. Both the ribbon roll 45A and the tape roll 41A do not overlap the take-up spool 218 in the third direction.

The take-up spool 218 does not overlap the tape roll 41A in the first direction. The take-up spool 218 overlaps the ribbon roll 45A in the first direction. In the first direction, the one end of the take-up spool 218 in the first direction is spaced apart from both the other end of the tape roll 41A in the first direction and the other end of the ribbon roll 45A in the first direction. The take-up spool 218 does not overlap the ribbon roll 45A in the second direction. The take-up spool 218 does not overlap the ribbon roll 45A in the third direction.

A part of the gear 34 overlaps a part of the ribbon roll 45A in the first direction. The gear 34 overlaps a part of the take-up spool 218 in the first direction. A part of the gear 34 (i.e., the gear 35) does not overlap any of the tape roll 41A, the ribbon roll 45A, or the take-up spool 218 in the second direction. Further, a part of the gear 34 (i.e., the gear 35) does not overlap any of the tape roll 41A, the ribbon roll 45A, or the take-up spool 218 in the third direction. A part of the gear 34 (i.e., the cam 36) overlaps the take-up spool 218 in the second direction. Further, a part of the gear 34 (i.e., the cam 36) overlaps the take-up spool 218 in the third direction.

A part of the gear 37 overlaps a part of the tape roll 41A in the first direction. A part of the gear 37 overlaps a part of the ribbon roll 45A in the first direction. A part of the gear 37 overlaps a part of the take-up spool 218 in the first direction. The gear 37 does not overlap any of the ribbon roll 45A, the tape roll 41A, or the take-up spool 218 in the second direction. The gear 37 does not overlap any of the ribbon roll 45A, the tape roll 41A, or the take-up spool 218 in the third direction.

A part of the gear 31 overlaps a part of the take-up spool 218 in the first direction. The gear 31 does not overlap either the ribbon roll 45A or the tape roll 41A in the first direction. The gear 31 does not overlap any of the tape roll 41A, the ribbon roll 45A, or the take-up spool 218 in the second direction. The gear 31 does not overlap any of the tape roll 41A, the ribbon roll 45A, or the take-up spool 218 in the third direction.

Next, the printing operations performed with the printer 1 and the tape cassette 100C will be described with reference to FIGS. 37 through 40. The user attaches the tape cassette 100C to the cassette attachment portion 10, thereby positioning the print head 71 in the head opening 29 at a position in which the print head 71 overlaps both the tape 41 and the ink ribbon 45 in the second direction.

The shaft 66E of the drive shaft 63 is inserted in the cam 36 of the gear 34 positioned in the fourth space S4. The cam portion 67A of the drive cam 67 of the drive shaft 63 is inserted in the cam 218A of the take-up spool 218. The platen roller 82 is moved to the adjacent position. As a result, the platen gear 83 is brought into meshing engagement with the gear 31.

As illustrated in FIG. 37, in a state where the tape cassette 100C is attached to the cassette attachment portion 10, the gear 34 is rotated together with the cam 36 due to the rotation of the shaft 66E of the drive shaft 63. The gear 37 is also rotated in accordance with the rotation of the gear 34. The gear 31 is also rotated in accordance with the rotation of the gear 37. The platen gear 83 is also rotated in accordance with the rotation of the gear 31, thereby rotating the platen roller 82.

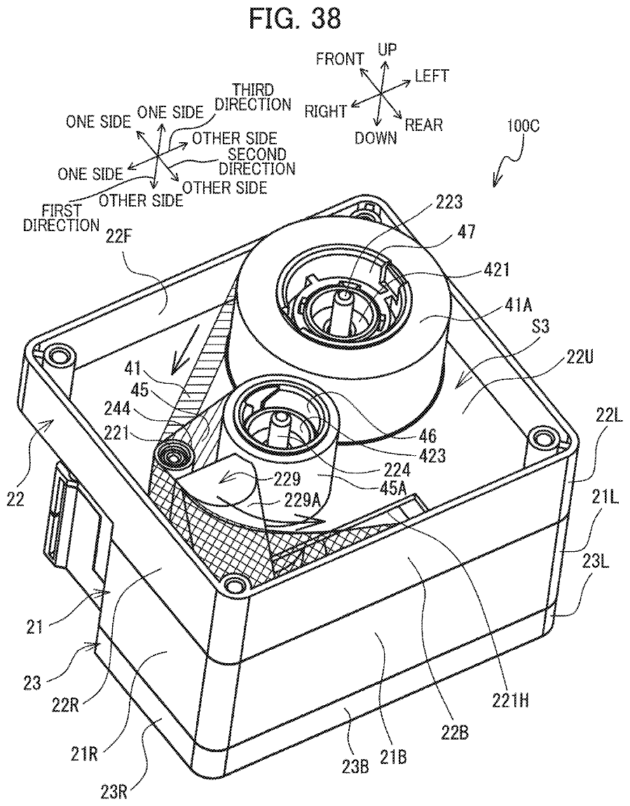

As illustrated in FIG. 38, the tape 41 is drawn off the tape roll 41A in the third space S3 due to the rotation of the platen roller 82. At the same time, the ink ribbon 45 is drawn off the ribbon roll 45A in the third space S3 due to the rotation of the take-up spool 218.

The tape 41 and the ink ribbon 45 are overlaid on each other at a roller 244. The tape 41 and the ink ribbon 45 reach the ribbon guide 229 after moving past the roller 244.

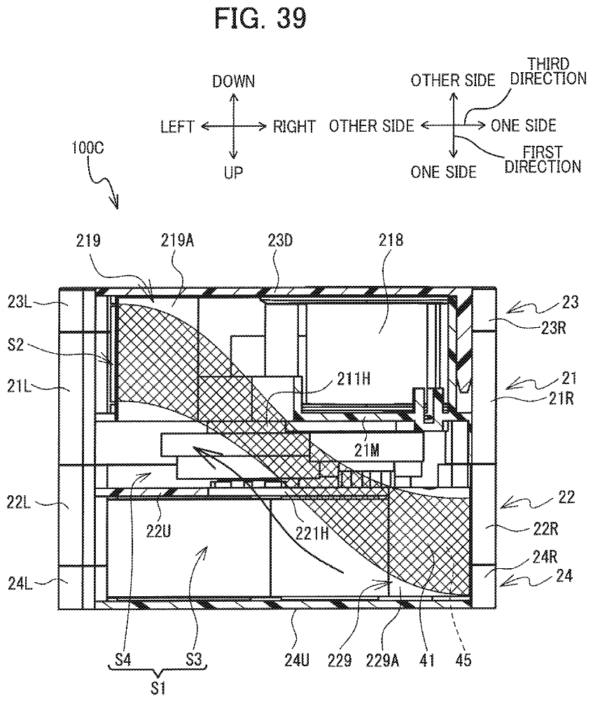

As illustrated in FIG. 39, the conveying directions of the tape 41 and the ink ribbon 45 are changed by the sloped surface 229A of the ribbon guide 229. That is, the tape 41 and the ink ribbon 45 are conveyed toward the other side in the first direction and the other side in the third direction to be moved from the first space S1 to the second space S2.

The tape 41 and the ink ribbon 45 are conveyed toward the ribbon guide 219. The conveying directions of the tape 41 and the ink ribbon 45 are changed along the sloped surface 219A of the ribbon guide 219.

As illustrated in FIG. 40, in the second space S2, the tape 41 is conveyed toward the one side in the second direction, i.e., toward the tape guide 442. The tape 41 is guided by the tape guide 442 toward the discharge port 17B. At this time, the tape 41 is conveyed toward the one side in the third direction through the gap between the plate 211 and the plate 94. Then, the tape 41 is discharged to the outside of the housing 20, i.e., an outside of the second space S2, through the discharge port 17B.

In the meantime, in the second space S2, the ink ribbon 45 is conveyed toward the one side in the second direction, i.e., toward the guide 97 in the arm 25. The ink ribbon 45 separates from the tape 41 at a position between the ribbon guide 219 and the guide 97. At this time, the ink ribbon 45 is conveyed toward the one side in the second direction through the gap between the plate 93 and the plate 214.

Thereafter, the ink ribbon 45 is guided by the guide 97 toward the discharge port 17A. The ink ribbon 45 is conveyed toward the one side in the third direction through the gap between the plate 94 and the plate 213. The ink ribbon 45 is then discharged to the outside of the housing 20, i.e., the outside of the second space S2 through the discharge port 17A.

The tape 41 and the ink ribbon 45 which have been discharged through the discharge port 17 are conveyed toward the head opening 29. The platen roller 82 presses the tape 41 against the print head 71 through the ink ribbon 45 in the head opening 29. At this time, selected one or more heating elements 71A are heated in the print head 71, whereby some of the ink contained in the surface of the ink ribbon 45 is transferred to the tape 41. As a result, characters or symbols are printed on the tape 41.

The tape 41 on which printing has been performed is guided toward the discharge channel 9 in the printer 1 by the guide 78. That is, the tape 41 that has been discharged through the discharge port 17B does not return to an inside of the housing 20.

In the meantime, in the second space S2, the cam 218A of the take-up spool 218 is rotated following the rotation of the drive cam 67 to rotate the take-up spool 218.

In accordance with the rotation of the take-up spool 218, the used ink ribbon 45 is conveyed toward the inlet port 55. While guided by the inlet port 55, the ink ribbon 45 is conveyed toward the second space S2 again.

In the second space S2, the ink ribbon 45 is conveyed toward the other side in the second direction along the plate 21R. The ink ribbon 45 is then taken up by the take-up spool 218.

Once the printing operation has been completed, the user cuts off the printed tape 41 from the printer 1.

As described above, the tape spool 47 is positioned in the housing 20. The tape roll 41A is mounted on the tape spool 47. The ribbon spool 46 is positioned in the housing 20. The ribbon roll 45A is mounted on the ribbon spool 46. The discharge port 17A is positioned in the second space S2 (more specifically, in the plate 21F that defines the second space S2). The discharge port 17A allows the ink ribbon 45 to be discharged to the outside of the housing 20. The inlet port 55 is positioned in the second space S2 (more specifically, in the plate 21F that defines the second space S2). The inlet port 55 allows the ink ribbon 45 to enter the housing 20. The ribbon guides 219 and 229 are configured to guide the ink ribbon 45 during the conveyance of the ink ribbon 45 from the first space S1 toward the second space S2. The ribbon guide 229 is positioned in the first space S1, while the ribbon guide 219 is positioned in the second space S2. In the first direction, the ribbon spool 46 and the take-up spool 218 are spaced apart from each other. The ribbon spool 46, the tape roll 41A, and the tape spool 47 are positioned in the first space S1. The ink ribbon 45 drawn off the ribbon roll 45A is conveyed along the ribbon guides 229 and 219 and conveyed through the discharge port 17A and the inlet port 55, in order, and is taken up by the take-up spool 218. That is, in the conveying direction in which the ink ribbon 45 drawn off the ribbon roll 45A is conveyed from the ribbon roll 45A to the take-up spool 218, the ribbon roll 45A, the ribbon guides 229 and 219, the discharge port 17A, the inlet port 55, and the take-up spool 218 are arranged in order from upstream to downstream. In this way, the components can be appropriately arranged in the tape cassette 100C.

The roller 244 is positioned in the first space S1. The ink ribbon 45 drawn off the ribbon roll 45A and the tape 41 drawn off the tape roll 41A are overlaid on each other on the roller 244. In the tape cassette 100C, the ink ribbon 45 and the tape 41 can be overlaid on each other on the roller 244.

The discharge port 17B is positioned in the second space S2 (more specifically, in the plate 21F that defines the second space S2). The discharge port 17B allows the tape 41 to be discharged to the outside of the housing 20. The tape guide 442 is positioned in the second space S2. The tape guide 442 is configured to guide the tape 41 during the conveyance of the tape 41. The tape 41 drawn off the tape roll 41A is conveyed along the ribbon guides 229 and 219 and the tape guide 442, in order, and conveyed to the discharge port 17B. That is, in the conveying direction in which the tape 41 drawn off the tape roll 41A is conveyed from the tape roll 41A to the discharge port 17B, the tape roll 41A, the ribbon guides 229 and 219, the tape guide 442, and the discharge port 17B are arranged in order from upstream to downstream. In the tape cassette 100C, the tape 41 drawn off the tape roll 41A can be conveyed along the ribbon guides 229 and 219 and the tape guide 442, in order, and conveyed to the discharge port 17B.

The take-up spool 218 overlaps the ribbon roll 45A in the first direction. The take-up spool 218 does not overlap the ribbon roll 45A in the second direction orthogonal to the first direction. The take-up spool 218 and the ribbon roll 45A can be arranged to be offset from each other in the tape cassette 100C.

The take-up spool 218 does not overlap the tape roll 41A in the first direction. The take-up spool 218 does not overlap the tape roll 41A in the second direction orthogonal to the first direction. The tape cassette 100C enables the take-up spool 218 and the tape roll 41A to be arranged offset from each other in the first direction and in the second direction.

The take-up spool 218 overlaps the ribbon roll 45A in the first direction. The take-up spool 218 does not overlap the tape roll 41A in the first direction. The tape cassette 100C enables the take-up spool 218 to be arranged to overlap the ribbon roll 45A in the first direction and to be offset from the tape roll 41A in the first direction.

The partition plate 22U partitions the first space S1 into the third space S3 and the fourth space S4 in the first direction. The ribbon roll 45A and the tape roll 41A are positioned in the third space S3. The gears 30 are positioned in the fourth space S4. The ribbon roll 45A and the tape roll 41A can be arranged in the third space S3 and the gears 30 can be arranged in the fourth space S4 in the tape cassette 100C.

The gears 30 include the gear 31. A part of the gear 31 is exposed to the outside of the housing 20. The tape cassette 100C can expose the gear 31 to the outside of the housing 20.

The gear 31 does not overlap the ribbon roll 45A in the first direction. The tape cassette 100C can arrange the gear 31 and the ribbon roll 45A so that the gear 31 and the ribbon roll 45A are offset from each other in the first direction.

The gears 30 include the gear 37 in engagement with the gear 31. The tape cassette 100C can accommodate not only the gear 31 but also the gear 37.

The gear 37 overlaps the ribbon roll 45A in the first direction. The tape cassette 100C enables the gear 37 and the ribbon roll 45A to be arranged to overlap each other in the first direction.

The gear 37 overlaps the tape roll 41A in the first direction. The tape cassette 100C enables the gear 37 and the tape roll 41A to be arranged to overlap each other in the first direction.

The gears 30 include the gear 34 for receiving a drive force. The tape cassette 100C can accommodate the gear 34.

In this modification, the rotation axis L23 is an example of the “axis”. The partition plate 21M is an example of the “first partition plate”. The partition plate 22U is an example of the “second partition plate”. The surfaces of the plate 24U are an example of the “first surface”. The surfaces of the plate 23D are an example of the “second surface”. The case 24 is an example of the “first case”. The case 23 is an example of the “second case”. The plate 21F is an example of the “wall defining the second space”. The ribbon guide 229 is an example of the “first ribbon guide”. The ribbon guide 219 is an example of the “second ribbon guide”. The discharge port 17A is also an example of the “discharge port”. The inlet port 55 is an example of the “inlet port”. The gears 30, 31, 37, and 34 are each an example of the “gear”.

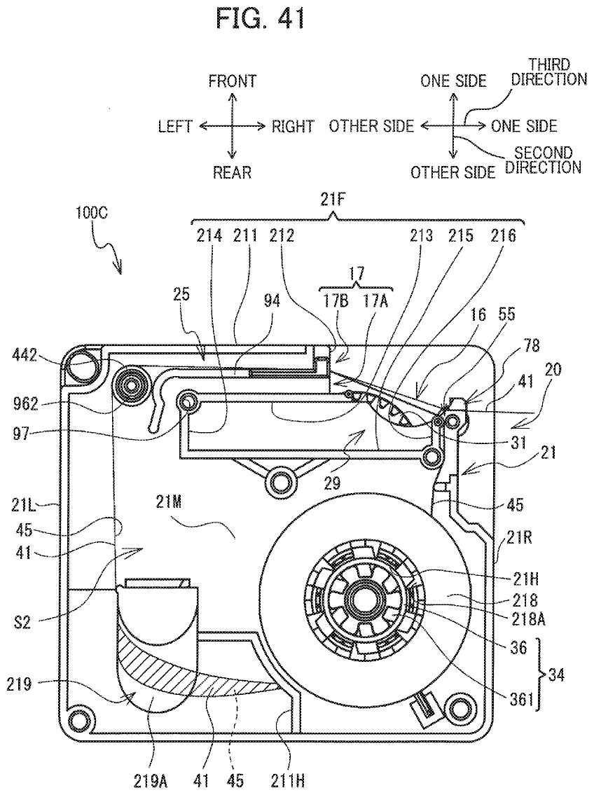

Note that the conveying passage for the ink ribbon 45 may be modified in the tape cassette 100C, as illustrated in FIG. 41. In the second space S2, the ink ribbon 45 may be conveyed along the tape guide 442 and through the discharge port 17B together with the tape 41, for example. Then, the ink ribbon 45 is used for printing in the head opening 29. The used ink ribbon 45 enters the second space S2 after passing through the inlet port 55, and is taken up by the take-up spool 218. In this variation illustrated in FIG. 41, the discharge port 17B serves as an example of the “discharge port”.

The roller 244 may be omitted from the tape cassette 100C.

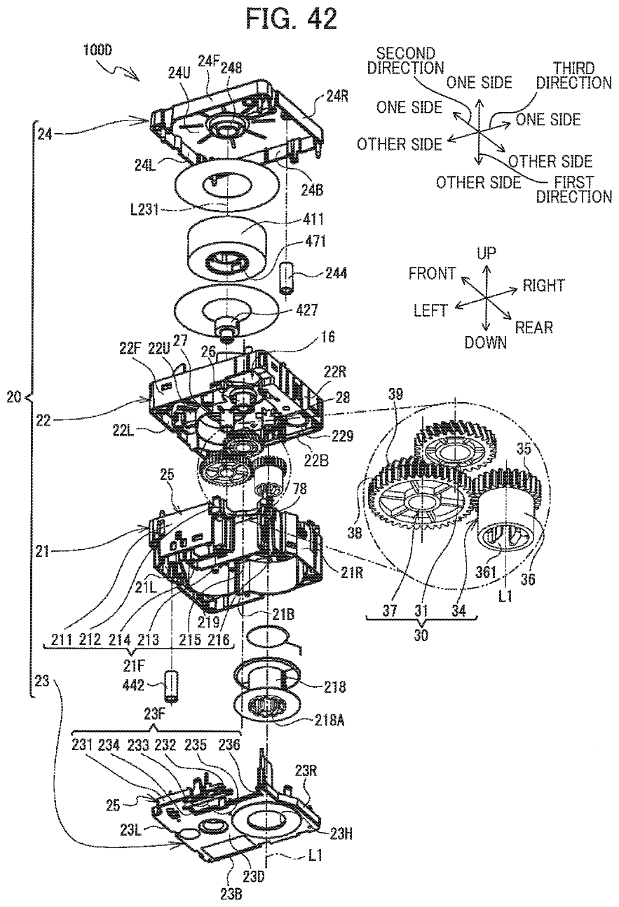

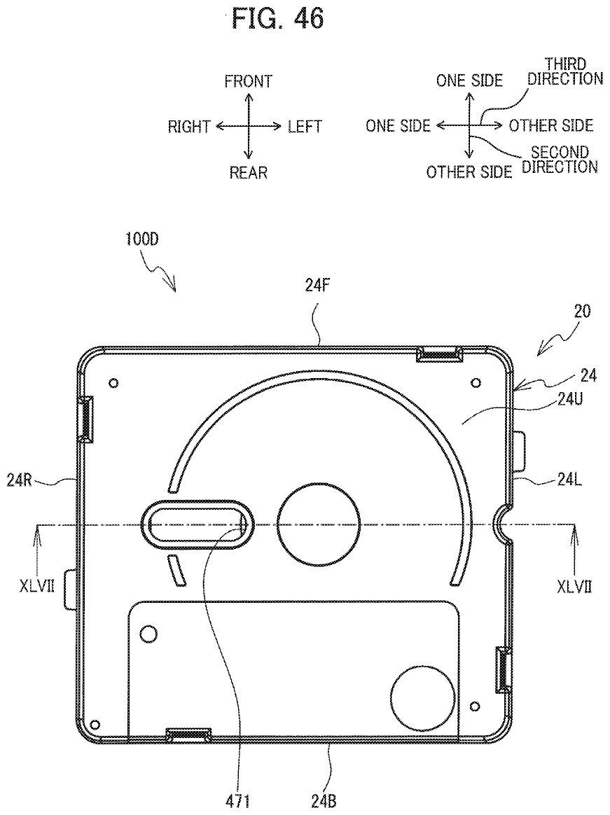

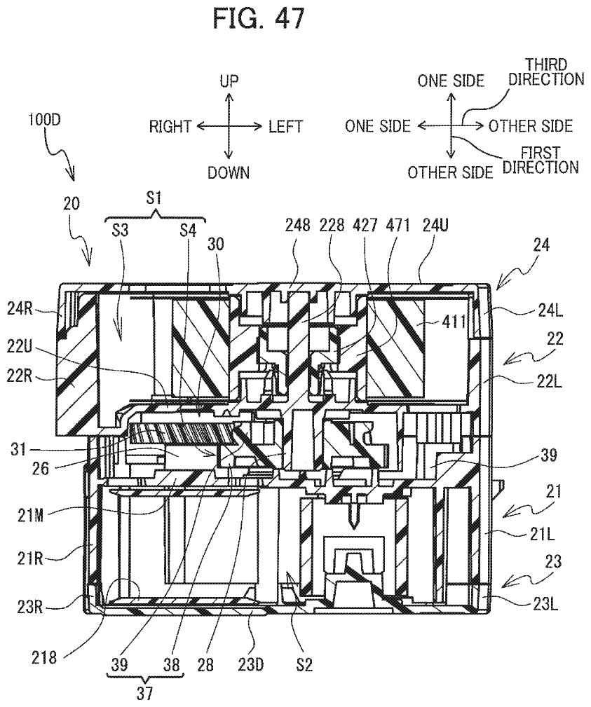

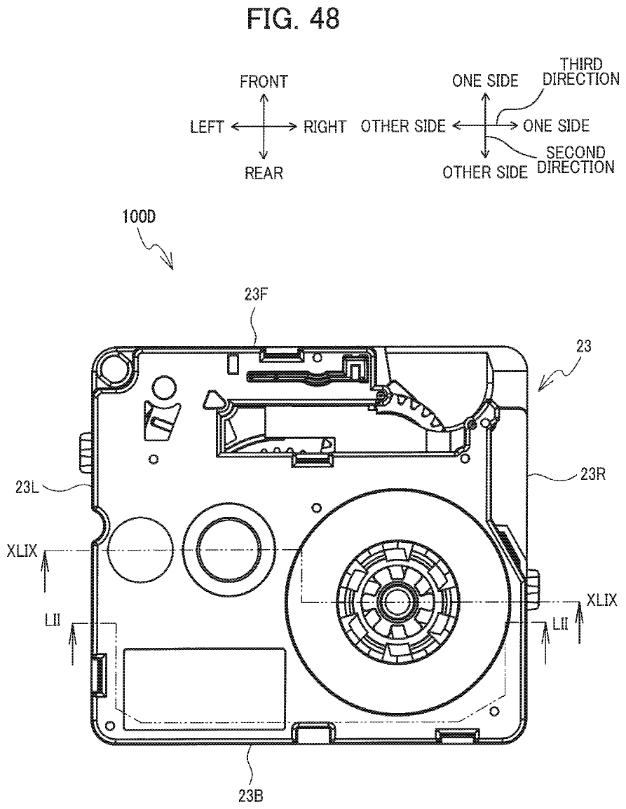

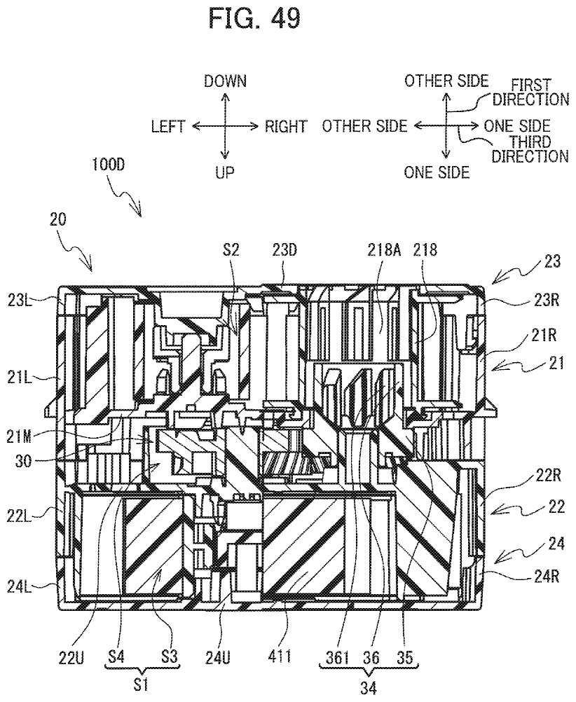

Next, the tape cassette 100D according to a modification of the present disclosure will be described with reference to FIGS. 42 through 53. The tape cassette 100D is attachable to the cassette attachment portion 10 illustrated in FIG. 2. Replenishment of the tape and change of the type (for example, the size, the color, and the material) of the tape can be performed by replacing the tape cassette 100D attached to the cassette attachment portion 10 of the printer 1.

The tape cassette 100D includes a housing 20, a roll 411, a take-up spool 218, and gears 30. As illustrated in FIG. 42, the tape cassette 100D has a rectangular parallelepiped outer shape. That is, the housing 20 has a rectangular parallelepiped shape. The housing 20 accommodates the roll 411, the take-up spool 218, and the gears 30.

Inside the housing 20, the roll 411 is positioned on the center in the second direction and on the center in the third direction. Inside the housing 20, a spool 471 is positioned on the center in the second direction and on the center in the third direction.

The roll 411 is a roll in which a tape 41 and an ink ribbon 45 are wound together in an overlaid state. That is, the roll 411 serves not only as a tape roll but also as a ribbon roll.

Each of the tape 41 and the ink ribbon 45 has a strip shape. The tape 41 includes a printing tape having adhesive coated on one surface and a releasing paper bonded to the one surface of the printing tape to cover the same, for example. The tape 41 is to be overlaid on the ink ribbon 45 to be subjected to printing by the print head 71.

Both the tape 41 and the ink ribbon 45 are wound about the spool 471. The spool 471 has a hollow cylindrical shape elongated in the first direction. The spool 471 is rotatable about a rotation axis L231 extending in the first direction with the tape 41 and the ink ribbon 45 wound about the spool 471. That is, the roll 411 is rotatable about the rotation axis L231 extending in the first direction. The rotation axis L231 is an imaginary axis. The rotation axis L231 passes through the center of the roll 411.

As illustrated in FIG. 42, the housing 20 of the tape cassette 100D includes an arm 25. The arm 25 is positioned at the one end portion of the housing 20 in the second direction. In the second direction, the arm 25 is positioned closer to the one end portion of the housing 20 in the second direction than to the other end portion of the housing 20 in the second direction.

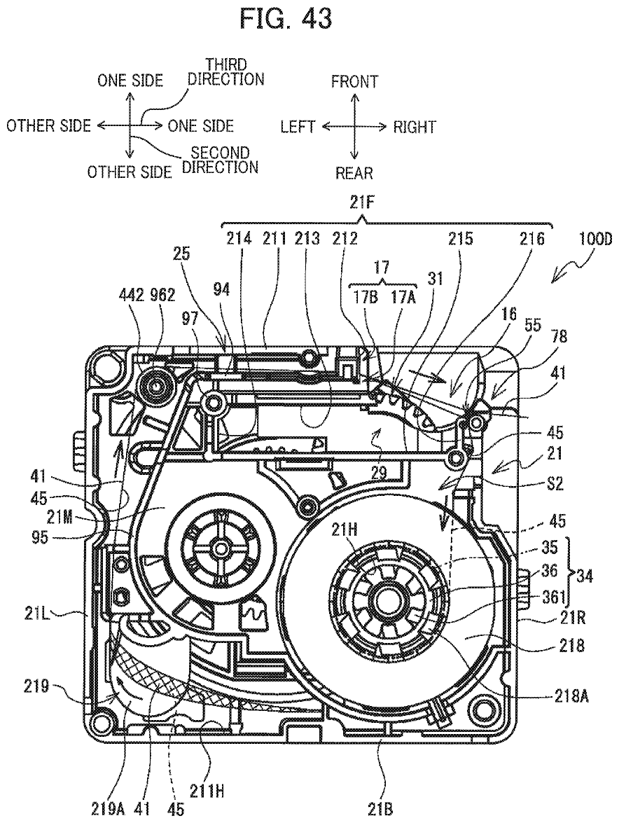

As illustrated in FIG. 43, the arm 25 has a discharge port 17. The discharge port 17 allows the tape 41 and the ink ribbon 45 to be discharged to an outside of the housing 20 through the discharge port 17. The arm 25 and the discharge port 17 will be described later in detail.

As illustrated in FIG. 42, the housing 20 includes a case 21, a case 22, a case 23, and a case 24.

The case 23 constitutes the other end of the housing 20 in the first direction. The case 21 is disposed on the one side of the case 23 in the first direction. The case 21 is coupled to the one end of the case 23 in the first direction.

The case 22 is disposed on the one side of the case 21 in the first direction. The case 22 is coupled to the one end of the case 21 in the first direction.

The case 24 constitutes the one end of the housing 20 in the first direction. The case 24 is disposed on the one side of the case 22 in the first direction. The case 24 is coupled to the one end of the case 22 in the first direction.

As illustrated in FIG. 42, the case 23 includes plates 23D, 23R, 23B, 23L, and 23F. Each of the plates 23D, 23B, 23R, and 23L has a rectangular shape.

The plate 23D has plate surfaces that are orthogonal to the first direction. The plate 23D has an opening 23H. In the plate 23D, the opening 23H is located on the other side in the second direction and on the one side in the third direction. The opening 23H extends through the plate 23D in the first direction.

The plate 23R is positioned at the one end of the plate 23D in the third direction. The plate 23B is positioned at the other end of the plate 23D in the second direction. The plate 23L is positioned at the other end of the plate 23D in the third direction. The plates 23R, 23B, and 23L extend toward the one side in the first direction from the plate 23D.

The plate 23F is positioned at the one end of the plate 23D in the second direction. The plate 23F includes plates 231 through 236. Each of the plates 231 through 236 has a rectangular shape. Each of the plates 231, 233, and 235 has plate surfaces that are orthogonal to the second direction. Each of the plates 232, 234, and 236 has plate surfaces that are orthogonal to the third direction.

The plate 231 is positioned at the one end of the plate 23D in the first direction. The one end of the plate 232 (i.e., the one end of the plate 232 in the second direction) is connected to the one end of the plate 231 (i.e., the one end of the plate 231 in the third direction). The other end of the plate 232 (i.e., the other end of the plate 232 in the second direction) is connected to the one end of the plate 233 (i.e., the one end of the plate 233 in the third direction). The other end of the plate 233 (i.e., the other end of the plate 233 in the third direction) is connected to the one end of the plate 234 (i.e., the one end of the plate 234 in the second direction). The other end of the plate 234 (i.e., the other end of the plate 234 in the second direction) is connected to the other end of the plate 235 (i.e., the other end of the plate 235 in the third direction). The one end of the plate 235 (i.e., the other end of the plate 235 in the third direction) is connected to the other end of the plate 236 (i.e., the other end of the plate 236 in the second direction).

As illustrated in FIGS. 42 and 43, the case 21 includes a partition plate 21M and plates 21R, 21B, 21L, and 21F. Each of the partition plate 21M and the plates 21R, 21B, and 21L has a rectangular shape.

As illustrated in FIGS. 42, 43, and 45, the partition plate 21M has plate surfaces that are orthogonal to the first direction. The partition plate 21M has openings 21H and 211H. A ribbon guide 219, plates 95 and 94, and a shaft 962 are disposed on the partition plate 21M.

In the partition plate 21M, the opening 21H is located on the other side in the second direction and on the one side in the third direction. The position of the opening 21H is the same as the position of the opening 23H. Specifically, the position of the opening 21H in the second direction and in the third direction is the same as the position of the opening 23H in the second direction and in the third direction. The opening 21H extends through the partition plate 21M in the up-down direction (i.e., in the first direction).

In the partition plate 21M, the opening 211H is located on the other end in the second direction and on the other end in the third direction. The opening 211H extends through the partition plate 21M in the first direction. The other end of the partition plate 21M in the second direction and the other end of the partition plate 21M in the third direction are notched by the opening 211H.

The ribbon guide 219, the plates 95 and 94, and the shaft 962 extend toward the other side in the first direction from the partition plate 21M.

The ribbon guide 219 is disposed on the corner of the housing 20 on the other side in the second direction and on the other side in the third direction. Specifically, the ribbon guide 219 is arranged at a position further toward the other side in the third direction than the opening 21H. The one end of the ribbon guide 219 in the first direction is connected to the opening 211H.

The ribbon guide 219 has a sloped surface 219A, which is curved. The sloped surface 219A is sloped to extend toward the one side in the second direction as the sloped surface 219A extends toward the other side in the first direction. The ribbon guide 219 is configured to guide the conveyance of the ink ribbon 45. More specifically, the ink ribbon 45 is to be conveyed while contacting the sloped surface 219A of the ribbon guide 219.

The plate 95 extends in the second direction along the plate 21L. The plate 95 is curved to form an arc shape centered on the center of the partition plate 21M. The other end of the plate 95 in the second direction is connected to the ribbon guide 219.

The plate 94 extends in the third direction. The plate 94 is positioned between a plate 211 and a plate 213 of the plate 21F in the second direction. The other end of the plate 94 in the third direction is connected to the one end of the plate 95 in the second direction. The plate 94 is positioned within the arm 25 (described later).

The shaft 962 is disposed on the corner of the partition plate 21M on the one side in the second direction and on the other side in the third direction. A tape guide 442 is fitted over the shaft 962. The tape guide 442 has a hollow cylindrical shape. The tape guide 442 is rotatable about the shaft 962.

The plate 21R is positioned at the one end of the housing 20 in the third direction. The plate 21R has plate surfaces which are orthogonal to the third direction. In the first direction, the partition plate 21M is positioned between the one end of the plate 21R in the first direction and the other end of the plate 21R in the first direction.

The plate 21B is positioned at the other end of the housing 20 in the second direction. The plate 21B has plate surfaces which are orthogonal to the second direction. In the first direction, the partition plate 21M is positioned between the one end of the plate 21B in the first direction and the other end of the plate 21B in the first direction.

The plate 21L is positioned at the other end of the housing 20 in the third direction. The plate 21L has plate surfaces which are orthogonal to the third direction. In the first direction, the partition plate 21M is positioned between the one end of the plate 21L in the first direction and the other end of the plate 21L in the first direction.

The plate 21F is positioned at the one end of the housing 20 in the second direction. The plate 21F includes plates 212 and 214 through 216 in addition to the plates 211 and 213. Each of the plates 211 through 216 has a rectangular shape. Each of the plates 211, 213, and 215 has plate surfaces which are orthogonal to the second direction. Each of the plates 214 and 216 has plate surfaces which are orthogonal to the third direction.

The plate 211 is positioned at the one end of the partition plate 21M in the second direction. The plate 213 is positioned further toward the other side in the second direction than the plate 94. The plate 94 is positioned between the plate 211 and the plate 213 in the second direction. In other words, a gap is formed between the plate 94 and the plate 211, and a gap is formed between the plate 94 and the plate 213.

The one end of the plate 212 in the second direction is connected to the one end of the plate 211 in the third direction. The other end of the plate 212 in the second direction is connected to the one end of the plate 213 in the third direction. The plate 212 constitutes a discharge port 17B (described later).

The other end of the plate 213 in the third direction is connected to a guide 97. The guide 97 is also connected to the one end of the plate 214 in the second direction. The other end of the plate 214 in the second direction is connected to the other end of the plate 215 in the third direction.

The one end of the plate 215 in the third direction is connected to the other end of the plate 216 in the second direction.

The plates 211 through 216 are disposed at positions the same as the plates 231 through 236 in the second direction and in the third direction, respectively.

The cases 21 and 23 constitute the arm 25 of the tape cassette 100D. The arm 25 is constituted by the plates 21F and 23F. More specifically, the arm 25 is constituted by the plate 23D and the plate 231 through 234 of the case 23 and the partition plate 21M and the plates 211, 213, and 214 of the case 21.

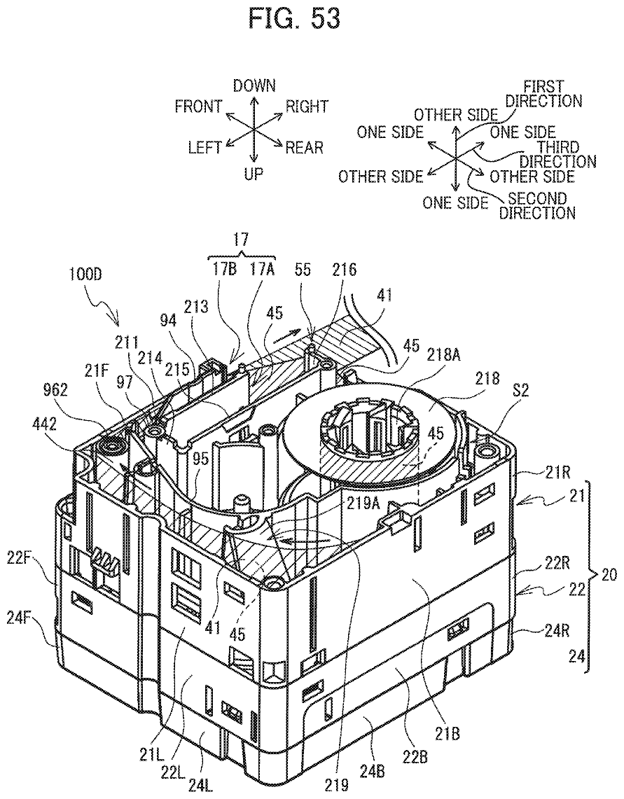

As illustrated in FIG. 53, the arm 25 has the discharge port 17 on the one end of the arm 25 (i.e., the one end of the arm 25 in the third direction). The discharge port 17 includes a discharge port 17A and the discharge port 17B.

As illustrated in FIG. 43, each of the discharge ports 17A and 17B has a slit shape extending in the first direction. Note that the discharge port 17A is not used in this modification.

The discharge port 17B is constituted by the one end of the plate 94 (i.e., the one end of the plate 94 in the third direction) and the one end of the plate 212 (i.e., the one end of the plate 94 in the second direction). In the second direction, the discharge port 17B is positioned closer to the one end of the housing 20 in the second direction than the discharge port 17A is to the one end of the housing 20 in the second direction.

The housing 20 further includes a guide 78. Specifically, the guide 78 is disposed on the one end of the plate 21R (i.e., the one end of the plate 21R in the second direction). The guide 78 has a slit extending in the first direction. The tape 41 that has been discharged out of the arm 25 through the discharge port 17B is to be conveyed toward the slit in the guide 78. The guide 78 is configured to guide the tape 41 passing through the slit of the guide 78 toward the discharge channel 9 of the printer 1.

The housing 20 has an inlet port 55. Specifically, the inlet port 55 is positioned between the one end of the plate 21R (i.e., the one end of the plate 21R in the second direction) and the guide 78. The inlet port 55 has a slit through which the used ink ribbon 45 enters the housing 20 again.

In the following description, a space located further toward the one side in the third direction than the arm 25 will also be referred to as a head opening 29. That is, the head opening 29 is a space between the arm 25 and the guide 78, and is also a space between the arm 25 and the inlet port 55.

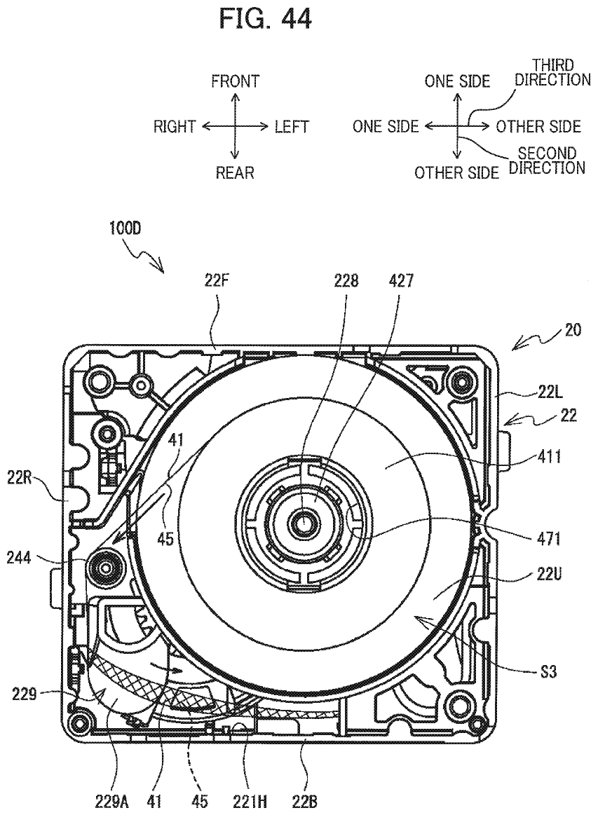

As illustrated in FIGS. 42 and 44, the case 22 includes a partition plate 22U and plates 22B, 22R, 22L, and 22F. Each of the partition plate 22U and the plates 22B, 22R, 22L, and 22F has a rectangular shape.

The partition plate 22U has plate surfaces which are orthogonal to the first direction. The partition plate 22U has an opening 221H. A ribbon guide 229 and shafts 26 through 28 and 228 are disposed on the partition plate 22U.

The opening 221H is located in the corner of the partition plate 22U on the other side in the second direction and on the one side in the third direction. The opening 221H extends through the partition plate 22U in the first direction. In a state where the case 23 is coupled to the case 22, the opening 221H is in communication with the opening 211H illustrated in FIG. 43.

The ribbon guide 229 and the shaft 228 extend toward the one side in the first direction from the partition plate 22U, while the shafts 26 through 28 extend toward the other side in the first direction from the partition plate 22U.

The ribbon guide 229 is disposed on the corner of the partition plate 22U on the other side in the second direction and on the one side in the third direction. The other end of the ribbon guide 229 in the first direction is connected to the opening 221H. The ribbon guide 229 has a sloped surface 229A, which is curved. The sloped surface 229A is sloped to extend toward the one side in the second direction as the sloped surface 229A extends toward the one side in the first direction. The ribbon guide 229 is configured to guide the conveyance of the ink ribbon 45. Specifically, the ink ribbon 45 is to be conveyed while contacting the sloped surface 229A of the ribbon guide 229.

The shaft 26 is disposed on the corner of the partition plate 22U on the one side in the second direction and on the one side in the third direction. The shaft 27 is disposed on a portion in the vicinity of the center of the partition plate 22U. The shaft 28 is disposed on the other side of the shaft 27 in the second direction and on the one side of the shaft 27 in the third direction. The position of the shaft 28 corresponds to the position of the opening 23H.

The shaft 228 is disposed on a position in the vicinity of the center of the partition plate 22U.

The plate 22R is positioned at the one end of the partition plate 22U in the third direction. The plate 22R has plate surfaces which are orthogonal to the third direction. In the first direction, the partition plate 22U is positioned between the one end of the plate 22R in the first direction and the other end of the plate 22R in the first direction.

The plate 22B is positioned at the other end of the partition plate 22U in the second direction. The plate 22B has plate surfaces which are orthogonal to the second direction. In the first direction, the partition plate 22U is positioned between the one end of the plate 22B in the first direction and the other end of the plate 22B in the first direction.

The plate 22L is positioned at the other end of the partition plate 22U in the third direction. The plate 22L has plate surfaces which are orthogonal to the third direction. In the first direction, the partition plate 22U is positioned between the one end of the plate 22L in the first direction and the other end of the plate 22L in the first direction.

The plate 22F is positioned at the one end of the partition plate 22U in the second direction. The plate 22F has plate surfaces which are orthogonal to the second direction. In the first direction, the partition plate 22U is positioned between the one end of the plate 22F in the first direction and the other end of the plate 22F in the first direction.

The housing 20 also has an opening 16. More specifically, the opening 16 is positioned on the corner of the case 21 and the case 22 on the one side in the second direction and on the one side in the third direction.

As illustrated in FIG. 42, the case 24 includes plates 24U, 24R, 24B, 24L, and 24F. Each of the plates 24U, 24B, 24R, 24L, and 24F has a rectangular shape.

The plate 24U has plate surfaces which are orthogonal to the first direction. A shaft 248 is disposed on the plate 24U. Specifically, the shaft 248 is disposed on a position in the vicinity of the center of the plate 24U in the second direction and in the vicinity of the center of the plate 24U in the third direction. The shaft 248 extends toward the other side in the first direction from the plate 24U.

The plate 24R is positioned at the one end of the plate 24U in the third direction. The plate 24B is positioned at the other end of the plate 24U in the second direction. The plate 24L is positioned at the other end of the plate 24U in the third direction. The plate 24F is positioned at the one end of the plate 24U in the second direction.

The plates 24R, 24B, 24L, and 24F extend toward the other side in the first direction from the plate 24U.

The partition plate 21M partitions the internal space of the housing 20 into a first space S1 and a second space S2 in the first direction.

The first space S1 is a space enclosed by the partition plate 21M and the plates 21F, 21B, 21L, and 21R of the case 21, the plates 22F, 22B, 22L, and 22R of the case 22, and the plates 24U, 24F, 24B, 24L, and 24R of the case 24.

The second space S2 is a space enclosed by the partition plate 21M and the plates 21F, 21B, 21L, and 21R of the case 21 and the plates 23D, 23F, 23B, 23L, and 23R of the case 23.

The first space S1 and the second space S2 are arranged in the first direction. The first space S1 is located on the one side of the second space S2 in the first direction. The arm 25 defines the one end of the second space S2 in the second direction. The opening 23H is in communication with the second space S2.

The partition plate 22U partitions the first space S1 into a third space S3 and a fourth space S4 in the first direction. The third space S3 and the fourth space S4 are arranged in the first direction. The third space S3 is positioned on the one side of the fourth space S4 in the first direction.

The third space S3 is a space enclosed by the plates 24U, 24F, 24B, 24L, and 24R of the case 24 and the partition plate 22U and the plates 22F, 22B, 22L, and 22R of the case 22.

The fourth space S4 is a space enclosed by the partition plate 22U and the plates 22F, 22B, 22L, and 22R of the case 22 and the partition plate 21M and the plates 21F, 21B, 21L, and 21R of the case 21.

As illustrated in FIGS. 44 and 47 through 49, the roll 411 and the gears 30 are positioned in the first space S1 in the tape cassette 100D.

Specifically, the roll 411 is positioned in the third space S3. In the third space S3, the roll 411 is positioned on the partition plate 21M on the center in the second direction and on the center in the third direction.

A holder 427 is fitted inside the spool 471 for the roll 411. The shafts 228 and 248 are inserted in the holder 427. The shafts 228 and 248 have the rotation axis L231 extending in the first direction. Accordingly, the spool 471 is rotatable about the rotation axis L231.

As illustrated in FIGS. 42, 47, and 49, the gears 30 are arranged in the fourth space S4. The gears 30 are configured to transmit a drive force transmitted through the transmission gear 679 on the shaft 66E of the drive shaft 63 to the platen roller 82.

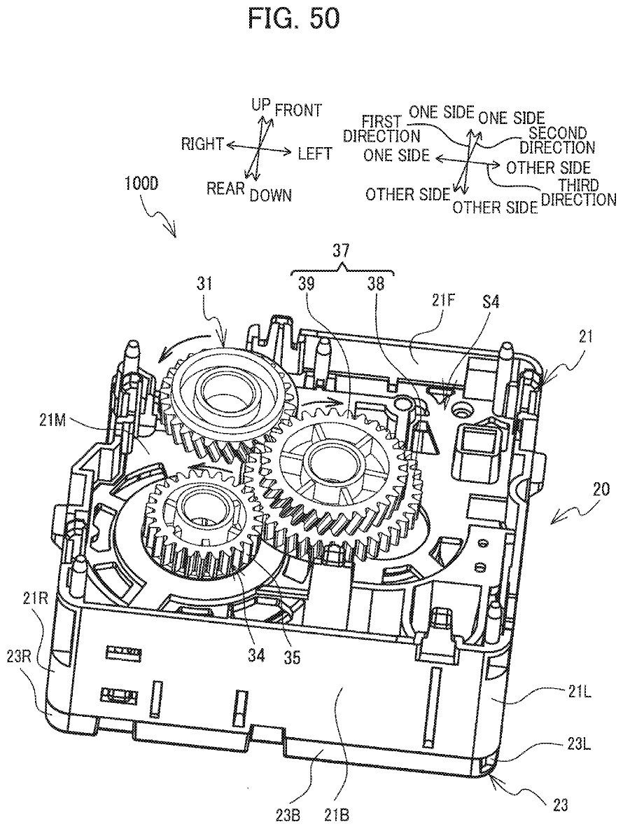

As illustrated in FIGS. 42 and 50, the gears 30 include gears 34, 31, and 37. The gear 34 is fitted over the shaft 28. The gear 31 is fitted over the shaft 26. The gear 37 is fitted over the shaft 27.

The gear 34 is rotatable about the shaft 28. The position of the gear 34 in the second direction and in the third direction is the same as the positions of the openings 23H and 21H in the second direction and in the third direction.

The gear 34 is coupled to the gear 31 through the gear 37. The gear 34 is configured to transmit a drive force to the gear 31. The gear 34 includes a gear 35 and a cam 36. The gear 35 is an external gear that is in meshing engagement with a gear 38 of the gear 37. The gear 35 is coupled to the cam 36.

The cam 36 is fixed to the gear 35 in the first direction. The cam 36 extends toward the other side in the first direction from the gear 35. The cam 36 is an internal gear having a hollow cylindrical shape. Specifically, the cam 36 has splines 361 on the inner circumferential surface of the cam 36. The shaft 66E of the drive shaft 63 is configured to be inserted into the cam 36 from the other side in the first direction.

A part of the cam 36 is inserted in the second space S2 from the fourth space S4. The cam 36 is exposed to the outside of the housing 20 through the opening 23H. Note that “the cam 36 is exposed” denotes a state in which the cam 36 is visible by the user.

The gear 31 is an external gear. The gear 31 is rotatable about the shaft 26 extending in the first direction. The gear 31 is positioned further toward the one side in the second direction than the gear 34 to be spaced apart from the gear 34.

The gear 31 is configured to transmit, to the platen gear 83, a drive force for conveying the tape 41. The gear 31 is so-called a helical gear. The gear teeth of the gear 31 are helical (i.e., skewed) relative to the first direction at a predetermined angle. The gear teeth on the gear 31 are of the opposite hand to the gear teeth on the platen gear 83.

In a state where the tape cassette 100D is attached to the cassette attachment portion 10, the gear 31 meshes with the platen gear 83 in the space in communication with the head opening 29.

A part of the gear 31 is exposed to the outside of the housing 20 through the opening 16. That is, a part of the gear 31 is exposed to the space in communication with the head opening 29. Note that the phrase “the gear 31 is exposed” denotes a state in which the gear 31 is visible by the user.

The gear 37 is in meshing engagement with both the gear 31 and the gear 34. The gear 37 is configured to transmit a drive force inputted into the gear 34 to the gear 31.

Specifically, the gear 37 is configured to transmit a drive force inputted into the gear 34 to the gear 31 while reducing a rotational speed of the drive force. That is, the gears 30 include a reduction mechanism.

The gear 37 is a double gear including the gear 38 and a gear 39. The gears 38 and 39 are arranged side by side and coaxial with each other. The diameter of the gear 39 is smaller than the diameter of the gear 38. The gear 38 is positioned farther from the roll 411 than the gear 39 is from the roll 411 in the first direction.

The gear 38 is in meshing engagement with the gear 34. The gear 38 is an external spur gear.

The gear 39 is in meshing engagement with the gear 31. The gear 39 is an external helical gear. The gear 39 has gear teeth which are of the opposite hand to the gear teeth on the gear 31.

As illustrated in FIGS. 43, 45, 47, and 49, the take-up spool 218, the discharge port 17B, and the inlet port 55 are positioned in the second space S2 in the tape cassette 100D. In the second space S2, the take-up spool 218 is positioned on the corner on the other side in the second direction and on the one side in the third direction.

A cam 218A is positioned inside the take-up spool 218. The cam portion 67A of the drive cam 67 in the printer 1 is configured to be fitted in the cam 218A. The cam portion 67A is rotatable about a rotation axis L1. That is, the cam 218A is rotatable about the rotation axis L1.

In the second space S2, the discharge port 17B is positioned on the one end of the arm 25 (i.e., the one end of the arm 25 in the third direction). The discharge port 17B allows the tape 41 and the ink ribbon 45 to be discharged from the second space S2 through the discharge port 17B.

In the second space S2, the inlet port 55 is located in the corner on the one side in the second direction and on the one side in the third direction. The inlet port 55 allows the ink ribbon 45 to enter the third space S3 again through the inlet port 55.

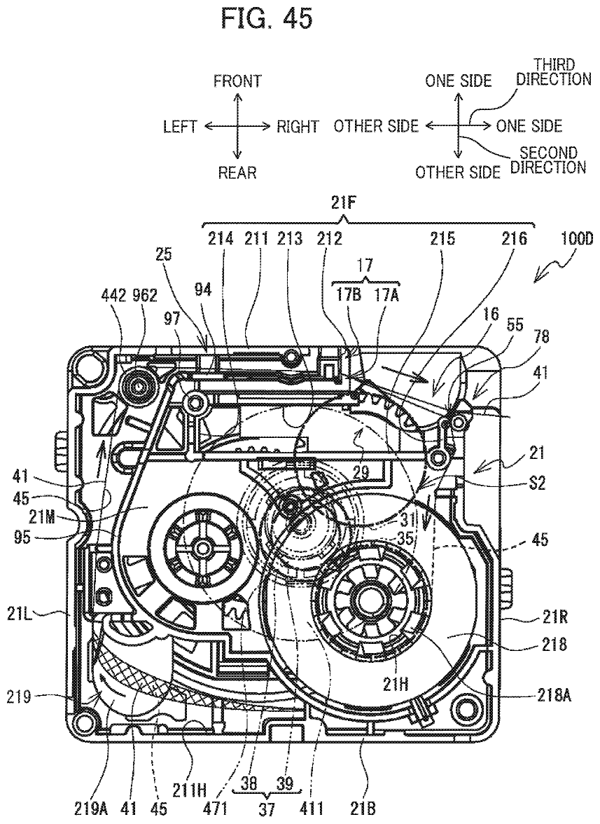

Next, the positional relationship among the components in the tape cassette 100D will be described with reference to FIG. 45. In the following description, the phrase “a component overlaps another component” denotes that at least a part of the component overlaps at least a part of the other component when viewed from the one side or the other side in the corresponding direction. Further, the phrase “a component does not overlap another component” denotes that the component does not overlap the other component when viewed from the one side or the other side in the corresponding direction. These phrases do not denote that the component and the other component are physically in contact with each other.

A part of the roll 411 overlaps a part of the take-up spool 218 in the first direction. In the first direction, the one end of the take-up spool 218 in the first direction is spaced apart from the other end of the roll 411 in the first direction. The roll 411 does not overlap the take-up spool 218 in the second direction. The roll 411 does not overlap the take-up spool 218 in the third direction.

A part of the gear 34 overlaps a part of the roll 411 in the first direction. A part of the gear 34 overlaps a part of the take-up spool 218 in the first direction. A part of the gear 34 (i.e., the gear 35) does not overlap either the roll 411 or the take-up spool 218 in the second direction. Further, a part of the gear 34 (i.e., the gear 35) does not overlap either the roll 411 or the take-up spool 218 in the third direction. A part of the gear 34 (i.e., the cam 36) overlaps the take-up spool 218 in the second direction. Further, a part of the gear 34 (i.e., the cam 36) overlaps the take-up spool 218 in the third direction.

A part of the gear 37 overlaps a part of the roll 411 in the first direction. A part of the gear 37 overlaps a part of the take-up spool 218 in the first direction. The gear 37 does not overlap either the roll 411 or the take-up spool 218 in the second direction. The gear 37 does not overlap either the roll 411 or the take-up spool 218 in the third direction.

A part of the gear 31 overlaps a part of the roll 411 in the first direction. A part of the gear 31 overlaps a part of the take-up spool 218 in the first direction. The gear 37 does not overlap either the roll 411 or the take-up spool 218 in the second direction. The gear 37 does not overlap either the roll 411 or the take-up spool 218 in the third direction.

Next, the printing operations performed with the printer 1 and the tape cassette 100D will be described with reference to FIGS. 50 through 53. The user attaches the tape cassette 100D to the cassette attachment portion 10, thereby positioning the print head 71 in the head opening 29 at a position in which the print head 71 overlaps both the tape 41 and the ink ribbon 45 in the second direction.

The shaft 66E of the drive shaft 63 is inserted in the cam 36 of the gear 34 positioned in the fourth space S4. The cam portion 67A of the drive cam 67 of the drive shaft 63 is inserted in the cam 218A of the take-up spool 218. The platen roller 82 is moved to the adjacent position. As a result, the platen gear 83 is brought into meshing engagement with the gear 31.

As illustrated in FIG. 50, in a state where the tape cassette 100D is attached to the cassette attachment portion 10, the gear 34 is rotated together with the cam 36 due to the rotation of the shaft 66E of the drive shaft 63. The gear 37 is also rotated in accordance with the rotation of the gear 34. The gear 31 is also rotated in accordance with the rotation of the gear 37. The platen gear 83 is also rotated in accordance with the rotation of the gear 31, thereby rotating the platen roller 82.

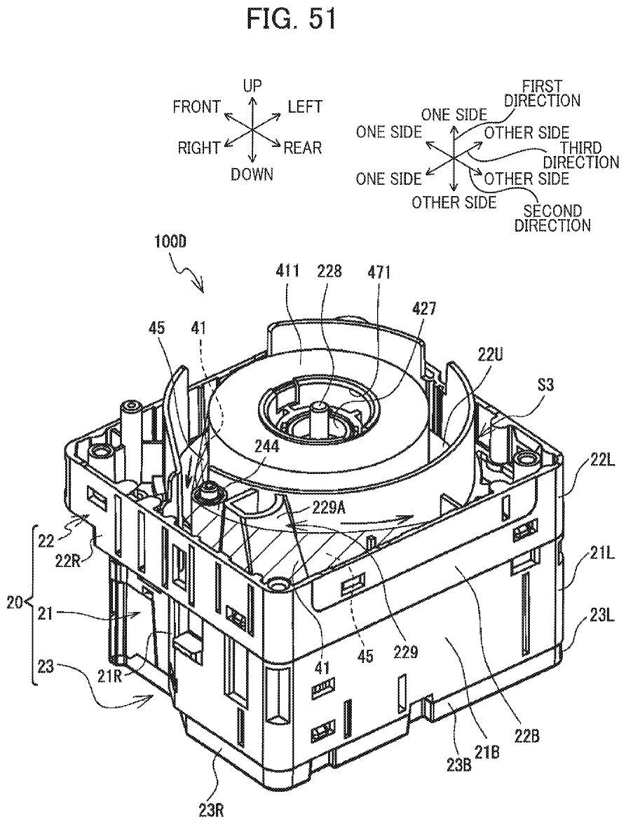

As illustrated in FIG. 51, both the tape 41 and the ink ribbon 45 are drawn off the roll 411 due to the rotation of the platen roller 82. The tape 41 and the ink ribbon 45 are conveyed toward a roller 244. The tape 41 and the ink ribbon 45 are overlaid on each other on the roller 244.

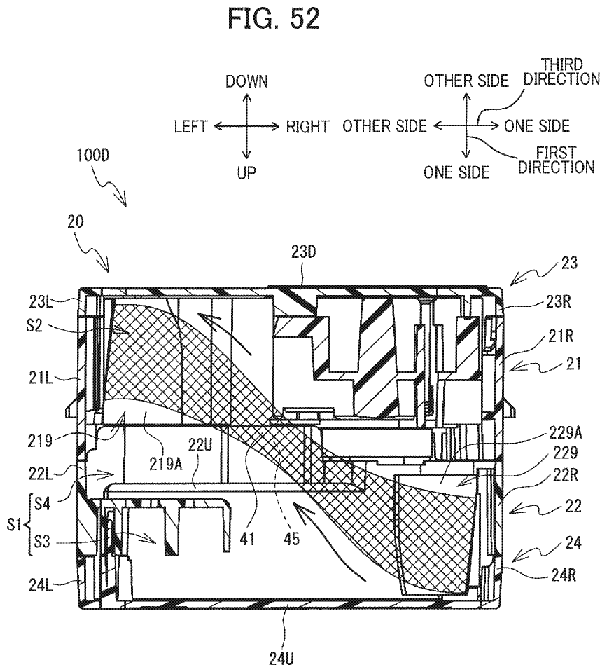

As illustrated in FIG. 52, the tape 41 and the ink ribbon 45 which have moved past the roller 244 reach the ribbon guide 229. The conveying directions of the tape 41 and the ink ribbon 45 are changed by the sloped surface 229A of the ribbon guide 229. As a result, the tape 41 and the ink ribbon 45 are conveyed toward the other side in the first direction and the other side in the third direction. The tape 41 and the ink ribbon 45 are conveyed from the third space S3 to the second space S2.

In the second space S2, the tape 41 and the ink ribbon 45 are conveyed toward the ribbon guide 219. Then, the tape 41 and the ink ribbon 45 are conveyed along the sloped surface 219A of the ribbon guide 219, whereby the conveying directions of the tape 41 and the ink ribbon 45 are changed by the sloped surface 219A. Then, the tape 41 and the ink ribbon 45 are conveyed toward the one side in the second direction.

As illustrated in FIG. 53, the tape 41 is guided toward the tape guide 442 in the second space S2.

The tape 41 and the ink ribbon 45 are conveyed toward the one side in the third direction through the gap between the plate 211 and the plate 94. The tape 41 and the ink ribbon 45 are then discharge to the outside of the housing 20, i.e., an outside of the second space S2, through the discharge port 17B.

The tape 41 and the ink ribbon 45 which have been discharged through the discharge port 17B are conveyed toward the head opening 29. In the head opening 29, the platen roller 82 presses the tape 41 against the print head 71 through the ink ribbon 45. At this time, selected one or more heating elements 71A are heated in the print head 71, whereby some of the ink contained in the surface of the ink ribbon 45 is transferred to the tape 41. As a result, characters or symbols are printed on the tape 41.

The tape 41 on which printing has been performed is guided toward the discharge channel 9 in the printer 1 by the guide 78. That is, the tape 41 that has been discharged through the discharge port 17B does not return to an inside of the housing 20.

In the meantime, in the second space S2, the cam 218A of the take-up spool 218 is rotated in accordance with the rotation of the drive cam 67, thereby rotating the take-up spool 218.

The rotation of the take-up spool 218 causes the used ink ribbon 45 to be conveyed toward the inlet port 55. The ink ribbon 45 is guided by the inlet port 55 to enter the second space S2 again.

In the second space S2, the ink ribbon 45 is conveyed toward the other side in the second direction along the plate 21R, and is taken up by the take-up spool 218.

Once the printing operation has been completed, the user cuts off the printed tape 41 from the printer 1.

As described above, the discharge port 17B is positioned in the second space S2 (more specifically, in the plate 21F that defines the second space S2). The discharge port 17B allows the ink ribbon 45 to be discharged to the outside of the housing 20. The inlet port 55 is also positioned in the second space S2 (more specifically, in the plate 21F that defines the second space S2). The inlet port 55 allows the ink ribbon 45 to enter the housing 20. The ribbon guides 219 and 229 are positioned for guiding the ink ribbon 45 during the conveyance of the ink ribbon 45 from the first space S1 toward the second space S2. The ribbon guide 229 is positioned in the third space S3 (i.e., in the first space S1), and the ribbon guide 219 is positioned in the second space S2. The tape 41 and the ink ribbon 45 are wound together in an overlaid state to constitute the single roll 411. The roll 411 is positioned in the first space S1 and is rotatable about the rotation axis L231. The ink ribbon 45 drawn off the roll 411 is conveyed along the ribbon guides 229 and 219 and conveyed through the discharge port 17B and the inlet port 55, in order, and is taken up by the take-up spool 218. That is, in the conveying direction in which the ink ribbon 45 drawn off the roll 411 is conveyed from the roll 411 to the take-up spool 218, the roll 411, the ribbon guides 229 and 219, the discharge port 17B, the inlet port 55, and the take-up spool 218 are arranged in order from upstream to downstream. In this way, in the tape cassette 100D, the components can be appropriately arranged.

The tape guide 442 is positioned in the second space S2. The tape guide 442 is positioned for guiding the tape 41 during the conveyance of the tape 41 and for guiding the ink ribbon 45 during the conveyance of the ink ribbon 45. The discharge port 17B further allows the tape 41 to be discharged to the outside of the housing 20 together with the ink ribbon 45. The tape 41 drawn off the roll 411 is conveyed along the ribbon guides 229 and 219 and the tape guide 442, in order, and is conveyed to the discharge port 17B. That is, in the conveying direction in which the tape 41 drawn off the roll 411 is conveyed from the roll 411 to the discharge port 17B, the roll 411, the ribbon guides 229 and 219, the tape guide 442, and the discharge port 17B are arranged in order from upstream to downstream. In the tape cassette 100D, the tape 41 drawn off the roll 411 can be conveyed along the ribbon guides 229 and 219 and the tape guide 442, in order, and conveyed to the discharge port 17B.

The take-up spool 218 overlaps the roll 411 in the first direction. The take-up spool 218 does not overlap the roll 411 in the second direction orthogonal to the first direction. The tape cassette 100D enables the take-up spool 218 and the roll 411 to be arranged to overlap each other in the first direction and to be offset from each other in the second direction.

The partition plate 22U partitions the first space S1 into the third space S3 and the fourth space S4 in the first direction. The roll 411 is positioned in the third space S3. The gears 30 are positioned in the fourth space S4. In the tape cassette 100D, the roll 411 can be positioned in the third space S3, and the gears 30 can be positioned in the fourth space S4.

The gears 30 include the gear 31. A part of the gear 31 is exposed to the outside of the housing 20. The tape cassette 100D enables a part of the gear 31 to be exposed to the outside of the housing 20.

The gear 31 overlaps the roll 411 in the first direction. The tape cassette 100D enables the gear 31 and the roll 411 to be arranged to overlap each other in the first direction.

The gears 30 also include the gear 37 in engagement with the gear 31. The tape cassette 100D can accommodate not only the gear 31 but also the gear 37.

The gear 37 overlaps the roll 411 in the first direction. The tape cassette 100D enables the gear 37 and the roll 411 to be arranged to overlap each other in the first direction.

The gears 30 also include the gear 34 for receiving a drive force. The tape cassette 100D can also accommodate the gear 34.

In this modification, the roll 411 is an example of the “tape roll”. The roll is also an example of the “ribbon roll”. The roll 411 is also an example of the “single roll”. The rotation axis L231 is an example of the “axis”. The partition plate 21M is an example of the “first partition plate”. The partition plate 22U is an example of the “second partition plate”. The surfaces of the plate 24U are an example of the “first surface”. The surfaces of the plate 23D are an example of the “second surface”. The case 24 is an example of the “first case”. The case 23 is an example of the “second case”. The plate 21F is an example of the “wall defining the second space”. The ribbon guide 229 is an example of the “first ribbon guide”. The ribbon guide 219 is an example of the “second ribbon guide”. The discharge port 17B is also an example of the “discharge port”. The inlet port 55 is an example of the “inlet port”. The gears 30, 31, 37, and 34 are each an example of the “gear”.

Although the discharge port 17A in the tape cassette 100D is not used, different configurations may be employed. That is, the ink ribbon 45 may be discharged to the outside of the tape cassette 100D through the discharge port 17A. Alternatively, the discharge port 17 may include only the discharge port 17B, and the discharge port 17A may be dispensed with. That is, the slit of the discharge port 17A may be omitted.

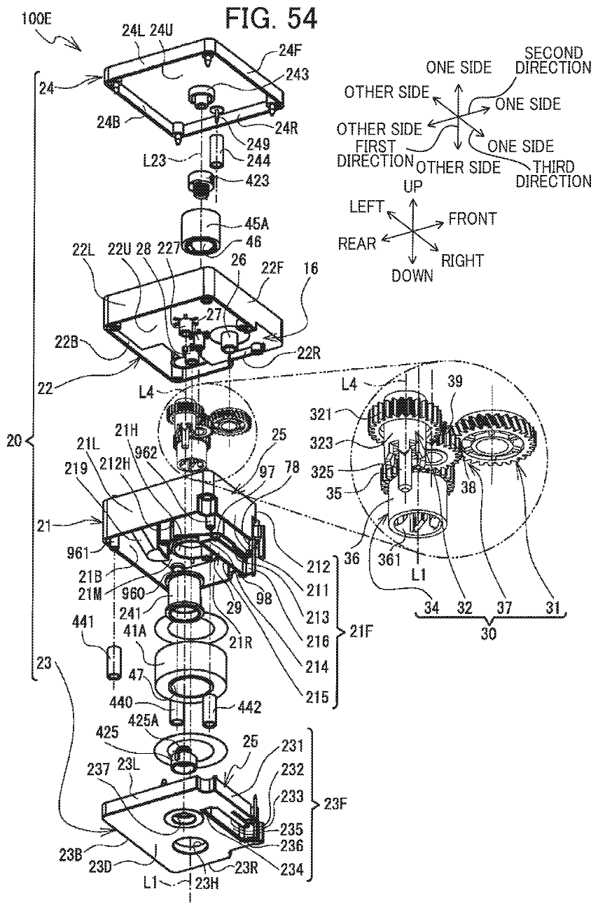

Next, the tape cassette 100E according to a modification of the present disclosure will be described with reference to FIGS. 54 through 65. The tape cassette 100E is attachable to the cassette attachment portion 10 illustrated in FIG. 2. Replenishment of the tape and change of the type (for example, the size, the color, and the material) of the tape can be performed by replacing the tape cassette 100E attached to the cassette attachment portion 10 of the printer 1.

The tape cassette 100E includes a housing 20, a tape roll 41A, a ribbon roll 45A, a take-up spool 241, and gears 30. As illustrated in FIG. 54, the tape cassette 100E has a rectangular parallelepiped outer shape. That is, the housing 20 has a rectangular parallelepiped shape. The housing 20 accommodates the tape roll 41A, the ribbon roll 45A, the take-up spool 241, and the gears 30.

Inside the housing 20, the tape roll 41A is positioned on the corner on the other side in the second direction and on the one side in the third direction. Inside the housing 20, a tape spool 47 is positioned on the corner on the other side in the second direction and on the one side in the third direction.

The tape roll 41A is a roll in which a tape 41 is wound about the tape spool 47.

The tape spool 47 has a hollow cylindrical shape elongated in the first direction. The tape 41 has a strip shape. The tape 41 includes a printing tape having adhesive coated on one surface and a releasing paper bonded to the one surface of the printing tape to cover the same, for example. The tape 41 is to be overlaid on an ink ribbon 45 (described later) to be subjected to printing by the print head 71.

The tape 41 is wound about the tape spool 47. The tape spool 47 is rotatable about a rotation axis L1 extending in the first direction with the tape 41 wound about the tape spool 47. The tape roll 41A is rotatable about the rotation axis L1 extending in the first direction. The rotation axis L1 is an imaginary axis. The rotation axis L1 passes through the center of the tape roll 41A.

Inside the housing 20, the ribbon roll 45A is positioned further toward the other side in the second direction than the center of the housing 20 to be away from the center of the housing 20. Similarly, a ribbon spool 46 is positioned further toward the other side in the second direction than the center of the housing 20 to be away from the center of the housing 20.

The ribbon roll 45A is a roll in which the ink ribbon 45 is wound about the ribbon spool 46.

The ribbon spool 46 has a hollow cylindrical shape that is elongated in the first direction. The ink ribbon 45 has a strip shape. For example, the ink ribbon 45 is a strip-like film containing ink. The ink ribbon 45 is to be used to perform printing on the tape 41. Specifically, the ink ribbon 45 is to be overlaid on the tape 41 in a head opening 29 (described later) to be used for printing by the print head 71.

The ink ribbon 45 is wound about the ribbon spool 46. Specifically, the ribbon spool 46 is rotatable about a rotation axis L23 extending in the first direction with the ink ribbon 45 wound about the ribbon spool 46. The ribbon roll 45A is rotatable about the rotation axis L23 extending in the first direction. The ink ribbon 45 is to be taken up by the take-up spool 241 (described later). The rotation axis L23 is an imaginary axis. The rotation axis L23 passes through the center of the ribbon roll 45A.

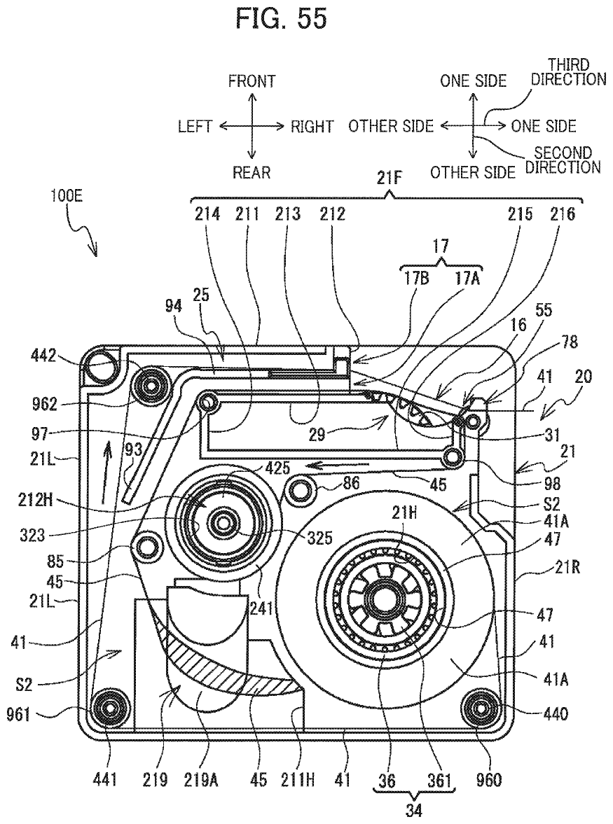

As illustrated in FIGS. 54 and 55, the housing 20 of the tape cassette 100E includes an arm 25. The arm 25 is positioned at the one end portion of the housing 20 in the second direction. In the second direction, the arm 25 is positioned closer to the one end portion of the housing 20 in the second direction than to the other end portion of the housing 20 in the second direction.

As illustrated in FIG. 55, the arm 25 has a discharge port 17. The discharge port 17 allows the tape 41 and the ink ribbon 45 to be discharged to an outside of the housing 20 through the discharge port 17. The arm 25 and the discharge port 17 will be described later in detail.

As illustrated in FIG. 54, the housing 20 includes a case 21, a case 22, a case 23, and a case 24.

The case 23 constitutes the other end of the housing 20 in the first direction. The case 21 is disposed on the one side of the case 23 in the first direction. The case 21 is coupled to the one end of the case 23 in the first direction.

The case 22 is disposed on the one side of the case 21 in the first direction. The case 22 is coupled to the one end of the case 21 in the first direction.

The case 24 constitutes the one end of the housing 20 in the first direction. The case 24 is disposed on the one side of the case 22 in the first direction. The case 24 is coupled to the one end of the case 22 in the first direction.

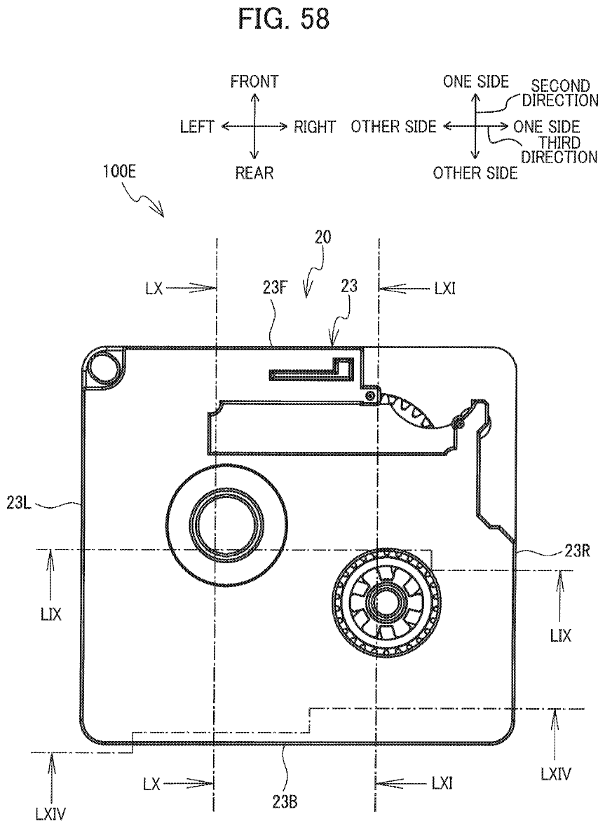

As illustrated in FIGS. 54 and 58, the case 23 includes plates 23D, 23R, 23B, 23L, and 23F. Each of the plates 23D, 23B, 23R, and 23L has a rectangular shape.

The plate 23D has plate surfaces that are orthogonal to the first direction. The plate 23D has an opening 23H. A shaft 237 is disposed on the plate 23D. In the plate 23D, the opening 23H is located on the other side in the second direction and on the one side in the third direction. The opening 23H extends through the plate 23D in the first direction.

On the plate 23D, the shaft 237 is positioned on the one side in the second direction and on the other side in the third direction. The shaft 237 protrudes toward the one side in the first direction from the plate 23D.

The plate 23R is positioned at the one end of the plate 23D in the third direction. The plate 23B is positioned at the other end of the plate 23D in the second direction. The plate 23L is positioned at the other end of the plate 23D in the third direction. The plates 23R, 23B, and 23L extend toward the one side in the first direction from the plate 23D.

The plate 23F is positioned at the one end of the plate 23D in the second direction. The plate 23F includes plates 231 through 236. Each of the plates 231 through 236 has a rectangular shape. Each of the plates 231, 233, and 235 has plate surfaces that are orthogonal to the second direction. Each of the plates 232, 234, and 236 has plate surfaces that are orthogonal to the third direction.

The plate 231 is positioned at the one end of the plate 23D in the first direction. The one end of the plate 232 (i.e., the one end of the plate 232 in the second direction) is connected to the one end of the plate 231 (i.e., the one end of the plate 231 in the third direction). The other end of the plate 232 (i.e., the other end of the plate 232 in the second direction) is connected to the one end of the plate 233 (i.e., the one end of the plate 233 in the third direction). The other end of the plate 233 (i.e., the other end of the plate 233 in the third direction) is connected to the one end of the plate 234 (i.e., the one end of the plate 234 in the second direction). The other end of the plate 234 (i.e., the other end of the plate 234 in the second direction) is connected to the other end of the plate 235 (i.e., the other end of the plate 235 in the third direction). The one end of the plate 235 (i.e., the other end of the plate 235 in the third direction) is connected to the other end of the plate 236 (i.e., the other end of the plate 236 in the second direction).

As illustrated in FIGS. 54, 55, and 57, the case 21 includes a partition plate 21M and plates 21R, 21B, 21L, and 21F. Each of the partition plate 21M and the plates 21R, 21B, and 21L has a rectangular shape.

As illustrated in FIGS. 54, 55, and 57, the partition plate 21M has plate surfaces that are orthogonal to the first direction. The partition plate 21M has openings 21H, 211H, and 212H. A ribbon guide 219, plates 93 and 94, shafts 960 through 962, and guides 85 and 86 are disposed on the partition plate 21M.

In the partition plate 21M, the opening 21H is located on the other side in the second direction and on the one side in the third direction. The position of the opening 21H is the same as the position of the opening 23H. Specifically, the position of the opening 21H in the second direction and in the third direction is the same as the position of the opening 23H in the second direction and in the third direction. The opening 21H extends through the partition plate 21M in the up-down direction (i.e., in the first direction).

In the partition plate 21M, the opening 212H is positioned on the one side in the second direction and on the other side in the third direction. The opening 212H extends through the partition plate 21M in the first direction.

In the partition plate 21M, the opening 211H is located on the other side in the second direction and on the other side in the third direction. The opening 211H extends through the partition plate 21M in the first direction. The other end of the partition plate 21M in the second direction and the other end of the partition plate 21M in the third direction are notched by the opening 211H.

The ribbon guide 219, the plates 93 and 94, the shafts 960 through 962, and the guides 85 and 86 extend toward the other side in the first direction from the partition plate 21M.

The ribbon guide 219 is disposed on the corner of the housing 20 on the other side in the second direction and on the other side in the third direction. Specifically, the ribbon guide 219 is disposed at a position further toward the other side in the third direction than the opening 21H. The one end of the ribbon guide 219 in the first direction is connected to the opening 211H.

The ribbon guide 219 has a sloped surface 219A, which is curved. The sloped surface 219A is sloped to extend toward the one side in the second direction as the sloped surface 219A extends toward the other side in the first direction. The ribbon guide 219 is configured to guide the conveyance of the ink ribbon 45. More specifically, the ink ribbon 45 is to be conveyed while contacting the sloped surface 219A of the ribbon guide 219.

The plate 93 extends in the second direction. The plate 93 is positioned closer to the plate 21L than to the plate 21R in the third direction. The one end of the plate 93 in the second direction is connected to the other end of the plate 94 in the third direction.

The plate 94 extends in the third direction. The plate 94 extends toward the one side in the third direction from the one end of the plate 93 in the second direction. The plate 94 is positioned within the arm 25 (described later).

The shaft 960 is positioned on the corner of the partition plate 21M on the other side in the second direction and on the one side in the third direction. A tape guide 440 is fitted over the shaft 960. The tape guide 440 has a hollow cylindrical shape. The tape guide 440 is rotatable about the shaft 960.

The shaft 961 is positioned on the corner of the partition plate 21M on the other side in the second direction and on the other side in the third direction. A tape guide 441 is fitted over the shaft 961. The tape guide 441 has a hollow cylindrical shape. The tape guide 441 is rotatable about the shaft 961.

The shaft 962 is positioned on the corner of the partition plate 21M on the one side in the second direction and on the other side in the third direction. A tape guide 442 is fitted over the shaft 962. The tape guide 442 has a hollow cylindrical shape. The tape guide 442 is rotatable about the shaft 962.

In the partition plate 21M, the guide 85 is positioned on the center in the second direction and on the other side in the third direction. The guide 86 is positioned in the partition plate 21M on the center in the second direction and on the center in the third direction.

The plate 21R is positioned at the one end of the housing 20 in the third direction. The plate 21R has plate surfaces which are orthogonal to the third direction. In the first direction, the partition plate 21M is positioned between the one end of the plate 21R in the first direction and the other end of the plate 21R in the first direction.

The plate 21B is positioned at the other end of the housing 20 in the second direction. The plate 21B has plate surfaces which are orthogonal to the second direction. In the first direction, the partition plate 21M is positioned between the one end of the plate 21B in the first direction and the other end of the plate 21B in the first direction.

The plate 21L is positioned at the other end of the housing 20 in the third direction. The plate 21L has plate surfaces which are orthogonal to the third direction. In the first direction, the partition plate 21M is positioned between the one end of the plate 21L in the first direction and the other end of the plate 21L in the first direction.

The plate 21F is positioned at the one end of the housing 20 in the second direction. The plate 21F includes plates 211 through 216. Each of the plates 211 through 216 has a rectangular shape. Each of the plates 211, 213, and 215 has plate surfaces which are orthogonal to the second direction. Each of the plates 214 and 216 has plate surfaces which are orthogonal to the third direction.

The plate 211 is positioned at the one end of the partition plate 21M in the second direction. The plate 213 is positioned further toward the other side in the second direction than the plate 94. The plate 94 is positioned between the plate 211 and the plate 213 in the second direction. In other words, a gap is formed between the plate 94 and the plate 211, and a gap is formed between the plate 94 and the plate 213.

The one end of the plate 212 in the second direction is connected to the one end of the plate 211 in the third direction. The other end of the plate 212 in the second direction is connected to the one end of the plate 213 in the third direction. The plate 212 constitutes the discharge port 17 (described later).

The other end of the plate 213 in the third direction is connected to a guide 97. The guide 97 is connected to the one end of the plate 214 in the second direction. The other end of the plate 214 in the second direction is connected to the other end of the plate 215 in the third direction. The plate 214 is positioned further toward the one side in the third direction than the plate 93 to be spaced apart from the plate 93. That is, a gap is formed between the plate 93 and the plate 214.

The one end of the plate 215 in the third direction is connected to a guide 98. The guide 98 is connected to the other end of the plate 216 in the second direction.

The plates 211 through 216 are disposed at positions the same as the plates 231 through 236 in the second direction and in the third direction, respectively.

The cases 21 and 23 constitute the arm 25 of the tape cassette 100E. The arm 25 is constituted by the plates 21F and 23F. More specifically, the arm 25 is constituted by the plate 23D and the plate 231 through 234 of the case 23 and the partition plate 21M and the plates 211, 213, and 214 of the case 21.

The arm 25 has the discharge port 17 on the one end of the arm 25 (i.e., the one end of the arm 25 in the third direction). The discharge port 17 includes a discharge port 17A and a discharge port 17B.

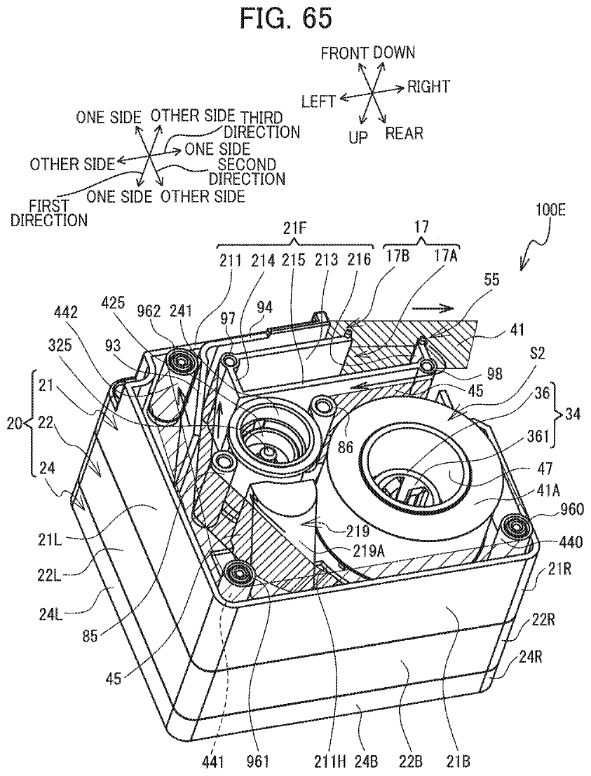

As illustrated in FIG. 65, each of the discharge ports 17A and 17B has a slit shape extending in the first direction. The discharge port 17A is constituted by the plate 213 and the one end of the plate 94 (i.e., the one end of the plate 94 in the third direction).

In the second direction, the discharge port 17B is positioned closer to the one end of the housing 20 in the second direction than the discharge port 17A is to the one end of the housing 20 in the second direction. The discharge port 17B is constituted by the one end of the plate 94 (i.e., the one end of the plate 94 in the third direction) and the one end of the plate 211 (i.e., the one end of the plate 211 in the third direction).

The housing 20 further includes a guide 78. Specifically, the guide 78 is disposed on the one end of the plate 21R (i.e., the one end of the plate 21R in the second direction). The guide 78 has a slit extending in the first direction. The tape 41 that has been discharged out of the arm 25 through the discharge port 17B is to be conveyed toward the slit in the guide 78. The guide 78 is configured to guide the tape 41 passing through the slit of the guide 78 toward the discharge channel 9 of the printer 1.

The housing 20 has an inlet port 55. Specifically, the inlet port 55 is positioned between the one end of the plate 21R (i.e., the one end of the plate 21R in the second direction) and the guide 78. The inlet port 55 has a slit through which the used ink ribbon 45 enters the housing 20 again.

In the following description, a space located further toward the one side in the third direction than the arm 25 will also be referred to as the head opening 29. That is, the head opening 29 is a space between the arm 25 and the guide 78, and is also a space between the arm 25 and the inlet port 55.

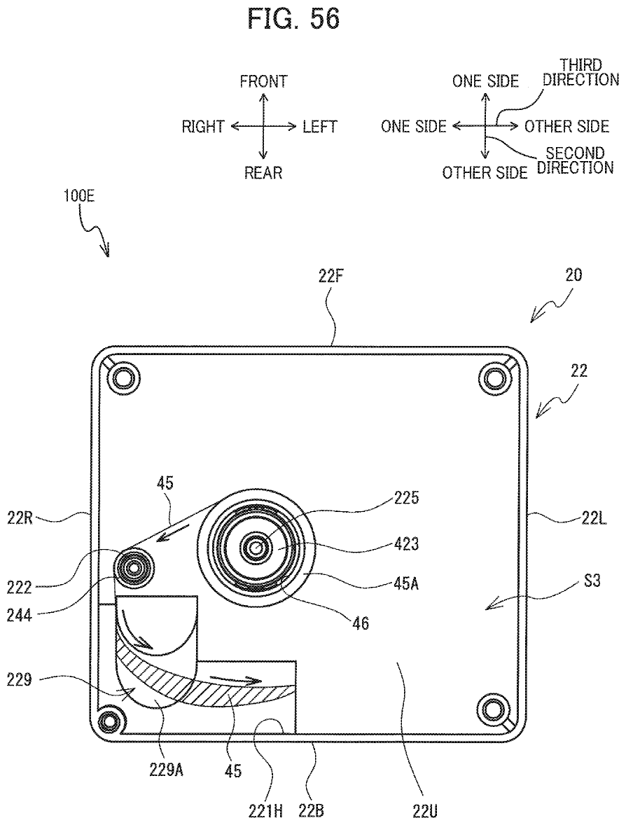

As illustrated in FIGS. 54 and 56, the case 22 includes a partition plate 22U and plates 22B, 22R, 22L, and 22F. Each of the partition plate 22U and the plates 22B, 22R, 22L, and 22F has a rectangular shape.

The partition plate 22U has plate surfaces which are orthogonal to the first direction. The partition plate 22U has an opening 221H. A ribbon guide 229 and shafts 26 through 28, 227, 225, and 222 are disposed on the partition plate 22U.

The opening 221H is located in the corner of the partition plate 22U on the other side in the second direction and on the one side in the third direction. The opening 221H extends through the partition plate 22U in the first direction. The opening 221H is in communication with the opening 211H illustrated in FIG. 55 in a state where the case 21 is coupled to the case 22.

The ribbon guide 229 and the shafts 26 through 28 and 227 extend toward the other side in the first direction from the partition plate 22U, while the shafts 225 and 222 extend toward the one side in the first direction from the partition plate 22U. That is, the shafts 225 and 222 extend in a direction opposite the direction in which the shafts 26 through 28 extend.

The ribbon guide 229 is disposed on the corner of the partition plate 22U on the other side in the second direction and on the one side in the third direction. The other end of the ribbon guide 229 in the first direction is connected to the opening 221H. The ribbon guide 229 has a sloped surface 229A, which is curved. The sloped surface 229A is sloped to extend toward the one side in the second direction as the sloped surface 229A extends toward the one side in the first direction. The ribbon guide 229 is configured to guide the conveyance of the ink ribbon 45. Specifically, the ink ribbon 45 is to be conveyed while contacting the sloped surface 229A of the ribbon guide 229.

The shaft 26 is disposed on the corner of the partition plate 22U on the one side in the second direction and on the one side in the third direction. The shaft 27 is disposed on a portion in the vicinity of the center of the partition plate 22U. The shaft 28 is disposed on the other side of the shaft 27 in the second direction and on the one side of the shaft 27 in the third direction. The position of the shaft 28 corresponds to the position of the opening 23H.

The shaft 227 is positioned offset from the center of the partition plate 22U in the third direction, more specifically, positioned on the other side of the center of the partition plate 22U in the third direction.

In the partition plate 22U, the shaft 225 is positioned in the vicinity of the center in the second direction and in the vicinity of the center in the third direction. Specifically, the shaft 225 is positioned away from the center of the partition plate 22U in the third direction, more specifically, positioned on the one side of the center of the partition plate 22U in the third direction.

In the partition plate 22U, the shaft 222 is positioned on the center in the second direction and on the one side in the third direction. Specifically, the shaft 222 is positioned between the shaft 225 and the plate 22R in the third direction. A roller 244 is fitted over the shaft 222.

The plate 22R is positioned at the one end of the partition plate 22U in the third direction. The plate 22R has plate surfaces which are orthogonal to the third direction. In the first direction, the partition plate 22U is positioned between the one end of the plate 22R in the first direction and the other end of the plate 22R in the first direction.

The plate 22B is positioned at the other end of the partition plate 22U in the second direction. The plate 22B has plate surfaces which are orthogonal to the second direction. In the first direction, the partition plate 22U is positioned between the one end of the plate 22B in the first direction and the other end of the plate 22B in the first direction.

The plate 22L is positioned at the other end of the partition plate 22U in the third direction. The plate 22L has plate surfaces which are orthogonal to the third direction. In the first direction, the partition plate 22U is positioned between the one end of the plate 22L in the first direction and the other end of the plate 22L in the first direction.

The plate 22F is positioned at the one end of the partition plate 22U in the second direction. The plate 22F has plate surfaces which are orthogonal to the second direction. In the first direction, the partition plate 22U is positioned between the one end of the plate 22F in the first direction and the other end of the plate 22F in the first direction.

The housing 20 also has an opening 16. More specifically, the opening 16 is positioned on the corner of the case 21 and the case 22 on the one side in the second direction and on the one side in the third direction.

As illustrated in FIG. 54, the case 24 includes plates 24U, 24R, 24B, 24L, and 24F. Each of the plates 24U, 24B, 24R, 24L, and 24F has a rectangular shape.

The plate 24U has plate surfaces which are orthogonal to the first direction. Shafts 243 and 249 are disposed on the plate 24U. The shafts 243 and 249 extend in the first direction from the plate 24U. The shaft 243 is positioned away from the center of the plate 24U in the third direction, more specifically, positioned further toward the one side in the third direction than the center of the plate 24U.

The shaft 249 is positioned away from the shaft 243 in the third direction, more specifically, positioned further toward the one side in the third direction than the shaft 243. The shaft 243 is inserted in the roller 244.

The plate 24R is positioned at the one end of the plate 24U in the third direction. The plate 24B is positioned at the other end of the plate 24U in the second direction. The plate 24L is positioned at the other end of the plate 24U in the third direction. The plate 24F is positioned at the one end of the plate 24U in the second direction.

The plates 24R, 24B, 24L, and 24F extend toward the other side in the first direction from the plate 24U.

The partition plate 21M partitions the internal space of the housing 20 into a first space S1 and a second space S2 in the first direction.

The first space S1 is a space enclosed by the partition plate 21M and the plates 21F, 21B, 21L, and 21R of the case 21, the plates 22F, 22B, 22L, and 22R of the case 22, and the plates 24U, 24F, 24B, 24L, and 24R of the case 24.

The second space S2 is a space enclosed by the partition plate 21M and the plates 21F, 21B, 21L, and 21R of the case 21 and the plates 23D, 23F, 23B, 23L, and 23R of the case 23.

The first space S1 and the second space S2 are arranged in the first direction. The first space S1 is located on the one side of the second space S2 in the first direction. The arm 25 defines the one end of the second space S2 in the second direction. The opening 23H is in communication with the second space S2.

The partition plate 22U partitions the first space S1 into a third space S3 and a fourth space S4 in the first direction. The third space S3 and the fourth space S4 are arranged in the first direction. The third space S3 is positioned on the one side of the fourth space S4 in the first direction.

The third space S3 is a space enclosed by the plates 24U, 24F, 24B, 24L, and 24R of the case 24 and the partition plate 22U and the plates 22F, 22B, 22L, and 22R of the case 22.

The fourth space S4 is a space enclosed by the partition plate 22U and the plates 22F, 22B, 22L, and 22R of the case 22 and the partition plate 21M and the plates 21F, 21B, 21L, and 21R of the case 21.

As illustrated in FIGS. 56 and 59 through 62, the ribbon roll 45A and the gears 30 are positioned in the first space S1 in the tape cassette 100E.

Specifically, the ribbon roll 45A is positioned in the third space S3.

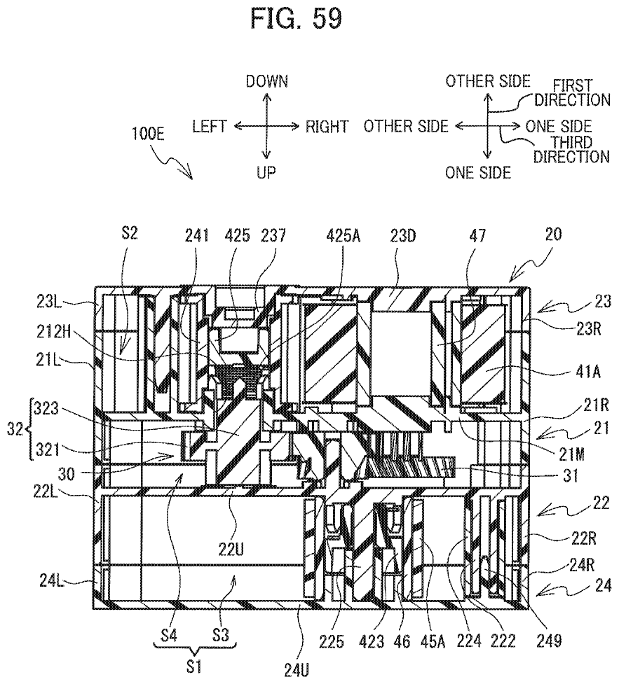

As illustrated in FIGS. 56 and 59, in the third space S3, the ribbon roll 45A is positioned offset from the center of the partition plate 22U in the third direction, specifically, positioned further toward the one side in the third direction than the center of the partition plate 21M. More specifically, in the third space S3, the ribbon roll 45A is positioned between the center of the partition plate 22U and the plate 22R in the third direction.

A holder 423 is fitted inside the ribbon spool 46. The shaft 243 is fitted inside the holder 423. The shaft 225 is inserted in the holder 423. The shaft 225 has the rotation axis L23 extending in the first direction. With this configuration, the ribbon spool 46 is rotatable about the rotation axis L23.

The gears 30 are positioned in the fourth space S4. The gears 30 are configured to transmit a drive force transmitted through the transmission gear 679 on the shaft 66E of the drive shaft 63 to the platen roller 82.

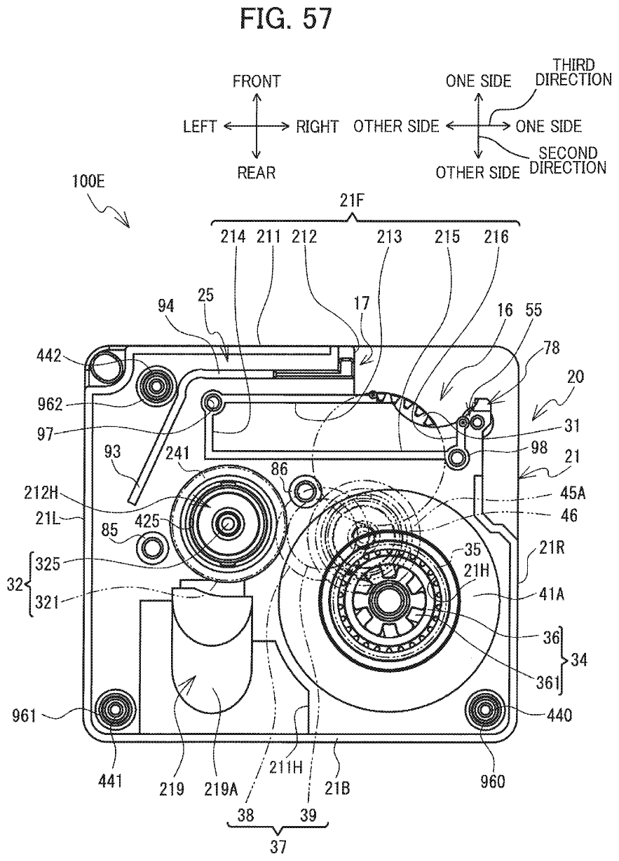

As illustrated in FIGS. 54 and 57, the gears 30 include gears 34, 31, 37, and 32. The gear 34 is fitted over the shaft 28. The gear 31 is fitted over the shaft 26. The gear 37 is fitted over the shaft 27. The shaft 227 is inserted through the gear 32.

The gear 34 is rotatable about the shaft 28. The position of the gear 34 in the second direction and in the third direction is the same as the positions of the openings 23H and 21H in the second direction and in the third direction.

The gear 34 is coupled to the gear 31 through the gear 37. The gear 34 is configured to transmit a drive force to the gear 31. The gear 34 includes a gear 35 and a cam 36. The gear 35 is an external gear that is in meshing engagement with a gear 38 of the gear 37. The gear 35 is coupled to the cam 36.

The cam 36 is fixed to the gear 35 in the first direction. The cam 36 extends toward the other side in the first direction from the gear 35. The cam 36 is an internal gear having a hollow cylindrical shape. Specifically, the cam 36 has splines 361 on the inner circumferential surface of the cam 36. The shaft 66E of the drive shaft 63 is configured to be inserted into the cam 36 from the other side in the first direction.

A part of the cam 36 is inserted in the second space S2 from the fourth space S4. The cam 36 is exposed to the outside of the housing 20 through the opening 23H. Note that “the cam 36 is exposed” denotes a state in which the cam 36 is visible by the user.

The gear 31 is an external gear. The gear 31 is rotatable about the shaft 26 extending in the first direction. The gear 31 is positioned further toward the one side in the second direction than the gear 34 to be spaced apart from the gear 34.

The gear 31 is configured to transmit, to the platen gear 83, a drive force for conveying the tape 41. The gear 31 is so-called a helical gear. The gear teeth of the gear 31 are helical (i.e., skewed) relative to the first direction at a predetermined angle. The gear teeth on the gear 31 are of the opposite hand to the gear teeth on the platen gear 83.

In a state where the tape cassette 100E is attached to the cassette attachment portion 10, the gear 31 meshes with the platen gear 83 in the space in communication with the head opening 29.

A part of the gear 31 is exposed to the outside of the housing 20 through the opening 16. That is, a part of the gear 31 is exposed to the space in communication with the head opening 29. Note that the phrase “the gear 31 is exposed” denotes a state in which the gear 31 is visible by the user.

The gear 37 is in meshing engagement with both the gear 31 and the gear 34. The gear 37 is configured to transmit a drive force inputted into the gear 34 to the gear 31.

Specifically, the gear 37 is configured to transmit a drive force inputted into the gear 34 to the gear 31 while reducing a rotational speed of the drive force. That is, the gears 30 include a reduction mechanism.

The gear 37 is a double gear including the gear 38 and a gear 39. The gears 38 and 39 are arranged side by side and coaxial with each other. The diameter of the gear 39 is smaller than the diameter of the gear 38. In the first direction, the gear 38 is positioned closer to the tape roll 41A than the gear 39 is to the tape roll 41A.

The gear 38 is in meshing engagement with the gear 34. The gear 38 is an external spur gear.

The gear 39 is in meshing engagement with the gear 31. The gear 39 is an external helical gear. The gear 39 has gear teeth which are of the opposite hand to the gear teeth on the gear 31.

The gear 32 includes a gear 321, a cam 323, and a shaft 325. The gear 321 is in meshing engagement with the gear 38. The cam 323 extends toward the other side in the first direction from the gear 321. The one end portion of the cam 323 in the first direction has a plurality of recessed portions. The shaft 325 extends toward the other side in the first direction from the center of the gear 321.

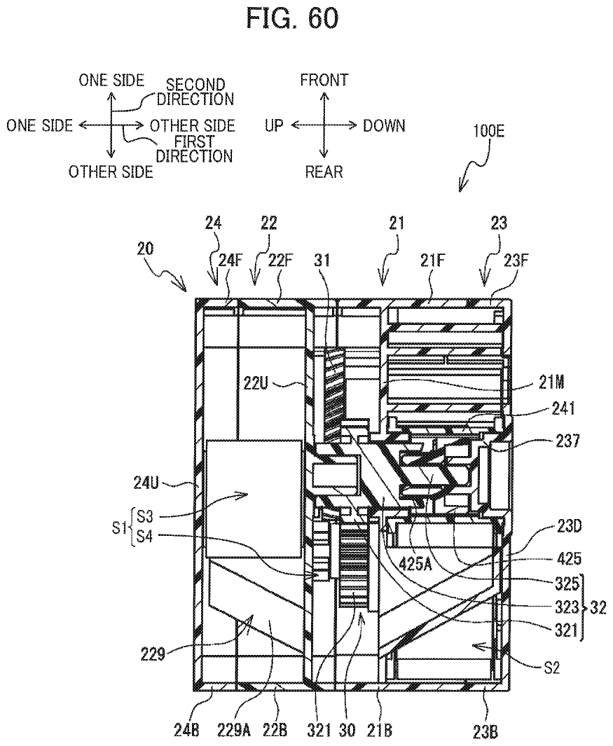

As illustrated in FIG. 60, a part of the gear 32 (i.e., the cam 323 and the shaft 325) is inserted in the second space S2 from the fourth space S4 through the opening 212H illustrated in FIG. 54.

The tape roll 41A, the take-up spool 241, the discharge ports 17A and 17B, and the inlet port 55 are positioned in the second space S2 in the tape cassette 100E.

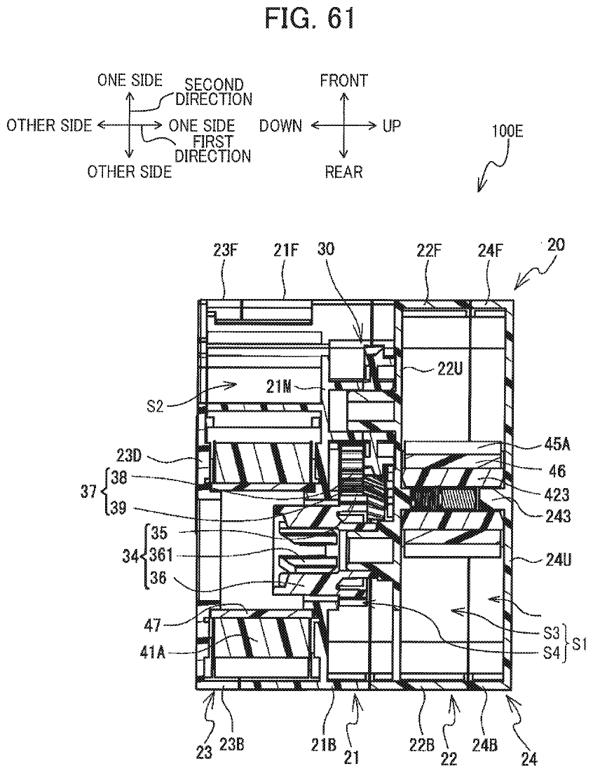

As illustrated in FIGS. 59 and 61, in the second space S2, the tape roll 41A is disposed on the corner of the partition plate 21M on the other side in the second direction and on the one side in the third direction. The cam 36 is fitted inside the tape spool 47. The drive cam 67 is configured to be inserted in the tape spool 47. The drive cam 67 has the rotation axis L1 extending in the first direction. Accordingly, the tape spool 47 is rotatable about the rotation axis L1.

As illustrated in FIGS. 59 and 60, in the second space S2, the take-up spool 241 is positioned on the center in the second direction and on the other side in the third direction. The cam 323 of the gear 32 is fitted inside the take-up spool 241. A holder 425 is fitted inside the cam 323. The shaft 237 is fitted inside the holder 425.

The shaft 325 of the gear 32 is also fitted inside the holder 425. The shaft 325 and the shaft 237 have a rotation axis L4 extending in the first direction. Accordingly, the take-up spool 241 is rotatable about the rotation axis L4.

A clutch spring 425A is mounted on the other end portion of the holder 425 in the first direction. Each of the two arms of the clutch spring 425A is fitted in one of the recessed portions of the cam 323. A drive force due to the rotation of the gear 321 is to be transmitted to the take-up spool 241 through the clutch spring 425A.

In the second space S2, the discharge port 17A is positioned at the one end of the arm 25 (i.e., the one end of the arm 25 in the third direction). The discharge port 17A allows the ink ribbon 45 to be discharged from the second space S2 through the discharge port 17A.

In the second space S2, the discharge port 17B is also positioned at the one end of the arm 25 (i.e., the one end of the arm 25 in the third direction). The discharge port 17B allows the tape 41 to be discharged from the second space S2 through the discharge port 17B.

The discharge port 17A is positioned between the discharge port 17B and the ribbon roll 45A in the second direction. The discharge port 17A is positioned between the discharge port 17B and the take-up spool 241 in the second direction.

In the second space S2, the inlet port 55 is located in the corner on the one side in the second direction and on the one side in the third direction. The inlet port 55 allows the ink ribbon 45 to enter the third space S3 again through the inlet port 55.

Next, the positional relationship among the components in the tape cassette 100E will be described with reference to FIG. 57. In the following description, the phrase “a component overlaps another component” denotes that at least a part of the component overlaps at least a part of the other component when viewed from the one side or the other side in the corresponding direction. Further, the phrase “a component does not overlap another component” denotes that the component does not overlap the other component when viewed from the one side or the other side in the corresponding direction. These phrases do not denote that the component and the other component are physically in contact with each other.

A part of the ribbon roll 45A overlaps a part of the tape roll 41A in the first direction. The ribbon roll 45A does not overlap the take-up spool 241 in the first direction. The ribbon roll 45A does not overlap either the take-up spool 241 or the tape roll 41A in the second direction. The ribbon roll 45A does not overlap either the take-up spool 241 or the tape roll 41A in the third direction.

The take-up spool 241 does not overlap either the tape roll 41A or the ribbon roll 45A in the first direction. In the first direction, the one end of the take-up spool 241 in the first direction is spaced apart from the other end of the ribbon roll 45A in the first direction. The take-up spool 241 does not overlap the ribbon roll 45A in the second direction. The take-up spool 241 does not overlap the ribbon roll 45A in the third direction. A part of the take-up spool 241 overlaps a part of the tape roll 41A in the third direction.

A part of the gear 34 overlaps a part of the ribbon roll 45A in the first direction. A part of the gear 34 (i.e., the gear 35) does not overlap any of the tape roll 41A, the ribbon roll 45A, or the take-up spool 241 in the second direction. Further, a part of the gear 34 (i.e., the gear 35) does not overlap any of the tape roll 41A, the ribbon roll 45A, or the take-up spool 241 in the third direction. A part of the gear 34 (i.e., the cam 36) overlaps the take-up spool 241 in the second direction. Further, a part of the gear 34 (i.e., the cam 36) overlaps the take-up spool 241 in the third direction.

A part of the gear 37 overlaps a part of the tape roll 41A in the first direction. A part of the gear 37 overlaps a part of the ribbon roll 45A in the first direction. The gear 37 does not overlap any of the tape roll 41A, the ribbon roll 45A, or the take-up spool 241 in the second direction. The gear 37 does not overlap any of the tape roll 41A, the ribbon roll 45A, or the take-up spool 241 in the third direction.

A part of the gear 31 overlaps a part of the tape roll 41A in the first direction. A part of the gear 31 overlaps a part of the ribbon roll 45A in the first direction. The gear 31 does not overlap the take-up spool 241 in the first direction. The gear 31 does not overlap any of the tape roll 41A, the ribbon roll 45A, or the take-up spool 241 in the second direction. The gear 31 does not overlap any of the tape roll 41A, the ribbon roll 45A, or the take-up spool 241 in the third direction.

The gear 32 overlaps the take-up spool 241 in the first direction. The gear 32 does not overlap either the tape roll 41A or the ink ribbon 45 in the first direction. A part of the gear 32 (i.e., the gear 321) does not overlap any of the tape roll 41A, the ribbon roll 45A, or the take-up spool 241 in the second direction. Also, a part of the gear 32 (i.e., the gear 321) does not overlap any of the tape roll 41A, the ribbon roll 45A, or the take-up spool 241 in the third direction. A part of the gear 32 (i.e., the cam 323) overlaps both the take-up spool 241 and the tape roll 41A in the second direction. Also, a part of the gear 32 (i.e., the cam 323) overlaps both the take-up spool 241 and the tape roll 41A in the third direction.

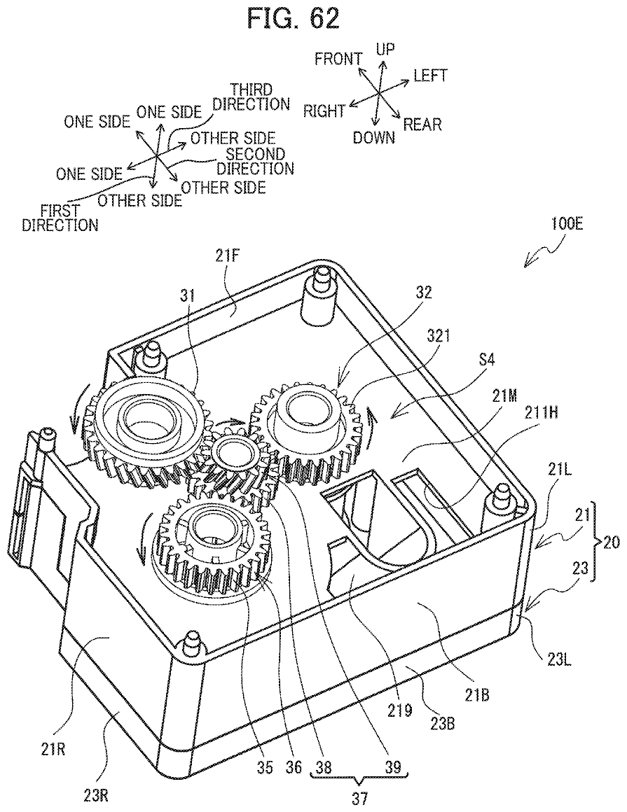

Next, the printing operations performed with the printer 1 and the tape cassette 100E will be described with reference to FIGS. 62 through 65. The user attaches the tape cassette 100E to the cassette attachment portion 10, thereby positioning the print head 71 in the head opening 29 at a position in which the print head 71 overlaps both the tape 41 and the ink ribbon 45 in the second direction.

The shaft 66E of the drive shaft 63 is inserted in the cam 36 of the gear 34 positioned in the fourth space S4. The platen roller 82 is moved to the adjacent position. As a result, the platen gear 83 is brought into meshing engagement with the gear 31.

As illustrated in FIG. 62, in a state where the tape cassette 100E is attached to the cassette attachment portion 10, the gear 34 is rotated together with the cam 36 due to the shaft 66E of the drive shaft 63. The gear 37 is also rotated in accordance with the rotation of the gear 34. The gear 31 is also rotated in accordance with the rotation of the gear 37. The platen gear 83 is also rotated in accordance with the rotation of the gear 31, thereby rotating the platen roller 82.

As illustrated in FIGS. 62 and 65, the tape 41 is drawn off the tape roll 41A in the second space S2 due to the rotation of the platen roller 82. At the same time, the ink ribbon 45 is drawn off the ribbon roll 45A in the first space S1 due to the rotation of the take-up spool 241.

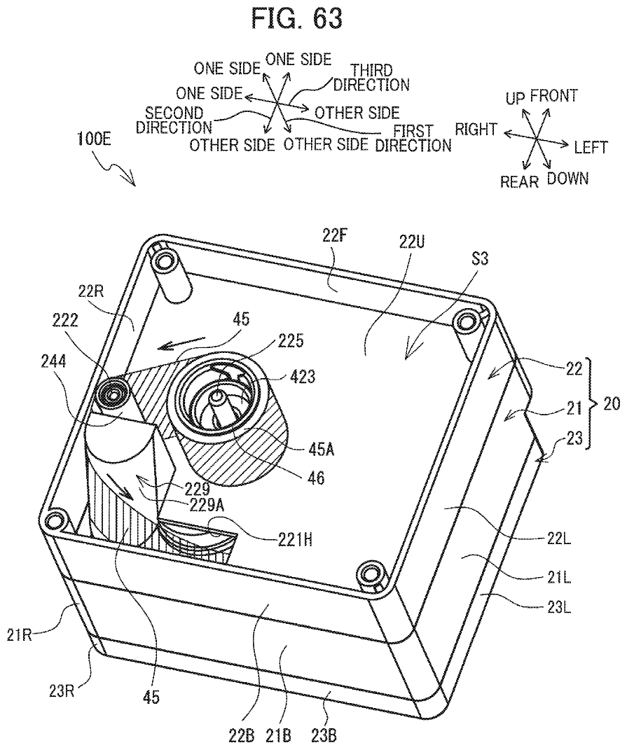

As illustrated in FIG. 63, in the third space S3, the ink ribbon 45 is conveyed toward the shaft 222. The ink ribbon 45 that has moved past the shaft 222 reaches the ribbon guide 229.

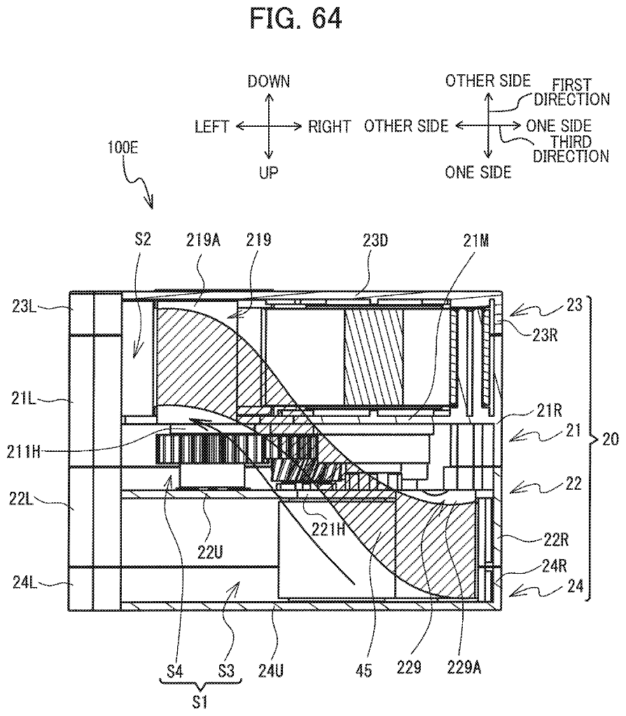

As illustrated in FIG. 64, in the third space S3, the ink ribbon 45 is guided by the ribbon guide 229. The conveying direction of the ink ribbon 45 is changed by the sloped surface 229A of the ribbon guide 229, whereby the ink ribbon 45 is conveyed toward the other side in the first direction and the other side in the third direction. That is, the ink ribbon 45 is conveyed from the first space S1 to the second space S2.

Then, the ink ribbon 45 reaches the ribbon guide 219 in the second space S2. The ink ribbon 45 is conveyed along the sloped surface 219A of the ribbon guide 219. The conveying direction of the ink ribbon 45 is further changed by the sloped surface 219A of the ribbon guide 219. The ribbon guide 219 causes the ink ribbon 45 to be conveyed toward the one side in the second direction.

As illustrated in FIG. 65, the ink ribbon 45 is conveyed toward the one side in the second direction through the gap between the plate 214 and the plate 93. The ink ribbon 45 reaches the guide 97 after moving past the guide 85. The ink ribbon 45 is conveyed toward the one side in the third direction through the gap between the plate 94 and the plate 213. The ink ribbon 45 is guided toward the discharge port 17A by the end portion of the plate 94, and is then discharged to the outside of the housing 20, i.e., an outside of the second space S2, through the discharge port 17A.

As illustrated in FIG. 65, in the second space S2, the tape 41 is conveyed toward the other side in the second direction, i.e., toward the tape guide 440. After moving past the tape guide 440, the tape 41 is further conveyed toward the other side in the third direction, i.e., toward the tape guide 441. At this time, the tape 41 is conveyed along the plate 21B.

The tape guide 441 causes the tape 41 to be further conveyed toward the one side in the second direction, i.e., toward the tape guide 442. At this time, the tape 41 is conveyed through the gap between the plate 21L and the plate 93.

The tape 41 is guided by the tape guide 442 toward the discharge port 17B. At this time, the tape 41 is conveyed toward the one side in the third direction through the gap between the plate 211 and the plate 94. Then, the tape 41 is discharged through the discharge port 17B to the outside of the housing 20, i.e., the outside of the second space S2.

The tape 41 and the ink ribbon 45 which have been discharged through the discharge port 17 are conveyed toward the head opening 29. The platen roller 82 presses the tape 41 against the print head 71 through the ink ribbon 45 in the head opening 29. At this time, selected one or more heating elements 71A are heated in the print head 71, whereby some of the ink contained in the surface of the ink ribbon 45 is transferred to the tape 41. As a result, characters or symbols are printed on the tape 41.

The tape 41 on which printing has been performed is guided toward the discharge channel 9 in the printer 1 by the guide 78. That is, the tape 41 that has been discharged through the discharge port 17B does not return to an inside of the housing 20.

In the meantime, in the second space S2, the cam 323 is rotated together with the rotation of the gear 32. Since the clutch spring 425A is disposed between the cam 323 and the holder 425, the holder 425 is also rotated, thereby rotating the take-up spool 241 together with the holder 425.

In accordance with the rotation of the take-up spool 241, the used ink ribbon 45 is conveyed toward the inlet port 55. While guided by the inlet port 55, the ink ribbon 45 is conveyed toward the second space S2 again.

In the second space S2, the ink ribbon 45 moves past the guides 98 and 86 to be conveyed toward the take-up spool 241. The ink ribbon 45 is finally taken up by the take-up spool 241.

Once the printing operation has been completed, the user cuts off the printed tape 41 from the printer 1.

As described above, the tape spool 47 is positioned in the housing 20. The tape roll 41A is mounted on the tape spool 47. The ribbon spool 46 is positioned in the housing 20. The ribbon roll 45A is mounted on the ribbon spool 46. The discharge port 17A is positioned in the second space S2 (more specifically, in the plate 21F that defines the second space S2). The discharge port 17A allows the ink ribbon 45 to be discharged to the outside of the housing 20. The inlet port 55 is also positioned in the second space S2 (more specifically, in the plate 21F that defines the second space S2). The inlet port 55 allows the ink ribbon 45 to enter the housing 20. The ribbon guides 219 and 229 are positioned for guiding the ink ribbon 45 during the conveyance of the ink ribbon 45 from the first space S1 toward the second space S2. The ribbon guide 229 is positioned in the first space S1, while the ribbon guide 219 is positioned in the second space S2. The ribbon spool 46 is positioned in the first space S1. The tape roll 41A and the tape spool 47 are positioned in the second space S2. The ink ribbon 45 drawn off the ribbon roll 45A is conveyed along the ribbon guides 229 and 219 and conveyed through the discharge port 17A and the inlet port 55, in order, and is taken up by the take-up spool 241. That is, in the conveying direction in which the ink ribbon 45 drawn off the ribbon roll 45A is conveyed from the ribbon roll 45A to the take-up spool 241, the ribbon roll 45A, the ribbon guides 229 and 219, the discharge port 17A, the inlet port 55, and the take-up spool 241 are arranged in order from upstream to downstream. In the tape cassette 100E, the components can be appropriately arranged in this way.

The discharge port 17B is positioned in the second space S2 (more specifically, in the plate 21F that defines the second space S2). The discharge port 17B allows the tape 41 to be discharged to the outside of the housing 20. The tape guides 440 through 442 are positioned in the second space S2. The tape guides 440 through 442 are positioned for guiding the tape 41 during the conveyance of the tape 41. The tape 41 drawn off the tape roll 41A is conveyed along the tape guides 440 through 442, in order, and conveyed to the discharge port 17B. That is, in the conveying direction in which the tape 41 drawn off the tape roll 41A is conveyed from the tape roll 41A to the discharge port 17B, the tape roll 41A, the tape guides 440 through 442, and the discharge port 17B are arranged in order from upstream to downstream. In the tape cassette 100E, the tape 41 drawn off the tape roll 41A can be conveyed along the tape guides 440 through 442, in order, and conveyed to the discharge port 17B.

The take-up spool 241 does not overlap the ribbon roll 45A in the first direction. The take-up spool 241 does not overlap the ribbon roll 45A in the second direction orthogonal to the first direction. The take-up spool 241 and the ribbon roll 45A can be arranged to be offset from each other in the tape cassette 100E.

The take-up spool 241 does not overlap the tape roll 41A in the first direction. The take-up spool 241 does not overlap the ribbon roll 45A in the second direction orthogonal to the first direction. The take-up spool 241, the tape roll 41A, and the ribbon roll 45A can be arranged to be offset from one another in the tape cassette 100E.

The partition plate 22U partitions the first space S1 into the third space S3 and the fourth space S4 in the first direction. The ribbon roll 45A is positioned in the third space S3. The gears 30 are positioned in the fourth space S4. In the tape cassette 100E, the ribbon roll 45A can be arranged in the third space S3, and the gears 30 can be arranged in the fourth space S4.

The gears 30 include the gear 31. A part of the gear 31 is exposed to the outside of the housing 20. The tape cassette 100E can expose the gear 31 to the outside of the housing 20.

The gear 31 overlaps the ribbon roll 45A in the first direction. The tape cassette 100E enables the gear 31 and the ribbon roll 45A to be arranged to overlap each other in the first direction.

The gears 30 include the gear 32 coupled to the take-up spool 241. The tape cassette 100E can drive the take-up spool 241 using the gear 32.

The gear 32 overlaps the take-up spool 241 in the first direction. The tape cassette 100E enables the gear 32 and the take-up spool 241 to be arranged to overlap each other in the first direction.

The gears 30 include the gear 37 in engagement with the gear 31. The tape cassette 100E can accommodate not only the gears 31 and 32 but also the gear 37.

The gear 37 overlaps the ribbon roll 45A in the first direction. The tape cassette 100E enables the gear 37 and the ribbon roll 45A to be arranged to overlap each other in the first direction.

The gear 37 overlaps the tape roll 41A in the first direction. The tape cassette 100E enables the gear 37 and the tape roll 41A to be arranged to overlap each other in the first direction.

The gears 30 include the gear 34 for receiving a drive force. The tape cassette 100E can accommodate the gear 34.

In this modification, the rotation axis L23 is an example of the “axis”. The partition plate 21M is an example of the “first partition plate”. The partition plate 22U is an example of the “second partition plate”. The surfaces of the plate 24U are an example of the “first surface”. The surfaces of the plate 23D are an example of the “second surface”. The case 24 is an example of the “first case”. The case 23 is an example of the “second case”. The plate 21F is an example of the “wall defining the second space”. The ribbon guide 229 is an example of the “first ribbon guide”. The ribbon guide 219 is an example of the “second ribbon guide”. The discharge port 17A is an example of the “first discharge port”. The discharge port 17A is also an example of the “discharge port”. The discharge port 17B is an example of the “second discharge port”. The inlet port 55 is an example of the “inlet port”. The gears 30, 31, 32, 37, and 34 are each an example of the “gear”.

As described above, in each of the tape cassettes 100A and 100E, the ribbon roll 45A and the take-up spool 241 are spaced apart from each other in the first direction. That is, each of the tape cassettes 100A and 100E enables the ribbon roll 45A and the take-up spool 241 to be positioned spaced apart from each other in the direction in which the rotation axis L23 of the ribbon roll 45A extends.

In the tape cassette 100B, the roll 411 and the take-up spool 241 are spaced apart from each other in the first direction. The tape cassette 100B enables the roll 411 and the take-up spool 241 to be arranged to be spaced apart from each other in the direction in which the rotation axis L231 of the roll 411 extends.

In the tape cassette 100C, the ribbon roll 45A and the take-up spool 218 are spaced apart from each other in the first direction. The tape cassette 100C enables the ribbon roll 45A and the take-up spool 218 to be positioned spaced apart from each other in the direction in which the rotation axis L23 of the ribbon roll 45A extends.

In the tape cassette 100D, the roll 411 and the take-up spool 218 are spaced apart from each other in the first direction. The tape cassette 100D enables the roll 411 and the take-up spool 218 to be arranged spaced apart from each other in the direction in which the rotation axis L231 of the roll 411 extends.

In each of the tape cassettes 100A and 100E, the ribbon roll 45A is positioned in the first space S1. The take-up spool 241 is positioned in the second space S2. Each of the tape cassettes 100A and 100E enables the ribbon roll 45A and the take-up spool 241 to be positioned in different spaces. Accordingly, each of the tape cassettes 100A and 100E enables the ribbon roll 45A and the take-up spool 241 to be positioned spaced apart from each other in the direction in which the rotation axis L23 of the ribbon roll 45A extends.

In the tape cassette 100C, the ribbon roll 45A is positioned in the first space S1. The take-up spool 218 is positioned in the second space S2. The tape cassette 100C enables the ribbon roll 45A and the take-up spool 218 to be positioned in different spaces. Accordingly, the tape cassette 100C enables the ribbon roll 45A and the take-up spool 218 to be positioned spaced apart from each other in the direction in which the rotation axis L23 of the ribbon roll 45A extends.

In the tape cassette 100B, the roll 411 is positioned in the first space S1, and the take-up spool 241 is positioned in the second space S2. The tape cassette 100B enables the roll 411 and the take-up spool 241 to be positioned in different spaces. Accordingly, the tape cassette 100B enables the roll 411 and the take-up spool 241 to be positioned spaced apart from each other in the direction in which the rotation axis L231 of the roll 411 extends.

In the tape cassette 100D, the roll 411 is positioned in the first space S1. The take-up spool 218 is positioned in the second space S2. The tape cassette 100D enables the roll 411 and the take-up spool 218 to be positioned in different spaces. Accordingly, the tape cassette 100D enables the roll 411 and the take-up spool 218 to be positioned spaced apart from each other in the direction in which the rotation axis L231 of the roll 411 extends.

In each of the tape cassettes 100A and 100B, the plate 23D and the plate 24U are spaced apart from each other in the first direction. That is, the surfaces of the plate 23D and the surfaces of the plate 24U are spaced apart from each other in the first direction. The partition plate 22U is positioned between the surfaces of the plate 23D and the surfaces of the plate 24U in the first direction. The first space S1 is located between the surfaces of the plate 23D and the partition plate 22U in the first direction. The second space S2 is located between the surfaces of the plate 24U of the partition plate 22U in the first direction. Each of the tape cassettes 100A and 100B enables the first space S1 and the second space S2 to be spaced apart from each other in the first direction.

In each of the tape cassettes 100C through 100E, the plate 24U and the plate 23D are spaced apart from each other in the first direction. That is, the surfaces of the plate 24U and the surfaces of the plate 23D are spaced apart from each other in the first direction. The partition plate 21M is positioned between the surfaces of the plate 24U and the surfaces of the plate 23D in the first direction. The first space S1 is located between the surfaces of the plate 24U and the partition plate 21M in the first direction. The second space S2 is located between the surfaces of the plate 23D of the partition plate 21M in the first direction. Each of the tape cassettes 100C through 100E enables the first space S1 and the second space S2 to be spaced apart from each other in the first direction.

In each of the tape cassettes 100A through 100E, the housing 20 includes the cases 23 and 24. The case 23 and the case 24 are spaced apart from each other in the first direction. The case 23 has the surfaces of the plate 23D. The case 24 has the surfaces of the plate 24U. Each of the tape cassettes 100A through 100E can define spaces using the surfaces of the plate 23D and the surfaces of the plate 24U.

In each of the tape cassettes 100A through 100D, the tape roll 41A or the roll 411 is positioned in the first space S1. Each of the tape cassettes 100A through 100D enables the tape roll 41A or the roll 411 to be arranged in the first space S1.

In the tape cassette 100E, the tape roll 41A is positioned in the second space S2. The tape cassette 100E enables the tape roll 41A to be positioned in the second space S2.

In each of the tape cassettes 100A through 100C and 100E, the discharge port 17A allows the ink ribbon 45 to be discharged to the outside of the housing 20. Each of the tape cassettes 100A through 100C and 100E enables the ink ribbon 45 to be discharged out through the discharge port 17A.

In the tape cassettes 100D, the discharge port 17B allows the ink ribbon 45 to be discharged to the outside of the housing 20. The tape cassettes 100D enables the ink ribbon 45 to be discharged out through the discharge port 17B.

In each of the tape cassettes 100A through 100E, the discharge port 17A is a part of the housing 20 defines an opening. Each of the tape cassettes 100A through 100E allows the ink ribbon 45 to be discharged out of the housing 20 using a part of the housing 20.

In each of the tape cassettes 100A and 100B, the discharge port 17A is positioned in in the first space S1 (more specifically, in the plate 21F that defines the first space S1). The discharge port 17A allows the ink ribbon 45 to be discharged out of the housing 20. Each of the tape cassettes 100A and 100B enables the ink ribbon 45 to be discharged out of the housing 20 through the first space S1.

In each of the tape cassettes 100C and 100E, the discharge port 17A is positioned in the second space S2 (more specifically, in the plate 21F that defines the second space S2). The discharge port 17A allows the ink ribbon 45 to be discharged out of the housing 20. In each of the tape cassettes 100C and 100E, the ink ribbon 45 can be discharged out of the housing 20 through the second space S2.

In the tape cassette 100D, the discharge port 17B is positioned in the second space S2 (more specifically, in the plate 21F that defines the second space S2). The discharge port 17B allows the ink ribbon 45 to be discharged out of the housing 20. In the tape cassette 100D, the ink ribbon 45 can be discharged out of the housing 20 through the second space S2.

In each of the tape cassettes 100A through 100C and 100E, the discharge port 17B is different from the discharge port 17A. The discharge port 17B allows the tape 41 to be discharged to the outside of the housing 20. In each of the tape cassettes 100A through 100C and 100E, the tape 41 can be discharged out of the housing 20 through the discharge port 17B independently of the ink ribbon 45.

In each of the tape cassettes 100A through 100C and 100E, the discharge port 17A is positioned between the discharge port 17B and the ribbon roll 45A or the roll 411 in the second direction orthogonal to the first direction. Each of the tape cassettes 100A through 100C and 100E enables the components to be properly arranged in the corresponding one of the tape cassettes 100A through 100C and 100E.

In each of the tape cassettes 100C through 100E, the discharge port 17A is positioned between the discharge port 17B and the take-up spool 241 or the take-up spool 218 in the second direction orthogonal to the first direction. Each of the tape cassettes 100C through 100E enables the discharge port 17A to be located between the discharge port 17B and the take-up spool 241 or the take-up spool 218.

In each of the tape cassette 100C illustrated in FIG. 41 and the tape cassette 100D, the discharge port 17B allows not only the tape 41 but also the ink ribbon 45 to be discharged to the outside of the housing 20. Each of the tape cassette 100C illustrated in FIG. 41 and the tape cassette 100D does not need to provide the discharge port 17A for the ink ribbon 45.

In each of the tape cassettes 100B and 100D, the ribbon roll 45A and the tape roll 41A constitute the single roll 411 in which the tape 41 and the ink ribbon 45 are wound together in an overlaid state. The roll 411 is rotatable about the axis 231. Each of the tape cassettes 100B and 100D can accommodate the tape 41 and the ink ribbon 45 with the tape 41 and the ink ribbon 45 overlaid on each other.

In each of the tape cassettes 100A, 100C, and 100E, the tape spool 47 is positioned in the housing 20. The tape roll 41A is mounted on the tape spool 47. The ribbon spool 46 is positioned in the housing 20. The ribbon roll 45A is mounted on the ribbon spool 46. Each of the tape cassettes 100A, 100C, and 100E can accommodate the tape roll 41A and the ribbon roll 45A, which are separate components from each other.

In each of the tape cassettes 100A and 100E, the ribbon spool 46 and the take-up spool 241 are spaced apart from each other in the first direction. Each of the tape cassettes 100A and 100E enables the ribbon spool 46 and the take-up spool 241 to be arranged spaced apart from each other in the first direction.

In the tape cassette 100B, the spool 471 and the take-up spool 241 are spaced apart from each other in the first direction. The tape cassette 100B enables the spool 471 and the take-up spool 241 to be arranged spaced apart from each other in the first direction.

In the tape cassette 100C, the ribbon spool 46 and the take-up spool 218 are spaced apart from each other in the first direction. The tape cassette 100C enables the ribbon spool 46 and the take-up spool 218 to be arranged spaced apart from each other in the first direction.

In the tape cassette 100D, the spool 471 and the take-up spool 218 are spaced apart from each other in the first direction. The tape cassette 100D enables the spool 471 and the take-up spool 218 to be arranged spaced apart from each other in the first direction.

In each of the tape cassettes 100A and 100B, the ribbon guides 219 and 229 are positioned for guiding the ink ribbon 45 during the conveyance of the ink ribbon 45 from the first space S1 toward the second space S2. The ink ribbon 45 drawn off the ribbon roll 45A or the roll 411 in the first space S1 is conveyed along the ribbon guides 219 and 229, in order, and is taken up by the take-up spool 241 in the second space S2.

That is, in the conveying direction in which the ink ribbon 45 drawn off the ribbon roll 45A is conveyed from the ribbon roll 45A to the take-up spool 241 in the tape cassette 100A, the ribbon roll 45A, the ribbon guides 219 and 229, and the take-up spool 241 are arranged in order from upstream to downstream. Similarly, in the conveying direction in which the ink ribbon 45 drawn off the roll 411 is conveyed from the roll 411 to the take-up spool 241 in the tape cassette 100B, the roll 411, the ribbon guides 219 and 229, and the take-up spool 241 are arranged in order from upstream to downstream. In each of the tape cassettes 100A and 100B, the ink ribbon 45 can be stably conveyed from the first space S1 to the second space S2 using the ribbon guides 219 and 229.

In each of the tape cassettes 100C through 100E, the ribbon guides 229 and 219 are positioned for guiding the ink ribbon 45 during the conveyance of the ink ribbon 45 from the first space S1 toward the second space S2. The ink ribbon 45 drawn off the ribbon roll 45A or the roll 411 in the first space S1 is conveyed along the ribbon guides 229 and 219, in order, and is taken up by the take-up spool 218 or the take-up spool 241 in the second space S2.

That is, in the conveying direction in which the ink ribbon 45 drawn off the ribbon roll 45A is conveyed from the ribbon roll 45A to the take-up spool 218 in the tape cassette 100C, the ribbon roll 45A, the ribbon guides 229 and 219, and the take-up spool 218 are arranged in order from upstream to downstream. Similarly, in the conveying direction in which the ink ribbon 45 drawn off the roll 411 is conveyed from the roll 411 to the take-up spool 218 in the tape cassette 100D, the roll 411, the ribbon guides 229 and 219, and the take-up spool 218 are arranged in order from upstream to downstream. Similarly, in the conveying direction in which the ink ribbon 45 drawn off the ribbon roll 45A is conveyed from the ribbon roll 45A to the take-up spool 241 in the tape cassette 100E, the ribbon roll 45A, the ribbon guides 229 and 219, and the take-up spool 241 are arranged in order from upstream to downstream. In each of the tape cassettes 100C through 100E, the ink ribbon 45 can be stably conveyed from the first space S1 to the second space S2 using the ribbon guides 229 and 219.

In each of the tape cassettes 100A and 100B, the ribbon guide 219 is positioned in the first space S1, and the ribbon guide 229 is positioned in the second space S2. Each of the tape cassettes 100A and 100B enables the ink ribbon 45 to be stably conveyed in each of the first space S1 and the second space S2 using the corresponding one of the ribbon guides 219 and 229.

In each of the tape cassettes 100C through 100E, the ribbon guide 229 is positioned in the first space S1, and the ribbon guide 219 is positioned in the second space S2. Each of the tape cassettes 100C through 100E enables the ink ribbon 45 to be stably conveyed in each of the first space S1 and the second space S2 using the corresponding one of the ribbon guides 229 and 219.

In each of the tape cassettes 100A and 100B, the discharge port 17A is positioned in the first space S1 (more specifically, in the plate 21F that defines the first space S1). The discharge port 17A allows the ink ribbon 45 to be discharged to the outside of the housing 20. The inlet port 55 is also positioned in the first space S1 (more specifically, in the plate 21F that defines the first space S1). The inlet port 55 allows the ink ribbon 45 to be introduced into the housing 20. The ink ribbon 45 drawn off the ribbon roll 45A or the roll 411 is conveyed through the discharge port 17A and the inlet port 55 and conveyed along the ribbon guides 219 and 229, in order, and is taken up by the take-up spool 241.

That is, in the conveying direction in which the ink ribbon 45 drawn off the ribbon roll 45A is conveyed from the ribbon roll 45A to the take-up spool 241 in the tape cassette 100A, the ribbon roll 45A, the discharge port 17A, the inlet port 55, the ribbon guides 219 and 229, and the take-up spool 241 are arranged in order from upstream to downstream. Similarly, in the conveying direction in which the ink ribbon 45 drawn off the roll 411 is conveyed from the roll 411 to the take-up spool 241 in the tape cassette 100B, the roll 411, the discharge port 17A, the inlet port 55, the ribbon guides 219 and 229, and the take-up spool 241 are arranged in order from upstream to downstream. Each of the tape cassettes 100A and 100B secures the conveying passage for the ink ribbon 45.

In each of the tape cassettes 100C and 100E, the discharge port 17A is positioned in the second space S2 (more specifically, in the plate 21F that defines the second space S2). The discharge port 17A allows the ink ribbon 45 to be discharged to the outside of the housing 20. The inlet port 55 is also positioned in the second space S2 (more specifically, in the plate 21F that defines the second space S2). The inlet port 55 allows the ink ribbon 45 to enter the housing 20. The ink ribbon 45 drawn off the ribbon roll 45A is conveyed along the ribbon guides 229 and 219 and conveyed through the discharge port 17A and the inlet port 55, in order, and is taken up by the take-up spool 241 or the take-up spool 218.

That is, in the conveying direction in which the ink ribbon 45 drawn off the ribbon roll 45A is conveyed from the ribbon roll 45A to the take-up spool 218 in the tape cassette 100C, the ribbon roll 45A, the ribbon guides 229 and 219, the discharge port 17A, the inlet port 55, and the take-up spool 218 are arranged in order from upstream to downstream. Similarly, in the conveying direction in which the ink ribbon 45 drawn off the tape roll 41A is conveyed from the tape roll 41A to the take-up spool 241 in the tape cassette 100E, the tape roll 41A, the ribbon guides 229 and 219, the discharge port 17A, the inlet port 55, and the take-up spool 241 are arranged in order from upstream to downstream. Each of the tape cassettes 100C and 100E enables the stable conveyance of the ink ribbon 45 prior to printing.

In the tape cassette 100D, the discharge port 17B is positioned in the second space S2 (more specifically, in the plate 21F that defines the second space S2). The discharge port 17B allows the ink ribbon 45 to be discharged to the outside of the housing 20. The inlet port 55 is also positioned in the second space S2 (more specifically, in the plate 21F that defines the second space S2). The inlet port 55 allows the ink ribbon 45 to enter the housing 20. The ink ribbon 45 drawn off the roll 411 is conveyed along the ribbon guides 229 and 219 and conveyed through the discharge port 17B and the inlet port 55, in order, and is taken up by the take-up spool 218. That is, in the conveying direction in which the ink ribbon 45 drawn off the roll 411 is conveyed from the roll 411 to the take-up spool 218, the roll 411, the ribbon guides 229 and 219, the discharge port 17B, the inlet port 55, and the take-up spool 218 are arranged in order from upstream to downstream. In the tape cassette 100D, the ink ribbon 45 can be conveyed stably prior to printing.

In each of the tape cassettes 100A and 100B, the partition plate 21M partitions the first space S1 into the third space S3 and the fourth space S4 in the first direction. That is, the partition plate 21M is positioned between the third space S3 and the fourth space S4 in the first direction. The ribbon roll 45A or the roll 411 is positioned in the third space S3. In each of the tape cassettes 100A and 100B, the corresponding ribbon roll 45A or the roll 411 can be positioned in the third space S3.

In each of the tape cassettes 100C through 100E, the partition plate 22U partitions the first space S1 into the third space S3 and the fourth space S4 in the first direction. That is, the partition plate 22U is positioned between the third space S3 and the fourth space S4 in the first direction. The ribbon roll 45A or the roll 411 is positioned in the third space S3. In each of the tape cassettes 100C through 100E, the corresponding ribbon roll 45A or the roll 411 can be positioned in the third space S3.

In each of the tape cassettes 100A and 100B, the partition plate 21M partitions the first space S1 into the third space S3 and the fourth space S4 in the first direction. The third space S3 is located between the case 23 and the partition plate 21M in the first direction. The fourth space S4 is located between the partition plate 22U and the partition plate 21M in the first direction. Each of the tape cassettes 100A and 100B can define the third space S3 using the case 23 and the partition plate 21M. Also, each of the tape cassettes 100A and 100B can define the fourth space S4 using the partition plates 22U and 21M.

In each of the tape cassettes 100C through 100E, the partition plate 22U partitions the first space S1 into the third space S3 and the fourth space S4 in the first direction. The third space S3 is located between the case 24 and the partition plate 22U in the first direction. The fourth space S4 is located between the partition plate 21M and the partition plate 22U in the first direction. Each of the tape cassettes 100C through 100E can define the third space S3 using the case 24 and the partition plate 22U. Also, each of the tape cassettes 100C through 100E can define the fourth space S4 using the partition plates 21M and 22U.

In each of the tape cassettes 100A through 100E, the gears 30 are positioned in the fourth space S4. In each of the tape cassettes 100A through 100E, the gears 30 can be positioned in the fourth space S4.

In each of the tape cassettes 100C and 100D, the gears 30 include the three gears 31, 34, and 37. Each of the tape cassettes 100C and 100D can accommodate these three gears 31, 34, and 37.

In each of the tape cassettes 100A, 100B, and 100E, the gears 30 include the four gears 31, 32, 34, and 37. Each of the tape cassettes 100A, 100B, and 100E can accommodate these four gears 31, 32, 34, and 37.

In each of the tape cassettes 100A through 100E, the gears 30 include the gear 31. A part of the gear 31 is exposed to the outside of the housing 20. Each of the tape cassettes 100A through 100E can expose the gear 31 to the outside of the housing 20.

In each of the tape cassettes 100A, 100B, and 100E, the gears 30 include the gear 32 coupled to the take-up spool 241. Each of the tape cassettes 100A, 100B, and 100E can drive the take-up spool 241 using the gear 32.

Note that the configurations of the tape cassettes 100A through 100E may be combined appropriately as long as there are no contradictions.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

The present disclosure encompasses the following aspects.

(Aspect 1) The disclosure provides a tape cassette including: a housing; a tape roll; a ribbon roll; and a take-up spool. The tape roll is positioned in the housing. The tape roll is a roll in which a tape is wound. The ribbon roll is positioned in the housing. The ribbon roll is a roll in which an ink ribbon is wound. The ribbon roll is rotatable about an axis extending in a first direction. The take-up spool is positioned in the housing. The take-up spool is configured to take up the ink ribbon. In the tape cassette, the ribbon roll and the take-up spool are spaced apart from each other in the first direction.

(Aspect 2) In the tape cassette according to aspect 1, the housing includes: a first partition plate. The first partition plate partitions an internal space of the housing into a first space and a second space in the first direction. The first partition plate is positioned between the first space and the second space in the first direction. The ribbon roll is positioned in the first space. The take-up spool is positioned in the second space.

(Aspect 3) In the tape cassette according to aspect 2, the housing has a first surface and a second surface which are spaced apart from each other in the first direction. The first partition plate is positioned between the first surface and the second surface in the first direction. The first space is located between the first surface and the first partition plate in the first direction. The second space is located between the second surface and the first partition plate in the first direction.

(Aspect 4) In the tape cassette according to aspect 3, the housing further includes: a first case; and a second case. The first case has the first surface. The second case has the second surface. The second case and the first case are spaced apart from each other in the first direction.

(Aspect 5) In the tape cassette according to aspect 2, the tape roll is positioned in the first space.

(Aspect 6) In the tape cassette according to aspect 2, the tape roll is positioned in the second space.

(Aspect 7) In the tape cassette according to aspect 1, the housing has a first discharge port. The first discharge port allows the ink ribbon to be discharged to an outside of the housing.

(Aspect 8) In the tape cassette according to aspect 7, the first discharge port is a part of the housing defining an opening.

(Aspect 9) In the tape cassette according to aspect 2, the housing has: a wall; and a discharge port. The wall defines the first space. The discharge port allows the ink ribbon to be discharged to an outside of the housing. The discharge port is positioned in the wall.

(Aspect 10) In the tape cassette according to aspect 2, the housing has: a wall; and a discharge port. The wall defines the second space. The discharge port allows the ink ribbon to be discharged to an outside of the housing. The discharge port is positioned in the wall.

(Aspect 11) In the tape cassette according to aspect 7, the housing further has a second discharge port. The second discharge port allows the tape to be discharged to an outside of the housing. The second discharge port is different from the first discharge port.

(Aspect 12) In the tape cassette according to aspect 11, the first discharge port is positioned between the second discharge port and the ribbon roll in a second direction orthogonal to the first direction.

(Aspect 13) In the tape cassette according to aspect 11, the first discharge port is positioned between the second discharge port and the take-up spool in a second direction orthogonal to the first direction.

(Aspect 14) In the tape cassette according to aspect 7, the first discharge port further allows the tape to be discharged to the outside of the housing.

(Aspect 15) In the tape cassette according to aspect 1, the tape roll and the ribbon roll constitute a single roll in which the tape and the ink ribbon are wound together in an overlaid state. The single roll is rotatable about the axis.

(Aspect 16) The tape cassette according to aspect 1 further includes: a tape spool on which the tape roll is mounted; and a ribbon spool on which the ribbon roll is mounted. The tape spool is positioned in the housing. The ribbon spool is positioned in the housing.

(Aspect 17) In the tape cassette according to aspect 16, the ribbon spool and the take-up spool are spaced apart from each other in the first direction.

(Aspect 18) In the tape cassette according to aspect 2, the housing further includes a ribbon guide for guiding the ink ribbon during conveyance of the ink ribbon from the first space toward the second space. In a conveying direction in which the ink ribbon drawn off the ribbon roll is conveyed from the ribbon roll to the take-up spool, the ribbon roll, the ribbon guide, and the take-up spool are arranged in order from upstream to downstream.

(Aspect 19) In the tape cassette according to aspect 18, the ribbon guide is positioned in the first space. The housing further includes a second ribbon guide for guiding the ink ribbon during the conveyance of the ink ribbon from the first space toward the second space. The second ribbon guide is positioned in the second space.

(Aspect 20) In the tape cassette according to aspect 18, the housing has: the housing has: a wall; a discharge port; and an inlet port. The wall defines the first space. The discharge port allows the ink ribbon to be discharged to an outside of the housing. The discharge port is positioned in the wall. The inlet port allows the ink ribbon to enter the housing. The inlet port is positioned in the wall. In the conveying direction, the ribbon roll, the discharge port, the inlet port, the ribbon guide, and the take-up spool are arranged in order from upstream to downstream.

(Aspect 21) In the tape cassette according to aspect 18, the housing has: a wall; a discharge port; and an inlet port. The wall defines the second space. The discharge port allows the ink ribbon to be discharged to an outside of the housing. The discharge port is positioned in the wall. The inlet port allows the ink ribbon to enter the housing. The inlet port is positioned in the wall. In the conveying direction, the ribbon roll, the ribbon guide, the discharge port, the inlet port, and the take-up spool are arranged in order from upstream to downstream.

(Aspect 22) In the tape cassette according to aspect 2, the housing further includes a second partition plate. The second partition plate partitions the first space into a third space and a fourth space in the first direction. The second partition plate is positioned between the third space and the fourth space in the first direction. The ribbon roll is positioned in the third space.

(Aspect 23) In the tape cassette according to aspect 4, the housing further includes a second partition plate. The second partition plate partitions the first space into a third space and a fourth space in the first direction. The third space is located between the first case and the second partition plate in the first direction. The fourth space is located between the first partition plate and the second partition plate in the first direction.

(Aspect 24) The tape cassette according to aspect 22 further includes a gear positioned in the fourth space.

(Aspect 25) The tape cassette according to aspect 22 further includes three gears positioned in the fourth space.

(Aspect 26) The tape cassette according to aspect 22 further includes four gears positioned in the fourth space.

(Aspect 27) In the tape cassette according to aspect 24, a part of the gear is exposed to an outside of the housing.

(Aspect 28) In the tape cassette according to aspect 24, the gear is coupled to the take-up spool.

(Aspect 29) The tape cassette according to aspect 2 further includes: a tape spool on which the tape roll is mounted; and a ribbon spool on which the ribbon roll is mounted. The tape spool is positioned in the housing. The ribbon spool is positioned in the housing. The housing has: a wall; a first discharge port; and an inlet port. The wall defines the first space. The first discharge port allows the ink ribbon to be discharged to an outside of the housing. The first discharge port is positioned in the wall. The inlet port allows the ink ribbon to enter the housing. The inlet port is positioned in the wall. The housing further includes: a first ribbon guide for guiding the ink ribbon during conveyance of the ink ribbon from the first space toward the second space; and a second ribbon guide for guiding the ink ribbon during the conveyance of the ink ribbon from the first space toward the second space. The first ribbon guide is positioned in the first space. The second ribbon guide is positioned in the second space. The ribbon spool and the take-up spool are spaced apart from each other in the first direction. The ribbon spool, the tape roll, and the tape spool are positioned in the first space. In a conveying direction in which the ink ribbon drawn off the ribbon roll is conveyed from the ribbon roll to the take-up spool, the ribbon roll, the first discharge port, the inlet port, the first ribbon guide, the second ribbon guide, and the take-up spool are arranged in order from upstream to downstream.

(Aspect 30) In the tape cassette according to aspect 29, the housing further has a second discharge port. The second discharge port allows the tape to be discharged to the outside of the housing. The second discharge port is positioned in the wall. The housing further includes a tape guide for guiding the tape during conveyance of the tape. The tape guide is positioned in the first space. In a conveying direction in which the tape drawn off the tape roll is conveyed from the tape roll to the second discharge port, the tape roll, the tape guide, and the second discharge port are arranged in order from upstream to downstream.

(Aspect 31) In the tape cassette according to aspect 29, the take-up spool does not overlap the ribbon roll in the first direction, and the take-up spool does not overlap the ribbon roll in a second direction orthogonal to the first direction.

(Aspect 32) In the tape cassette according to aspect 29, the take-up spool does not overlap the tape roll in the first direction, and the take-up spool does not overlap the ribbon roll in a second direction orthogonal to the first direction.

(Aspect 33) In the tape cassette according to aspect 29, the housing further includes a second partition plate. The second partition plate partitions the first space into a third space and a fourth space in the first direction. The ribbon roll is positioned in the third space. The tape cassette further includes a gear positioned in the fourth space.

(Aspect 34) In the tape cassette according to aspect 33, a part of the gear is exposed to the outside of the housing.

(Aspect 35) In the tape cassette according to aspect 34, the gear overlaps the ribbon roll in the first direction.

(Aspect 36) The tape cassette according to aspect 34 further includes a second gear coupled to the take-up spool. The second gear is positioned in the fourth space.

(Aspect 37) In the tape cassette according to aspect 36, the second gear overlaps the take-up spool in the first direction.

(Aspect 38) The tape cassette according to aspect 36 further includes a third gear in engagement with the gear. The third gear is positioned in the fourth space.

(Aspect 39) In the tape cassette according to aspect 38, the third gear overlaps the ribbon roll in the first direction.

(Aspect 40) In the tape cassette according to aspect 38, the third gear overlaps the tape roll in the first direction.

(Aspect 41) The tape cassette according to aspect 38 further includes a fourth gear for receiving a drive force. The fourth gear is positioned in the fourth space.

(Aspect 42) In the tape cassette according to aspect 2, the housing has: a wall; a first discharge port; and an inlet port. The wall defines the first space. The first discharge port allows the ink ribbon to be discharged to an outside of the housing. The first discharge port is positioned in the wall. The inlet port allows the ink ribbon to enter the housing. The inlet port is positioned in the wall. The housing further includes: a first ribbon guide for guiding the ink ribbon during conveyance of the ink ribbon from the first space toward the second space; and a second ribbon guide for guiding the ink ribbon during the conveyance of the ink ribbon from the first space toward the second space. The first ribbon guide is positioned in the first space. The second ribbon guide is positioned in the second space. The tape roll and the ribbon roll constitute a single roll in which the tape and the ink ribbon are wound together in an overlaid state. The single roll is rotatable about the axis. The single roll is positioned in the first space. In a conveying direction in which the ink ribbon drawn off the single roll is conveyed from the single roll to the take-up spool, the single roll, the first discharge port, the inlet port, the first ribbon guide, the second ribbon guide, and the take-up spool are arranged in order from upstream to downstream.

(Aspect 43) In the tape cassette according to aspect 42, the housing further has a second discharge port. The second discharge port allows the tape to be discharged to the outside of the housing. The second discharge port is positioned in the wall. The housing further includes a tape guide for guiding the tape during conveyance of the tape. The tape guide is positioned in the first space. In a conveying direction in which the tape drawn off the single roll is conveyed from the single roll to the second discharge port, the single roll, the tape guide, and the second discharge port are arranged in order from upstream to downstream.

(Aspect 44) In the tape cassette according to aspect 42, the take-up spool overlaps the single roll in the first direction, and the take-up spool does not overlap the single roll in a second direction orthogonal to the first direction.

(Aspect 45) In the tape cassette according to aspect 42, the housing further includes a second partition plate. The second partition plate partitions the first space into a third space and a fourth space in the first direction. The single roll is positioned in the third space. The tape cassette further includes a gear positioned in the fourth space.

(Aspect 46) In the tape cassette according to aspect 45, a part of the gear is exposed to the outside of the housing.

(Aspect 47) In the tape cassette according to aspect 46, the gear does not overlap the single roll in the first direction.

(Aspect 48) The tape cassette according to aspect 46 further includes a second gear coupled to the take-up spool. The second gear is positioned in the fourth space.

(Aspect 49) In the tape cassette according to aspect 48, the second gear overlaps the take-up spool in the first direction.

(Aspect 50) The tape cassette according to aspect 48 further includes a third gear in engagement with the gear. The third gear is positioned in the fourth space.

(Aspect 51) In the tape cassette according to aspect 50, the third gear overlaps the single roll in the first direction.

(Aspect 52) The tape cassette according to aspect 50 further includes a fourth gear for receiving a drive force. The fourth gear is positioned in the fourth space.

(Aspect 53) The tape cassette according to aspect 2 further includes: a tape spool on which the tape roll is mounted; and a ribbon spool on which the ribbon roll is mounted. The tape spool is positioned in the housing. The ribbon spool is positioned in the housing. The housing has: a wall; a first discharge port; and an inlet port. The wall defines the second space. The first discharge port allows the ink ribbon to be discharged to an outside of the housing. The first discharge port is positioned in the wall. The inlet port allows the ink ribbon to enter the housing. The inlet port is positioned in the wall. The housing further includes: a first ribbon guide for guiding the ink ribbon during conveyance of the ink ribbon from the first space toward the second space; and a second ribbon guide for guiding the ink ribbon during the conveyance of the ink ribbon from the first space toward the second space. The first ribbon guide is positioned in the first space. The second ribbon guide is positioned in the second space. The ribbon spool and the take-up spool are spaced apart from each other in the first direction. The ribbon spool, the tape roll, and the tape spool are positioned in the first space. In a conveying direction in which the ink ribbon drawn off the ribbon roll is conveyed from the ribbon roll to the take-up spool, the ribbon roll, the first ribbon guide, the second ribbon guide, the first discharge port, the inlet port, and the take-up spool are arranged in order from upstream to downstream.

(Aspect 54) The tape cassette according to aspect 53 further includes a roller positioned in the first space. The ink ribbon drawn off the ribbon roll and the tape drawn off the tape roll are overlaid on each other on the roller.

(Aspect 55) In the tape cassette according to aspect 53, the housing further has a second discharge port. The second discharge port allows the tape to be discharged to the outside of the housing. The second discharge port is positioned in the wall. The housing further includes a tape guide for guiding the tape during conveyance of the tape. The tape guide is positioned in the second space. In a conveying direction in which the tape drawn off the tape roll is conveyed from the tape roll to the second discharge port, the tape roll, the first ribbon guide, the second ribbon guide, the tape guide, and the second discharge port are arranged in order from upstream to downstream.

(Aspect 56) In the tape cassette according to aspect 53, the take-up spool overlaps the ribbon roll in the first direction, and the take-up spool does not overlap the ribbon roll in a second direction orthogonal to the first direction.

(Aspect 57) In the tape cassette according to aspect 53, the take-up spool does not overlap the tape roll in the first direction, and the take-up spool does not overlap the tape roll in a second direction orthogonal to the first direction.

(Aspect 58) In the tape cassette according to aspect 53, the take-up spool overlaps the ribbon roll in the first direction, and the take-up spool does not overlap the tape roll in the first direction.

(Aspect 59) In the tape cassette according to aspect 53, the housing further includes a second partition plate. The second partition plate partitions the first space into a third space and a fourth space in the first direction. The ribbon roll and the tape roll are positioned in the third space. The tape cassette further includes a gear positioned in the fourth space.

(Aspect 60) In the tape cassette according to aspect 59, a part of the gear is exposed to the outside of the housing.

(Aspect 61) In the tape cassette according to aspect 60, the gear does not overlap the ribbon roll in the first direction.

(Aspect 62) The tape cassette according to aspect 60 further includes a second gear in engagement with the gear. The second gear is positioned in the fourth space.

(Aspect 63) In the tape cassette according to aspect 62, the second gear overlaps the ribbon roll in the first direction.

(Aspect 64) In the tape cassette according to aspect 62, the second gear overlaps the tape roll in the first direction.

(Aspect 65) The tape cassette according to aspect 62 further includes a third gear for receiving a drive force. The third gear is positioned in the fourth space.

(Aspect 66) In the tape cassette according to aspect 2, the housing has: a wall; a discharge port; and an inlet port. The wall defines the second space. The discharge port allows the ink ribbon to be discharged to an outside of the housing. The discharge port is positioned in the wall. The inlet port allows the ink ribbon to enter the housing. The inlet port is positioned in the wall. The housing further includes: a first ribbon guide for guiding the ink ribbon during conveyance of the ink ribbon from the first space toward the second space; and a second ribbon guide for guiding the ink ribbon during the conveyance of the ink ribbon from the first space toward the second space. The first ribbon guide is positioned in the first space. The second ribbon guide is positioned in the second space. The tape roll and the ribbon roll constitute a single roll in which the tape and the ink ribbon are wound together in an overlaid state. The single roll is rotatable about the axis. The single roll is positioned in the first space. In a conveying direction in which the ink ribbon drawn off the single roll is conveyed from the single roll to the take-up spool, the single roll, the first ribbon guide, the second ribbon guide, the discharge port, the inlet port, and the take-up spool are arranged in order from upstream to downstream.

(Aspect 67) In the tape cassette according to aspect 66, the housing further includes a tape guide for guiding the tape during conveyance of the tape and for guiding the ink ribbon during conveyance of the ink ribbon. The tape guide is positioned in the second space. The discharge port further allows the tape to be discharged to the outside of the housing together with the ink ribbon. In a conveying direction in which the tape drawn off the single roll is conveyed from the single roll to the discharge port, the single roll, the first ribbon guide, the second ribbon guide, the tape guide, and the discharge port are arranged in order from upstream to downstream.

(Aspect 68) In the tape cassette according to aspect 66, the take-up spool overlaps the single roll in the first direction, and the take-up spool does not overlap the single roll in a second direction orthogonal to the first direction.

(Aspect 69) In the tape cassette according to aspect 66, the housing further includes a second partition plate. The second partition plate partitions the first space into a third space and a fourth space in the first direction. The single roll is positioned in the third space. The tape cassette further includes a gear positioned in the fourth space.

(Aspect 70) In the tape cassette according to aspect 69, a part of the gear is exposed to the outside of the housing.

(Aspect 71) In the tape cassette according to aspect 70, the gear overlaps the single roll in the first direction.

(Aspect 72) The tape cassette according to aspect 70 further includes a second gear in engagement with the gear. The second gear is positioned in the fourth space.

(Aspect 73) In the tape cassette according to aspect 72, the second gear overlaps the single roll in the first direction.

(Aspect 74) The tape cassette according to aspect 72 further includes a third gear for receiving a drive force. The third gear is positioned in the fourth space.

(Aspect 75) The tape cassette according to aspect 2 further includes: a tape spool on which the tape roll is mounted; and a ribbon spool on which the ribbon roll is mounted. The tape spool is positioned in the housing. The ribbon spool is positioned in the housing. The housing has: a wall; a first discharge port; and an inlet port. The wall defines the second space. The first discharge port allows the ink ribbon to be discharged to an outside of the housing. The first discharge port is positioned in the wall. The inlet port allows the ink ribbon to enter the housing. The inlet port is positioned in the wall. The housing further includes: a first ribbon guide for guiding the ink ribbon during conveyance of the ink ribbon from the first space toward the second space; and a second ribbon guide for guiding the ink ribbon during the conveyance of the ink ribbon from the first space toward the second space. The first ribbon guide is positioned in the first space. The second ribbon guide is positioned in the second space. The ribbon spool is positioned in the first space. The tape roll and the tape spool are positioned in the second space. In a conveying direction in which the ink ribbon drawn off the ribbon roll is conveyed from the ribbon roll to the take-up spool, the ribbon roll, the first ribbon guide, the second ribbon guide, the first discharge port, the inlet port, and the take-up spool are arranged in order from upstream to downstream.

(Aspect 76) In the tape cassette according to aspect 75, the housing further has a second discharge port. The second discharge port allows the tape to be discharged to the outside of the housing. The second discharge port is positioned in the wall. The housing further includes a tape guide for guiding the tape during conveyance of the tape. The tape guide is positioned in the second space. In a conveying direction in which the tape drawn off the tape roll is conveyed from the tape roll to the second discharge port, the tape roll, the tape guide, and the second discharge port are arranged in order from upstream to downstream.

(Aspect 77) In the tape cassette according to aspect 75, the take-up spool does not overlap the ribbon roll in the first direction, and the take-up spool does not overlap the ribbon roll in a second direction orthogonal to the first direction.

(Aspect 78) In the tape cassette according to aspect 75, the take-up spool does not overlap the tape roll in the first direction, and the take-up spool does not overlap the ribbon roll in a second direction orthogonal to the first direction.

(Aspect 79) In the tape cassette according to aspect 75, the housing further includes a second partition plate. The second partition plate partitions the first space into a third space and a fourth space in the first direction. The ribbon roll is positioned in the third space. The tape cassette further includes a gear positioned in the fourth space.

(Aspect 80) In the tape cassette according to aspect 79, a part of the gear is exposed to the outside of the housing.

(Aspect 81) In the tape cassette according to aspect 80, the gear overlaps the ribbon roll in the first direction.

(Aspect 82) The tape cassette according to aspect 80 further includes a second gear coupled to the take-up spool. The second gear is positioned in the fourth space.

(Aspect 83) In the tape cassette according to aspect 82, the second gear overlaps the take-up spool in the first direction.

(Aspect 84) The tape cassette according to aspect 82 further includes a third gear in engagement with the gear. The third gear is positioned in the fourth space.

(Aspect 85) In the tape cassette according to aspect 84, the third gear overlaps the ribbon roll in the first direction.

(Aspect 86) In the tape cassette according to aspect 84, the third gear overlaps the tape roll in the first direction.

(Aspect 87) The tape cassette according to aspect 84 further includes a fourth gear for receiving a drive force. The fourth gear is positioned in the fourth space.

What is claimed is:

1. A tape cassette comprising:
a housing;
a tape roll positioned in the housing, the tape roll being a roll in which a tape is wound;
a ribbon roll positioned in the housing, the ribbon roll being a roll in which an ink ribbon is wound, the ribbon roll being rotatable about an axis extending in a first direction; and
a take-up spool positioned in the housing, the take-up spool being configured to take up the ink ribbon,
wherein the ribbon roll and the take-up spool are spaced apart from each other in the first direction.

2. The tape cassette according to claim 1,
wherein the housing includes:
a first partition plate partitioning an internal space of the housing into a first space and a second space in the first direction,
wherein the first partition plate is positioned between the first space and the second space in the first direction,
wherein the ribbon roll is positioned in the first space, and
wherein the take-up spool is positioned in the second space.

3. The tape cassette according to claim 2,
wherein the housing has:
a first surface and a second surface which are spaced apart from each other in the first direction,
wherein the first partition plate is positioned between the first surface and the second surface in the first direction,
wherein the first space is located between the first surface and the first partition plate in the first direction, and
wherein the second space is located between the second surface and the first partition plate in the first direction.

4. The tape cassette according to claim 3,
wherein the housing further includes:
a first case having the first surface; and
a second case having the second surface, the second case and the first case being spaced apart from each other in the first direction.

5. The tape cassette according to claim 2,
wherein the tape roll is positioned in the first space.

6. The tape cassette according to claim 2,
wherein the tape roll is positioned in the second space.

7. The tape cassette according to claim 1,
wherein the housing has:
a discharge port allowing the ink ribbon to be discharged to an outside of the housing.

8. The tape cassette according to claim 2,
wherein the housing further includes:
a ribbon guide for guiding the ink ribbon during conveyance of the ink ribbon from the first space toward the second space, and
wherein, in a conveying direction in which the ink ribbon drawn off the ribbon roll is conveyed from the ribbon roll to the take-up spool, the ribbon roll, the ribbon guide, and the take-up spool are arranged in order from upstream to downstream.

9. The tape cassette according to claim 2,
wherein the housing has:
a wall defining the first space;
a first discharge port allowing the ink ribbon to be discharged to an outside of the housing, the first discharge port being positioned in the wall; and
an inlet port allowing the ink ribbon to enter the housing, the inlet port being positioned in the wall,
wherein the housing further includes:
a first ribbon guide for guiding the ink ribbon during conveyance of the ink ribbon from the first space toward the second space, the first ribbon guide being positioned in the first space; and
a second ribbon guide for guiding the ink ribbon during the conveyance of the ink ribbon from the first space toward the second space, the second ribbon guide being positioned in the second space,
wherein the tape roll and the ribbon roll constitute a single roll in which the tape and the ink ribbon are wound together in an overlaid state, the single roll being rotatable about the axis, the single roll being positioned in the first space, and
wherein, in a conveying direction in which the ink ribbon drawn off the single roll is conveyed from the single roll to the take-up spool, the single roll, the first discharge port, the inlet port, the first ribbon guide, the second ribbon guide, and the take-up spool are arranged in order from upstream to downstream.

10. The tape cassette according to claim 9,
wherein the housing further has:
a second discharge port allowing the tape to be discharged to the outside of the housing, the second discharge port being positioned in the wall,
wherein the housing further includes:
a tape guide for guiding the tape during conveyance of the tape, the tape guide being positioned in the first space, and
wherein, in a conveying direction in which the tape drawn off the single roll is conveyed from the single roll to the second discharge port, the single roll, the tape guide, and the second discharge port are arranged in order from upstream to downstream.

11. The tape cassette according to claim 9,
wherein the housing further includes:
a second partition plate partitioning the first space into a third space and a fourth space in the first direction, and
wherein the single roll is positioned in the third space,
the tape cassette further comprising:
a gear positioned in the fourth space.

12. The tape cassette according to claim 2, further comprising:
a tape spool on which the tape roll is mounted, the tape spool being positioned in the housing; and
a ribbon spool on which the ribbon roll is mounted, the ribbon spool being positioned in the housing,
wherein the housing has:
a wall defining the second space;
a discharge port allowing the ink ribbon to be discharged to an outside of the housing, the discharge port being positioned in the wall; and
an inlet port allowing the ink ribbon to enter the housing, the inlet port being positioned in the wall,
wherein the housing further includes:
a first ribbon guide for guiding the ink ribbon during conveyance of the ink ribbon from the first space toward the second space, the first ribbon guide being positioned in the first space; and
a second ribbon guide for guiding the ink ribbon during the conveyance of the ink ribbon from the first space toward the second space, the second ribbon guide being positioned in the second space,
wherein the ribbon spool and the take-up spool are spaced apart from each other in the first direction,
wherein the ribbon spool, the tape roll, and the tape spool are positioned in the first space, and
wherein, in a conveying direction in which the ink ribbon drawn off the ribbon roll is conveyed from the ribbon roll to the take-up spool, the ribbon roll, the first ribbon guide, the second ribbon guide, the discharge port, the inlet port, and the take-up spool are arranged in order from upstream to downstream.

13. The tape cassette according to claim 12, further comprising:
a roller positioned in the first space,
wherein the ink ribbon drawn off the ribbon roll and the tape drawn off the tape roll are overlaid on each other on the roller.

14. The tape cassette according to claim 12,
wherein the housing further includes:
a second partition plate partitioning the first space into a third space and a fourth space in the first direction, and
wherein the ribbon roll and the tape roll are positioned in the third space, the tape cassette further comprising:
a gear positioned in the fourth space.

15. The tape cassette according to claim 2,
wherein the housing has:
a wall defining the second space;
a discharge port allowing the ink ribbon to be discharged to an outside of the housing, the discharge port being positioned in the wall; and
an inlet port allowing the ink ribbon to enter the housing, the inlet port being positioned in the wall,
wherein the housing further includes:
a first ribbon guide for guiding the ink ribbon during conveyance of the ink ribbon from the first space toward the second space, the first ribbon guide being positioned in the first space; and
a second ribbon guide for guiding the ink ribbon during the conveyance of the ink ribbon from the first space toward the second space, the second ribbon guide being positioned in the second space,
wherein the tape roll and the ribbon roll constitute a single roll in which the tape and the ink ribbon are wound together in an overlaid state, the single roll being rotatable about the axis, the single roll being positioned in the first space, and
wherein, in a conveying direction in which the ink ribbon drawn off the single roll is conveyed from the single roll to the take-up spool, the single roll, the first ribbon guide, the second ribbon guide, the discharge port, the inlet port, and the take-up spool are arranged in order from upstream to downstream.

16. The tape cassette according to claim 15,
wherein the take-up spool overlaps the single roll in the first direction, and the take-up spool does not overlap the single roll in a second direction orthogonal to the first direction.

17. The tape cassette according to claim 15,
wherein the housing further includes:
a second partition plate partitioning the first space into a third space and a fourth space in the first direction, and
wherein the single roll is positioned in the third space,
the tape cassette further comprising:
a gear positioned in the fourth space.

18. The tape cassette according to claim 2, further comprising:
a tape spool on which the tape roll is mounted, the tape spool being positioned in the housing; and
a ribbon spool on which the ribbon roll is mounted, the ribbon spool being positioned in the housing,
wherein the housing has:
a wall defining the second space;
a first discharge port allowing the ink ribbon to be discharged to an outside of the housing, the first discharge port being positioned in the wall; and
an inlet port allowing the ink ribbon to enter the housing, the inlet port being positioned in the wall,
wherein the housing further includes:
a first ribbon guide for guiding the ink ribbon during conveyance of the ink ribbon from the first space toward the second space, the first ribbon guide being positioned in the first space; and
a second ribbon guide for guiding the ink ribbon during the conveyance of the ink ribbon from the first space toward the second space, the second ribbon guide being positioned in the second space,
wherein the ribbon spool is positioned in the first space,
wherein the tape roll and the tape spool are positioned in the second space, and
wherein, in a conveying direction in which the ink ribbon drawn off the ribbon roll is conveyed from the ribbon roll to the take-up spool, the ribbon roll, the first ribbon guide, the second ribbon guide, the first discharge port, the inlet port, and the take-up spool are arranged in order from upstream to downstream.

19. The tape cassette according to claim 18,
wherein the housing further has:
a second discharge port allowing the tape to be discharged to the outside of the housing, the second discharge port being positioned in the wall,
wherein the housing further includes:
a tape guide for guiding the tape during conveyance of the tape, the tape guide being positioned in the second space, and
wherein, in a conveying direction in which the tape drawn off the tape roll is conveyed from the tape roll to the second discharge port, the tape roll, the tape guide, and the second discharge port are arranged in order from upstream to downstream.

20. The tape cassette according to claim 18,
wherein the housing further includes:
a second partition plate partitioning the first space into a third space and a fourth space in the first direction, and
wherein the ribbon roll is positioned in the third space,
the tape cassette further comprising:
a gear positioned in the fourth space.
